(19) United States
(12) Patent Application Publication
(10) Pub. No.: US 2025/0142576 A1
(43) Pub. Date: May 1, 2025

(54) METHOD AND APPARATUS FOR TRANSMITTING AND RECEIVING UPLINK CONTROL INFORMATION IN WIRELESS COMMUNICATION SYSTEMS

(71) Applicant: SAMSUNG ELECTRONICS CO., LTD., Suwon-si (KR)

(72) Inventors: Jaeyeon SHIM, Suwon-si (KR); Kyungjun CHOI, Suwon-si (KR); Hyoungju JI, Suwon-si (KR); Hyemin CHOE, Suwon-si (KR)

(21) Appl. No.: 18/927,714

(22) Filed: Oct. 25, 2024

(30) Foreign Application Priority Data
Oct. 25, 2023 (KR) 10-2023-0144180

(51) Int. Cl. H04W 72/21; H04L 1/1812; H04L 1/1829; H04L 5/00

(52) U.S. Cl. CPC H04W 72/21; H04L 5/0007; H04L 5/0096; H04L 1/1812; H04L 1/1854; H04L 5/0055

(57) ABSTRACT

A method performed by a user equipment (UE) in a wireless communication system. The method includes receiving, from a base station (BS), information associated with a downlink (DL) resource on a DL subband and information associated with an uplink (UL) resource on a UL subband, wherein the DL resource and the UL resource are on a same time resource; receiving, from the BS, time resource information for multiplexing uplink control information (UCI) on the UL resource; performing multiplexing of the UCI on the UL resource based on the time resource information; and transmitting, to the BS, an UL signal based on the UL resource multiplexed with the UCI.

### CROSS-REFERENCE TO RELATED APPLICATION

This application is based on and claims priority under 35 U.S.C. § 119 to Korean Patent Application No. 10-2023-0144180, filed on Oct. 25, 2023, in the Korean Intellectual Property Office, the disclosure of which is incorporated by reference herein in its entirety.

### BACKGROUND

### 1. Field

The disclosure relates to a wireless communication system, and more particularly, to a method of transmitting and receiving uplink control information (UCI) in a wireless communication system, and an apparatus capable of performing the method.

### 2. Description of the Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An embodiment of the disclosure may provide an apparatus and method capable of effectively providing a service in a wireless communication system.

Additional aspects will be set forth in part in the description which follows and, in part, will be apparent from the description, or may be learned by practice of the presented embodiments of the disclosure.

A method performed by a user equipment (UE) in a wireless communication system may include: receiving, from a base station (BS), information associated with a downlink (DL) resource on a DL subband and information associated with an uplink (UL) resource on a UL subband, wherein the DL resource and the UL resource are on a same time resource; receiving, from the BS, time resource information for multiplexing uplink control information (UCI) on the UL resource; performing multiplexing of the UCI on the UL resource based on the time resource information; and transmitting, to the BS, an UL signal based on the UL resource multiplexed with the UCI.

A method performed by a base station (BS) in a wireless communication system may include: transmitting, to a user equipment (UE), information associated with a downlink (DL) resource on a DL subband and information associated with an uplink (UL) resource on a UL subband; wherein the DL resource and the UL resource are on a same time resource; transmitting, to the UE, time resource information for multiplexing uplink control information (UCI) on the UL resource, wherein the UCI is multiplexed on the UL resource based on the time resource information; and receiving, from the UE, an UL signal based on the UL resource multiplexed with the UCI.

A user equipment (UE) may include: a transceiver; and at least one processor coupled to the transceiver, and configured to: receive, from a base station (BS), information associated with a downlink (DL) resource on a DL subband and information associated with an uplink (UL) resource on a UL subband, wherein the DL resource and the UL resource are on a same time resource, receive, from the BS, time resource information for multiplexing uplink control information (UCI) on the UL resource, perform multiplexing of the UCI on the UL resource based on the time resource information, and transmit, to the BS, an UL signal based on the UL resource multiplexed with the UCI.

A base station (BS) may include: a transceiver; and at least one processor coupled to the transceiver, and configured to: transmit, to a user equipment (UE), information associated with a downlink (DL) resource on a DL subband and information associated with an uplink (UL) resource on a UL subband, wherein the DL resource and the UL resource are on a same time resource; transmit, to the UE, time resource information for multiplexing uplink control information (UCI) on the UL resource, wherein the UCI is multiplexed on the UL resource based on the time resource information, and receive, from the UE, an UL signal based on the UL resource multiplexed with the UCI.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain that is a radio resource region in which data or control channel is transmitted, according to an embodiment of the disclosure;

FIG. 2 illustrates a diagram of structures of a frame, a subframe, and slots in a wireless communication system, according to an embodiment of the disclosure;

FIG. 3 illustrates a diagram of an example configuration of a bandwidth part (BWP) in a wireless communication system, according to an embodiment of the disclosure;

FIG. 4 illustrates an example of control resource set (CORESET) in which a downlink (DL) control channel is transmitted, according to an embodiment of the disclosure;

FIG. 5 illustrates an example of a basic unit of time and frequency resources that configure a DL control channel, according to an embodiment of the disclosure;

FIG. 6 illustrates a diagram for describing a method by which a base station (BS) and a user equipment (UE) transmit or receive data by considering a DL data channel and a rate matching resource, according to an embodiment of the disclosure;

FIG. 7 illustrates an example of physical downlink shared channel (PDSCH) frequency-axis resource allocation in a wireless communication system, according to an embodiment of the disclosure;

FIG. 8 illustrates an example of PDSCH time-axis resource allocation in a wireless communication system, according to an embodiment of the disclosure;

FIG. 9 illustrates an example of time-axis resource allocation based on subcarrier spacing (SCS) of a data channel and a control channel in a wireless communication system, according to an embodiment of the disclosure;

FIG. 10 illustrates an example of a PUSCH repetitive transmission type A in a wireless communication system, according to an embodiment of the disclosure;

FIG. 11 illustrates an example of a PUSCH repetitive transmission type B in a wireless communication system, according to an embodiment of the disclosure;

FIG. 12 illustrates a procedure for transmitting and receiving uplink control information (UCI) information in a PUSCH between a UE and a BS, according to an embodiment of the disclosure;

FIG. 13 illustrates an example in which UCI is mapped to a PUSCH, according to an embodiment of the disclosure;

FIG. 14 illustrates radio protocol architecture of a BS and a UE in a situation of a single cell, carrier aggregation and dual connectivity, according to an embodiment of the present disclosure;

FIGS. 15A-15D illustrate an example in which subband non-overlapping full duplex (SBFD) is operated in a time division duplex (TDD) spectrum of a wireless communication system, according to an embodiment of the disclosure;

FIG. 16 illustrates an example in which an SBFD resource is configured in a wireless communication system, according to an embodiment of the disclosure;

FIG. 17 illustrates a scenario in which gNB-gNB cross-link interference (CLI) occurs, according to an embodiment of the disclosure;

FIG. 18 illustrates an example of gNB-gNB CLI effect in an SBFD system, according to an embodiment of the disclosure;

FIG. 19 illustrates an example of a UCI multiplexing method in single PUSCH transmission, according to an embodiment of the disclosure;

FIG. 20 illustrates an example of a UCI multiplexing method in single PUSCH transmission, according to an embodiment of the disclosure;

FIG. 21 illustrates an example of a method of determining a UCI multiplexing resource in multi-PUSCH transmission, according to an embodiment of the disclosure;

FIG. 22 illustrates a method of determining a UCI multiplexing resource, in consideration of a uplink (UL) resource type, according to an embodiment of the disclosure;

FIG. 23 illustrates a method of relaxing a PUSCH transmission timeline according to UCI multiplexing resource change, according to an embodiment of the disclosure;

FIG. 24 illustrates a method of configuring a DL power control resource, according to an embodiment of the disclosure;

FIGS. 25A-25C illustrate a method of applying DL power control, according to an embodiment of the disclosure;

FIGS. 26A-26B illustrate flowcharts of operations of a UE and a BS, respectively, according to an embodiment of the disclosure;

FIG. 27 illustrates a structure of a UE in a wireless communication system, according to an embodiment of the disclosure; and

FIG. 28 illustrates a structure of a BS in a wireless communication system, according to an embodiment of the disclosure.

### DETAILED DESCRIPTION

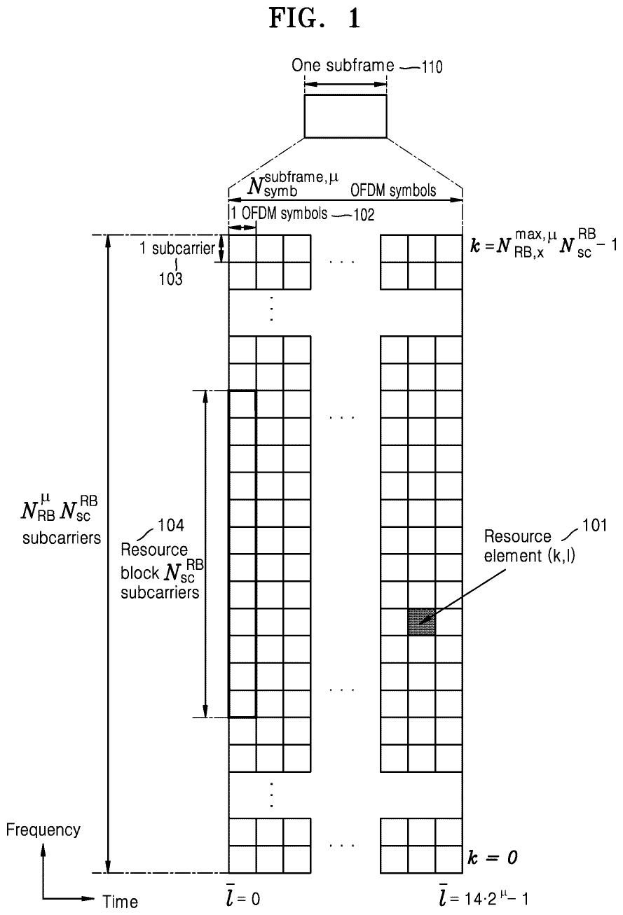

FIGS. 1 through 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Throughout the disclosure, the expression “at least one of a, b or c” indicates only a, only b, only c, both a and b, both a and c, both b and c, all of a, b, and c, or variations thereof.

Throughout the specification, a layer may also be referred to as an entity.

Hereinafter, embodiments of the disclosure will now be described more fully with reference to the accompanying drawings.

In the following descriptions of embodiments, descriptions of techniques that are well known in the art and are not directly related to the disclosure are omitted. By omitting unnecessary descriptions, the essence of the disclosure may not be obscured and may be explicitly conveyed.

For the same reason, some elements in the drawings are exaggerated, omitted, or schematically illustrated. Also, the size of each element does not entirely reflect the actual size. In the drawings, the same or corresponding elements are denoted by the same reference numerals.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein. Rather, these embodiments are provided so that the disclosure will be thorough and complete and will fully convey the concept of the disclosure to one of ordinary skill in the art, and the disclosure will only be defined by the appended claims. Throughout the specification, like reference numerals denote like elements. In the descriptions of the disclosure, detailed explanations of the related art are omitted when it is deemed that they may unnecessarily obscure the essence of the disclosure. The terms used in the specification are defined in consideration of functions used in the disclosure, and can be changed according to the intent or commonly used methods of users or operators. Accordingly, definitions of the terms are understood based on the entire descriptions of the present specification.

Hereinafter, a base station is an entity that allocates resources to a terminal, and may be at least one of a next-generation node B (gNode B), an evolved node B (eNode B), a Node B, a base station (BS), a radio access unit, a BS controller, or a node on a network. A terminal may include a user equipment (UE), a mobile station (MS), a cellular phone, a smartphone, a computer, or a multimedia system capable of performing a communication function. In the disclosure, a downlink (DL) is a wireless transmission path of a signal transmitted from a BS to a UE, and an uplink (UL) is a wireless transmission path of a signal transmitted from a UE to a BS. Although a long term evolution (LTE) or LTE-Advanced (LTE-A) system is mentioned as an example in the following description, embodiments of the disclosure may also be applied to other communication systems having similar technical backgrounds or channel types. For example, a 5^{th} generation (5G/New Radio (NR)) mobile communication technology developed after LTE-A may be included therein, and hereinafter, 5G may refer to a concept including legacy LTE, LTE-A, and other similar communication services. Also, an embodiment of the disclosure is applicable to other communication systems through modification at the discretion of one of ordinary skill in the art without greatly departing from the scope of the disclosure.

It will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a computer-executable or computer-readable memory that may direct the computer or other programmable data processing apparatus to function in a particular manner, such that the instructions stored in the computer-executable or computer-readable memory may produce an article of manufacture including instruction means that perform the functions specified in the flowchart block(s). The computer program instructions may also be loaded onto the computer or other programmable data processing apparatus to cause a series of operational steps to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which includes one or more executable instructions for performing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term “ . . . unit” as used in the present embodiment refers to a software or hardware component, such as field-programmable gate array (FPGA) or application-specific integrated circuit (ASIC), which performs certain tasks. However, the term “ . . . unit” does not mean to be limited to software or hardware. A “ . . . unit” may be configured to be in an addressable storage medium or configured to operate one or more processors. Thus, according to an embodiment of the disclosure, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in the elements and “ . . . units” may be combined into fewer elements and “ . . . units” or further separated into additional elements and “ . . . units”. Further, the elements and “ . . . units” may be implemented to operate one or more central processing units (CPUs) in a device or a secure multimedia card. Also, according to an embodiment of the disclosure, a “ . . . unit” may include one or more processors.

Wireless communication systems providing voice-based services in early stages are being developed to broadband wireless communication systems providing high-speed and high-quality packet data services according to communication standards such as high speed packet access (HSPA), long term evolution (LTE) or evolved universal terrestrial radio access (E-UTRA), LTE-advanced (LTE-A), LTE-Pro of 3GPP, high rate packet data (HRPD), ultra mobile broadband (UMB) of 3GPP2, and 802.16e of the Institute of Electrical and Electronics Engineers (IEEE).

As a representative example of the broadband wireless communication systems, LTE systems employ orthogonal frequency division multiplexing (OFDM) for a downlink (DL) and employs single carrier-frequency division multiple access (SC-FDMA) for an uplink (UL). The UL refers to a radio link for transmitting data or a control signal from a terminal (e.g., a UE or an MS) to a base station (e.g., an eNB or a BS), and the DL refers to a radio link for transmitting data or a control signal from the base station to the terminal. The above-described multiple access schemes identify data or control information of each user in a manner that time-frequency resources for carrying the data or control information of each user are allocated and managed not to overlap each other, that is, to achieve orthogonality therebetween.

As post-LTE communication systems, i.e., 5G communication systems need to support services capable of freely reflecting and simultaneously satisfying various requirements of users, service providers, and the like. Services considered for the 5G systems include enhanced mobile broadband (eMBB), massive machine-type communication (mMTC), ultra-reliability low-latency communication (URLLC) services, or the like.

The eMBB aims to provide an improved data rate than a data rate supported by the legacy LTE, LTE-A, or LTE-Pro. For example, in a 5G communication system, the eMBB should be able to provide a peak data rate of 20 Gbps in a DL and a peak data rate of 10 Gbps in an UL at one BS. Also, the 5G communication system has to simultaneously provide a peak data rate and an increased user-perceived data rate of a terminal. In order to satisfy such requirements, there is a need for improvement in various transmission/reception technologies including an improved multiple-input multiple-output (MIMO) transmission technology. Also, a data rate required in the 5G communication system may be satisfied by using a frequency bandwidth wider than 20 MHz in the 3 GHz to 6 GHz or 6 GHz or more frequency band, instead of the LTE transmitting a signal by using maximum 20 MHz in the 2 GHz band.

Also, the mMTC is being considered to support application services such as IoT in the 5G communication system. In order to efficiently provide the IoT, the mMTC may require the support for a large number of terminals in a cell, improved coverage for a terminal, improved battery time, reduced costs of a terminal, and the like. Because the IoT is attached to various sensors and various devices to provide a communication function, the mMTC should be able to support a large number of terminals (e.g., 1,000,000 terminals/km²) in a cell. Also, because a terminal supporting the mMTC is likely to be located in a shadow region failing to be covered by the cell, such as the basement of a building, due to the characteristics of the service, the terminal may require wider coverage than other services provided by the 5G communication system. The terminal supporting the mMTC should be configured as a low-cost terminal and may require a very long battery life time of 10 to 15 years because it is difficult to frequently replace the battery of the terminal.

The URLLC refers to cellular-based wireless communication services used for mission-critical purposes. For example, services for remote control of robots or machinery, industrial automation, unmanned aerial vehicles, remote health care, emergency alerts, and the like may be considered. Therefore, the URLLC should provide communications providing very low latency and very high reliability. For example, a service supporting the URLLC should satisfy air interface latency of less than 0.5 milliseconds, and simultaneously has a requirement for a packet error rate of 10⁻⁵ or less. Thus, for the service supporting the URLLC, the 5G system should provide a transmit time interval (TTI) smaller than other services and may simultaneously have a design requirement for allocating wide resources in a frequency band so as to ensure reliability of a communication link.

The three services of the 5G, i.e., the eMBB, the URLLC, and the mMTC may be multiplexed and transmitted in one system. Here, in order to satisfy different requirements of the services, the services may use different transceiving schemes and different transceiving parameters. Obviously, the 5G is not limited to the afore-described three services.

For convenience of descriptions, the disclosure uses terms and names defined in the 3^{rd} Generation Partnership Project (3GPP) 5G/NR rules (e.g., 3GPP Technical Specification 38 series) or 3GPP LTE rules (e.g., 3GPP Technical Specification 36 series). However, the disclosure is not limited to these terms and names, and may be equally applied to communication systems conforming to other standards. For example, the disclosure may be applied to NR-Advance, a 6^{th}-generation (6G) mobile communication technology, or next-generation mobile communication systems developed thereafter while having similar technical backgrounds.

### [NR Time-Frequency Resource]

Hereinafter, a frame structure of a 5G system will now be described in detail with reference to drawings.

FIG. 1 illustrates a basic structure of a time-frequency domain that is a radio resource region in which data or control channel is transmitted in the 5G system.

In FIG. 1, the horizontal axis represents a time domain and the vertical axis represents a frequency domain. A basic unit of a resource in the time-frequency domain is a resource element (RE) 101 and may be defined as one OFDM symbol 102 on the time axis and one subcarrier 103 on the frequency axis. In the frequency domain, N_{SC}^{RB} (e.g., 12) consecutive REs may constitute one resource block (RB) 104.

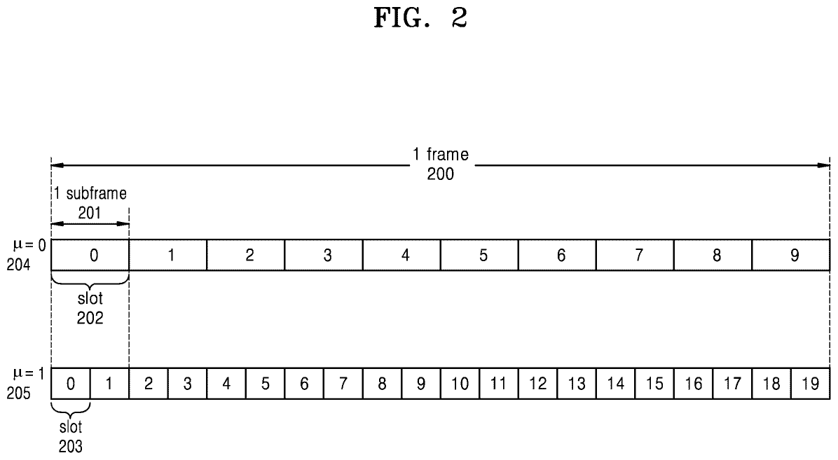

FIG. 2 illustrates a diagram of structures of a frame 200, a subframe 201, and slots 202 and 203 in a wireless communication system according to an embodiment of the disclosure.

FIG. 2 illustrates an example of a structure of the frame 200, the subframe 201, and the slot 202. One frame 200 may be defined as 10 ms. One subframe 201 may be defined as 1 ms, and thus, one frame 200 may consist of 10 subframes 201. One slot 202 or 203 may be defined as 14 OFDM symbols (that is, the number of symbols per 1 slot (N_{symb}^{slot})=14). One subframe 201 may consist of one slot 202 or a plurality of slots 203, and the number of slots 202 or 203 per one subframe 201 may vary according to a configuration value μ 204 or 205 for a configuration of a subcarrier spacing. The example of FIG. 2 shows a case in which μ=0 (204) and a case in which μ=1 (205), as a subcarrier spacing configuration value. When μ=0 (204), one subframe 201 may consist of one slot 202, and when μ=1 (205), one subframe 201 may consist of two slots 203. That is, the number of slots per one subframe (Nₛₗₒₜ^{subframe,μ}) may vary according to the configuration value p with respect to a subcarrier spacing, and thus, the number of slots per one frame (Nₛₗₒₜ^{frame,μ}) may vary accordingly. Nₛₗₒₜ^{subframe,μ} and Nₛₗₒₜ^{frame,μ} according to each subcarrier spacing configuration value p may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Hereinafter, configuration of bandwidth part (BWP) in the 5G communication system will now be described with reference to the drawings.

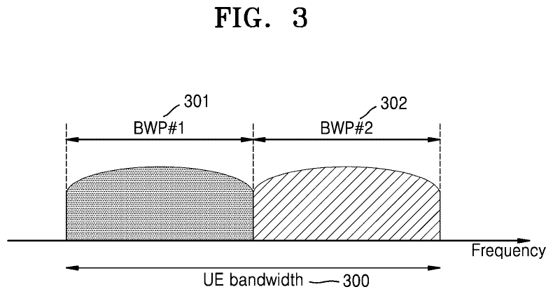

FIG. 3 illustrates a diagram of an example configuration of BWP in a wireless communication system according to an embodiment of the disclosure.

FIG. 3 illustrates the example in which a UE bandwidth 300 is configured into two BWPs, i.e., BWP #1 301 and BWP #2 302. A BS may configure a UE with one or more BWPs, and may configure, for each BWP, a plurality of pieces of information as in Table 2.

TABLE 2

| BWP ::= | SEQUENCE { |
|---|---|
| bwp-Id | BWP-Id, |
| (BWP identifier) | |
| locationAndBandwidth | INTEGER (1..65536), |
| (BWP location) | |
| subcarrierSpacing | ENUMERATED {n0, n1, n2, n3, n4, n5}, |
| (subcarrier spacing) | |
| cyclicPrefix | ENUMERATED { extended } |

```
    (cyclic prefix)
    }
```

The disclosure is not limited to the example, and thus, various parameters associated with the BWP may be configured for the UE, in addition to the configuration information. The plurality of pieces of information may be transmitted from the BS to the UE by higher layer signaling, e.g., radio resource control (RRC) signaling. At least one BWP among the configured one or more BWPs may be activated. Whether to activate a configured BWP may be notified from the BS to the UE semi-statically by RRC signaling or dynamically by downlink control information (DCI).

According to an embodiment of the disclosure, the UE may be configured by the BS with an initial BWP for initial access via a Master Information Block (MIB) before the UE is RRC connected. In more detail, the UE may receive, via the MIB in an initial access process, configuration information for a control resource set (CORESET) and a search space in which a physical downlink control channel (PDCCH) may be transmitted for reception of system information (e.g., remaining system information (RMSI) or system information block 1 (SIB1)) requested for initial access. Each of the control resource set and the search space which are configured as the MIB may be regarded as identity (ID) 0. The BS may notify, via the MIB, the UE of configuration information such as frequency allocation information, time allocation information, numerology, etc., for control resource set #0. Also, the BS may notify, via the MIB, the UE of configuration information such as a monitoring periodicity and occasion for the control resource set #0, i.e., configuration information for search space #0. The UE may regard a frequency region configured as the control resource set #0 obtained from the MIB, as the initial BWP for initial access. Here, the ID of the initial BWP may be regarded as 0.

Configuration of the BWP supported by the 5G communication system may be used for various purposes.

According to an embodiment of the disclosure, when a bandwidth supported by the UE is smaller than a system bandwidth, the BS may support this via configuration of the BWP. For example, the BS may configure the UE with a frequency location (configuration information 2) of the BWP, such that the UE may transmit or receive data in a particular frequency location in the system bandwidth.

Also, according to an embodiment of the disclosure, in order to support different numerologies, the BS may configure a plurality of BWPs for the UE. For example, in order to support data transmission and reception using both 15 KHz subcarrier spacing and 30 KHz subcarrier spacing for a certain UE, the BS may configure two BWPs with 15 KHz and 30 KHz subcarrier spacings, respectively. The different BWPs may be frequency division multiplexed, and in a case where a UE attempts to transmit and receive data with particular subcarrier spacing, a BWP configured with the subcarrier spacing may be activated.

Also, according to an embodiment of the disclosure, in order to reduce power consumption of the UE, the BS may configure BWPs with different bandwidth sizes for the UE. For example, when the UE supports very large bandwidth, e.g., 100 MHz bandwidth, and always transmits or receives data in the bandwidth, very high power consumption may occur. Particularly, in a situation where there is no traffic, monitoring unnecessary DL control channel in the large 100 MHz bandwidth may be very inefficient in terms of power consumption. In order to reduce the power consumption of the UE, the BS may configure a BWP with relatively small bandwidth, e.g., a 20 MHz BWP, for the UE. In the situation that there is no traffic, the UE may perform monitoring in the 20 MHz BWP, and when data occurs, the UE may transmit or receive the data on the 100 MHz BWP based on an indication from the BS.

In a method of configuring a BWP, UEs before being RRC connected may receive, via the MIB, configuration information for the initial BWP in an initial access process. In more detail, the UE may be configured, based on the MIB of a physical broadcast channel (PBCH), with a control resource set for a DL control channel on which DCI for scheduling a system information block (SIB) may be transmitted. A bandwidth of the control resource set configured based on the MIB may be regarded as the initial BWP, and the UE may receive, on the initial BWP, a physical downlink shared channel (PDSCH) on which the SIB is transmitted. The initial BWP may also be used for other system information (OSI), paging, or random access, in addition to reception of the SIB.

### [Switching of BWP]

When one or more BWPs are configured for the UE, the BS may indicate, to the UE, change (or, switching or transition) of BWP by using a BWP indicator field in DCI. For example, in FIG. 3, when a currently-activated BWP of the UE is BWP #1 301, the BS may indicate BWP #2 302 with a bandwidth indicator in DCI to the UE, and the UE may perform BWP switching to the BWP #2 302 indicated with the BWP indicator in the received DCI.

As described above, the DCI-based BWP switching may be indicated by DCI that schedules a PDSCH or a physical uplink shared channel (PUSCH), and thus, when the UE receives a BWP switching request, the UE may need to perform, in the switched BWP without difficulty, transmission or reception of the PDSCH or the PUSCH scheduled by the DCI. For this end, a requirement for a delay time T_{BWP} required for BWP switching is defined in the 3GPP standard, and, for example, may be defined as below.

TABLE 3

| | | BWP switch delay T_{BWP} (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

The requirement for BWP switching delay time supports type 1 or type 2 depending on a capability of the UE. The UE may report a supportable BWP delay time type to the BS.

According to the requirement for the BWP switching delay time, when the UE receives DCI including the BWP switching indicator in slot n, the UE may complete switching to a new BWP indicated by the BWP switching indicator no later than slot n+T_{BWP}, and may transmit or receive, on the new BWP, a data channel scheduled by the DCI. When the BS attempts to schedule the data channel on the new BWP, the BS may determine to allocate a time domain resource for the data channel by considering the BWP switching delay time (T_{BWP}) of the UE. That is, when the BS schedules a data channel on a new BWP, as for a method of determining time domain resource allocation for the data channel, the BS may schedule the data channel after the BWP switching delay time. Accordingly, the UE may not expect the DCI, which indicates BWP switching, to indicate a slot offset value (K0 or K2) smaller than the BWP switching delay time T_{BWP}.

If the UE receives DCI indicating BWP switching (e.g., DCI format 1_1 or 0_1), the UE may not perform any transmission or reception during time duration from a third symbol of the slot in which a PDCCH including the DCI is received to a starting point of a slot indicated by a slot offset value (K0 or K2) indicated in a time domain resource allocation indicator field in the DCI. For example, when the UE has received DCI indicating BWP switching in slot n and a slot offset value indicated by the DCI is K, the UE may not perform any transmission or reception from a third symbol of the slot n to a symbol before slot n+k (i.e., a last symbol of slot n+K−1).

### [Ss/Pbch Block]

Hereinafter, a synchronization signal (SS)/PBCH block in the 5G system will now be described.

An SS/PBCH block may refer to a physical layer channel block including primary SS (PSS), secondary SS (SSS), and PBCH. Details are as below.
PSS: a reference signal for DL time/frequency synchronization, which provides partial information of a cell ID.
SSS: a reference signal for DL time/frequency synchronization, which provides the rest of the cell ID information not provided by the PSS. In addition, the SSS may serve as another reference signal for demodulation of the PBCH.
PBCH: The PBCH provides essential system information requested for transmission or reception of data channel and control channel for UE. The essential system information may include search-space-associated control information indicating radio resource mapping information of the control channel, scheduling control information for a separate data channel to transmit system information, and the like.
SS/PBCH block: The SS/PBCH block is a combination of PSS, SSS, and PBCH. One or more SS/PBCH blocks may be transmitted within 5 ms, and each of the SS/PBCH blocks being transmitted may be identified by an index.

The UE may detect the PSS and the SSS in the initial access process, and may decode the PBCH. The UE may obtain an MIB from the PBCH and may be configured, via the MIB, with control resource set (CORESET) #0 (e.g., may correspond to control resource set whose control resource set index is 0). The UE may assume that demodulation reference signals (DMRSs) transmitted in the selected SS/PBCH block and control resource set #0 are quasi-co-located (QCL), and may perform monitoring with respect to the CORESET #0. The UE may receive system information via the DCI transmitted in the control resource set #0. The UE may obtain random-access-channel (RACH) related configuration information required for initial access from the received system information. The UE may transmit, to the BS, a physical RACH (PRACH) by considering the selected SS/PBCH index, and upon reception of the PRACH, the BS may obtain information about the SS/PBCH block index selected by the UE. The BS may identify that the UE has selected a certain block among the SS/PBCH blocks and monitors the control resource set #0 associated with the selected SS/PBCH block.

[PDCCH: Associated with DCI]

Hereinafter, DCI in the 5G system will now be described in detail.

In the 5G system, scheduling information for UL data (or PUSCH) or DL data (or PDSCH) is transmitted in the DCI from the BS to the UE. The UE may monitor a fallback DCI format and a non-fallback DCI format for PUSCH or PDSCH. The fallback DCI format may include a fixed field predefined between the BS and the UE, and the non-fallback DCI format may include a configurable field.

DCI may be transmitted on a PDCCH after channel coding and modulation processes. Cyclic redundancy check (CRC) may be added to a DCI message payload, and the CRC may be scrambled by a radio network temporary identifier (RNTI) that corresponds to an ID of the UE. Depending on a purpose of the DCI message, e.g., UE-specific data transmission, power control command, random access response, or the like, different RNTIs may be used. That is, the RNTI is not explicitly transmitted but is transmitted in a CRC calculation process. Upon reception of a DCI message transmitted on the PDCCH, the UE may check CRC by using an allocated RNTI, and when a result of the CRC checking is correct, the UE may identify that the DCI message is transmitted to the UE.

For example, DCI that schedules a PDSCH for system information (SI) may be scrambled by SI-RNTI. DCI that schedules a PDSCH for a random access response (RAR) message may be scrambled by an RA-RNTI. DCI that schedules a PDSCH for a paging message may be scrambled by a P-RNTI. DCI that notifies a slot format indicator (SFI) may be scrambled by an SFI-RNTI. DCI that notifies a transmit power control (TPC) may be scrambled by a TPC-RNTI. DCI that schedules UE-specific PDSCH or PUSCH may be scrambled by a Cell RNTI (C-RNTI).

DCI format 0_0 may be used for the fallback DCI that schedules a PUSCH, and here, the CRC may be scrambled by a C-RNTI. The DCI format 0_0 with the CRC scrambled by the C-RNTI may include a plurality of pieces of information of Table 4.

TABLE 4

| | |
|---|---|
| - | Identifier for DCI formats - [1] bit |
| - | Frequency domain resource assignment - [┌log₂(N_{RB}^{UL,BWP} (N_{RB}^{UL,BWP} + 1)/2)┐] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL indicator - 0 or 1 bit |

DCI format 0_1 may be used for the non-fallback DCI that schedules a PUSCH, and here, the CRC may be scrambled by a C-RNTI. The DCI format 0_1 with the CRC scrambled by the C-RNTI may include a plurality of pieces of information of Table 5.

```
TABLE 5
- Carrier indicator - 0 or 3 bits
- UL/SUL indicator - 0 or 1 bit
- Identifier for DCI formats - [1] bits
- Bandwidth part indicator - 0, 1 or 2 bits
- Frequency domain resource assignment
            · For resource allocation type 0, ┌N_{RB}^{UL,BWP}/P┐bits
            · For resource allocation type 1, ┌log₂(N_{RB}^{UL,BWP}(N_{RB}^{UL,BWP} + 1)/2)┐bits
- Time domain resource assignment -1, 2, 3, or 4 bits
- Virtual resource block (VRB)-to- physical resource block (PRB) mapping - 0 or 1 bit,
only for resource allocation type 1.
            · 0 bit if only resource allocation type 0 is configured;
            · 1 bit otherwise.
- Frequency hopping flag - 0 or 1 bit, only for resource allocation type 1.
            · 0 bit if only resource allocation type 0 is configured;
            · 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
            · 1 bit for semi-static HARQ-ACK codebook;
            · 2 bits for dynamic HARQ-ACK codebook with single HARQ-ACK codebook.
- 2nd downlink assignment index - 0 or 2 bits
· 2 bits for dynamic HARQ-ACK codebook with two HARQ-ACK sub-codebooks;
· 0 bit otherwise.
- TPC command for scheduled PUSCH - 2 bits
$- SRS resource indicator - ⌈ {log}_{2} ( {Σ}_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
          $⌈ {log}_{2} ( {Σ}_{k = 1}^{{L}_{max}} ( \begin{matrix}{N}_{SRS} \\ k\end{matrix} ) ) ⌉ bits for non - codebook based PUSCH transmission .$
            · ┌log₂(NSRS)┐ bits for codebook based PUSCH transmission.
- Precoding information and number of layers-up to 6 bits
- Antenna ports - up to 5 bits
- SRS request - 2 bits
- CSI request - 0, 1, 2, 3, 4, 5, or 6 bits
- Code block group (CBG) transmission information - 0, 2, 4, 6, or 8 bits
- PTRS-DMRS association - 0 or 2 bits.
- beta_offset indicator - 0 or 2 bits
- DMRS sequence initialization - 0 or 1 bit
```

DCI format 1_0 may be used for the fallback DCI that schedules a PDSCH, and here, the CRC may be scrambled by a C-RNTI. The DCI format 1_0 with the CRC scrambled by the C-RNTI may include a plurality of pieces of information of Table 6.

TABLE 6
- Identifier for DCI formats - [1] bit
- Frequency domain resource assignment -[┌log₂(N_{RB}^{DL,BWP} (N_{RB}^{DL,BWP} + 1)/2)┐] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator - 3 bits
- PDSCH-to-HARQ feedback timing indicator - [3] bits

DCI format 1_1 may be used for the non-fallback DCI that schedules a PDSCH, and here, the CRC may be scrambled by a C-RNTI. The DCI format 1_1 with the CRC scrambled by the C-RNTI may include a plurality of pieces of information of Table 7.

TABLE 7

| - | Carrier indicator - 0 or 3 bits | |
|---|---|---|
| - | Identifier for DCI formats - bits | |
| - | Bandwidth part indicator - 0, 1 or 2 bits | |
| - | Frequency domain resource assignment | |
| | • | For resource allocation type 0, ┌N_{RB}^{DL,BWP}/P┐ bits |
| | • | For resource allocation type 1, ┌log₂(N_{RB}^{DL,BWP} (N_{RB}^{DL,BWP} + 1)/2)┐ bits |
| - | Time domain resource assignment -1, 2, 3, or 4 bits | |
| - | VRB-to-PRB mapping - 0 or 1 bit, only for resource allocation type 1. | |
| | • | 0 bit if only resource allocation type 0 is configured; |
| | • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### [PDCCH: CORESET, REG, CCE, Search Space]

A DL control channel in the 5G communication system will now be described in detail with reference to related drawings.

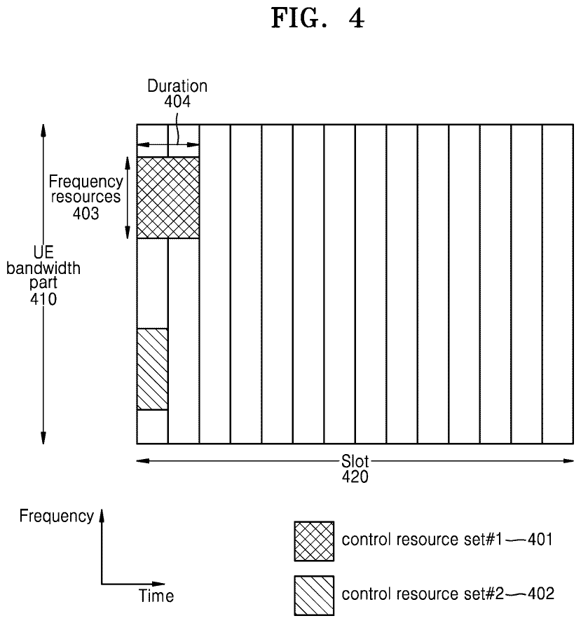

FIG. 4 illustrates an example of control resource set (CORESET) in which a DL control channel is transmitted in a 5G wireless communication system.

FIG. 4 illustrates the example in which UE BWP 410 is configured on the frequency axis, and two control resource sets (control resource set #1 401 and control resource set #2 402) are configured in a slot 420 on the time axis. The control resource sets 401 and 402 may be configured on particular frequency resources 403 in the full UE BWP 410 on the frequency axis. The control resource sets 401 and 402 may be configured as one or more OFDM symbols on the time axis, and may be defined as control resource set duration 404. Referring to the example of FIG. 4, the control resource set #1 401 may be configured as control resource set duration of two symbols, and the control resource set #2 402 may be configured as control resource set duration of one symbol.

The control resource set in the 5G communication system described above may be configured by the BS for the UE by higher layer signaling (e.g., system information (SI), MIB, or RRC signaling). Configuring the UE with a control resource set may be understood as providing information such as a control resource set ID, a frequency location of the control resource set, length of symbols of the control resource set, or the like. For example, a plurality of pieces of information of Table 8 may be included therein.

TABLE 8

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(CORESET Identity)

| | |
|---|---|
| frequencyDomainResources | BIT STRING (SIZE (45)), |

(frequency-axis resource allocation information)

| | |
|---|---|
| duration | INTEGER |

```
      (1..maxCoReSetDuration),
    (time-axis resource allocation information)
```

| | |
|---|---|
| cce-REG-MappingType | CHOICE { |

(CCE-to-REG mapping type)

interleaved
SEQUENCE {
reg-BundleSize
ENUMERATED {n2, n3, n6},

(REG bundle size)

```
  precoderGranularity
ENUMERATED {sameAsREG-bundle, allContiguousRBs},
  interleaverSize
ENUMERATED {n2, n3, n6}
  (interleaver size)
  shiftIndex
INTEGER(0..maxNrofPhysicalResourceBlocks-1)
```

OPTIONAL

(interleaver shift)

},

| | |
|---|---|
| non Interleaved | NULL |

```
      },
      tci-StatesPDCCH
```

SEQUENCE(SIZE (1..maxNrofTCI-StatesPDCCH)) OF TCI-StateId

OPTIONAL,

(QCL configuration information)

| | |
|---|---|
| tci-PresentInDCI | ENUMERATED |

{enabled}

OPTIONAL, -- Need S

}

In Table 8, tci-StatesPDCCH (simply, transmission configuration indication (TCI) state) configuration information may include information about channel state information reference signal (CSI-RS) indexes or one or more SS/PBCH block indexes having a QCL relation with a DMRS transmitted in the corresponding control resource set.

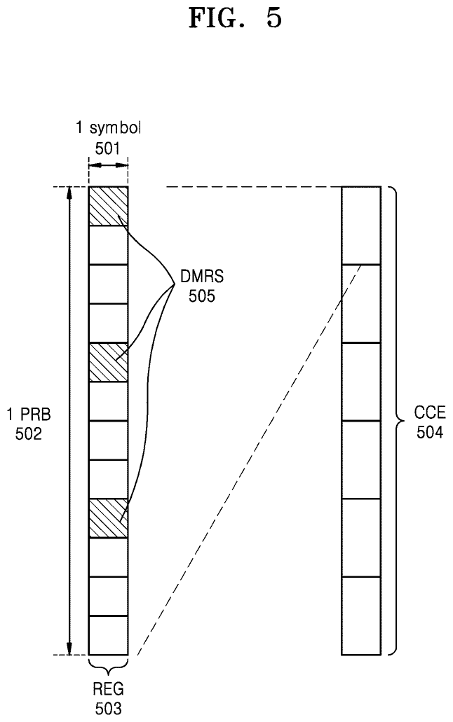

FIG. 5 illustrates an example of a basic unit of time and frequency resources that configure a DL control channel, according to an embodiment of the disclosure.

Referring to FIG. 5, a basic unit of time and frequency resources that configure a control channel may be referred to as a resource element group (REG) 503, and the REG 503 may be defined by one OFDM symbol 501 on the time axis and one physical resource block (PRB) 502, i.e., 12 subcarriers on the frequency axis. The BS may configure a DL control channel allocation unit by connecting REGs 503.

As illustrated in FIG. 5, when a basic unit with which the DL control channel is allocated is referred to as a control channel element (CCE) 504 in the 5G, the one CCE 504 may include a plurality of REGs 503. When describing, as an example, the REG 503 shown in FIG. 5, the REG 503 may include 12 REs, and when one CCE 504 includes 6 REGs 503, the one CCE 504 may include 72 REs. When the DL control resource set is configured, the resource set may include a plurality of CCEs 504, and a particular DL control channel may be transmitted by being mapped to one or more CCEs 504 based on an aggregation level (AL) in the control resource set. The CCEs 504 in the control resource set may be identified by numbers, and the numbers may be allocated to the CCEs 504 in a logical mapping scheme.

The basic unit of the DL control channel shown in FIG. 5, i.e., the REG 503, may include both REs to which DCI is mapped and a region to which DMRS 505 that is a reference signal for decoding the DCI is mapped. As shown in FIG. 5, three DMRSs 505 may be transmitted in one REG 503. The number of CCEs required to transmit the PDCCH may be 1, 2, 4, 8, or 16 depending on the AL, and different numbers of CCEs may be used to implement link adaptation of the DL control channel. For example, when AL=L, one DL control channel may be transmitted in L CCEs. The UE detects a signal without knowing information about the DL control channel, and thus, search space representing a set of CCEs may be defined for the blind decoding of the UE. The search space may be defined as a set of DL control channel candidates that include CCEs on which the UE needs to attempt decoding at a given AL, and because there are various ALs each making a bundle with 1, 2, 4, 8, or 16 CCEs, the UE may have a plurality of search spaces. A search space set may be defined as a set of search spaces at all the configured ALs.

The search spaces may be classified into common search spaces and UE-specific search spaces. A certain group of UEs or all the UEs may monitor a common search space of the PDCCH so as to receive dynamic scheduling of the system information or receive cell-common control information such as a paging message. For example, the UE may monitor the common search space of the PDCCH so as to receive PDSCH scheduling allocation information for transmitting an SIB including cell operator information or the like. Because a certain group of UEs or all the UEs need to receive the PDCCH, the common search space may be defined as a set of pre-defined CCEs. The UE may receive UE-specific PDSCH or PUSCH scheduling allocation information by monitoring the UE-specific search space of the PDCCH. The UE-specific search space may be UE-specifically defined as a function of various system parameters and an ID of the UE.

In the 5G, parameters of the search space of the PDCCH may be configured by the BS for the UE by using higher layer signaling (e.g., SIB, MIB, or RRC signaling). For example, the BS may configure the UE with the number of PDCCH candidates at each L, monitoring periodicity for the search space, monitoring occasion on symbols in the slot for the search space, a type of the search space (common search space or UE-specific search space), a combination of a DCI format to be monitored in the search space and an RNTI, a control resource set index to monitor the search space, or the like. For example, a plurality of pieces of information of Table 9 may be included therein.

TABLE 9

| | |
|---|---|
| SearchSpace ::= | SEQUENCE { |

```
      -- Identity of the search space. SearchSpaceId = 0 identifies the SearchSpace configured
      via PBCH (MIB) or ServingCellConfigCommon.
```

| | |
|---|---|
| searchSpaceId | SearchSpaceId, |

(search space identifier)

| | |
|---|---|
| controlResourceSetId | ControlResourceSetId, |

(control resource set identifier)

| | |
|---|---|
| monitoringSlotPeriodicityAndOffset | CHOICE { |

```
  (monitoring slot level periodicity)
        sl1
        NULL,
        sl2
        INTEGER (0..1),
        sl4
        INTEGER (0..3),
        sl5
        INTEGER (0..4),
        sl8
        INTEGER (0..7),
        sl10
        INTEGER (0..9),
        sl16
        INTEGER (0..15),
        sl20
        INTEGER (0..19)
      }
        OPTIONAL,
```

| | |
|---|---|
| duration(monitoring duration) | INTEGER (2..2559) |
| monitoringSymbolsWithinSlot | BIT STRING (SIZE |

(14))

OPTIONAL,

(monitoring symbol within slot)

| | |
|---|---|
| nrofCandidates | SEQUENCE { |

```
  (the number of PDCCH candidate groups within aggregation level)
        aggregationLevel1
        ENUMERATED {n0, n1, n2, n3, n4, n5, n6, n8},
        aggregationLevel2
        ENUMERATED {n0, n1, n2, n3, n4, n5, n6, n8},
        aggregationLevel4
        ENUMERATED {n0, n1, n2, n3, n4, n5, n6, n8},
        aggregationLevel8
        ENUMERATED {n0, n1, n2, n3, n4, n5, n6, n8},
        aggregationLevel16
        ENUMERATED {n0, n1, n2, n3, n4, n5, n6, n8}
      },
```

| | |
|---|---|
| searchSpaceType | CHOICE { |

```
      (search space type)
        -- Configures this search space as common search space (CSS) and DCI formats
      to monitor.
        common
        SEQUENCE {
    (common search space)
    }
        ue-Specific
        SEQUENCE {
    (UE-specific search space)
          -- Indicates whether the UE monitors in this USS for DCI formats 0-0
      and 1-0 or for formats 0-1 and 1-1.
          formats
        ENUMERATED {formats0-0-And-1-0, formats0-1-And-1-1},
          ...
        }
```

Based on the configuration information, the BS may configure the UE with one or more search space sets. According to an embodiment of the disclosure, the BS may configure search space set 1 and search space set 2 for the UE, and the BS may configure the UE to monitor DCI format A scrambled by an X-RNTI in the search space set 1 in the common search space and to monitor DCI format B scrambled by a Y-RNTI in the search space set 2 in the UE-specific search space.

Based on configuration information, one or more search space sets may be present in the common search space or the UE-specific search space. For example, search space set #1 and search space set #2 may be configured as the common search space, and search space set #3 and search space set #4 may be configured as the UE-specific search space.

In the common search space, combinations of DCI formats and RNTIs below may be monitored. Obviously, the combinations are not limited to an example below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, combinations of DCI formats and RNTIs below may be monitored. Obviously, the combinations are not limited to an example below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The RNTIs may conform to definitions and purposes below.
C-RNTI (Cell RNTI): for UE-specific PDSCH scheduling
TC-RNTI (Temporary Cell RNTI): for UE-specific PDSCH scheduling
CS-RNTI (Configured Scheduling RNTI): for semi-statically configured UE-specific PDSCH scheduling
RA-RNTI (Random Access RNTI): for PDSCH scheduling in a random access process
P-RNTI (Paging RNTI): for scheduling a PDSCH on which paging is transmitted
SI-RNTI (System Information RNTI): for scheduling a PDSCH on which system information is transmitted
INT-RNTI (Interruption RNTI): for indicating whether to puncture the PDSCH
TPC-PUSCH-RNTI (Transmit Power Control for PUSCH RNTI): for indicating power control command for a PUSCH
TPC-PUCCH-RNTI (Transmit Power Control for PUCCH RNTI): for indicating power control command for a PUCCH
TPC-SRS-RNTI (Transmit Power Control for SRS RNTI): for indicating power control command for an SRS

The DCI formats described above may conform to definitions as in an example of Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In the 5G, a search space at aggregation level L with control resource set p and search space set s may be represented as in Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level (AL)
n_{CI}: carrier index
N_{CCE,p}: a total number of CCEs being present in control resource set p
n_{s,f}^{μ}: slot index
M_{s,max}^{(L)}: the number of PDCCH candidate groups at aggregation level L
m_{s,n}_{_{CI}}=0, . . . , M_{s,max}^{(L)}−1: index of PDCCH candidate groups at aggregation level L
i=0, . . . , L−1
Y_{p,n} _{_{s,f}} _{^{μ}}=(Aₚ·Y_{p,n} _{_{s,f}} _{^{μ}}₋₁) mod D, Y_{p,-1}=n_RNTI≠0, Aₚ=39827 for pmod3=0, Aₚ=39829 for pmod3=1, Aₚ=39839 for pmod3=2,D=65537
n_RNTI: UE identifier
Y_{p,n} _{_{s,f}} _{^{μ}} value may correspond to 0 for common search space.
Y_{p,n} _{_{s,f}} _{^{μ}} value may be a value that changes by a UE Identity (C-RNTI or ID configured by the BS for the UE) and time index for the UE-specific search space.

In the 5G, it is possible to configure a plurality of search space sets with different parameters (e.g., the parameters in Table 9), and thus, a group of search space sets the UE monitors may be different every time. For example, when the search space set #1 is configured with X-slot periodicity and the search space set #2 is configured with Y-slot periodicity, where X and Y are different, the UE may monitor both the search space set #1 and the search space set #2 in a particular slot, and may monitor one of the search space set #1 and the search space set #2 in another particular slot.

### [Related to Rate Matching/Puncturing]

Hereinafter, a rate matching operation and a puncturing operation will now be described in detail.

When time and frequency resource A on which a random symbol sequence A is intended to be transmitted overlaps random time and frequency resource B, a rate matching operation or a puncturing operation may be considered for operations of transmission and reception of channel A (or the symbol sequence A), in consideration of resource C of a region on which the resource A and the resource B are overlapped. Detailed operations will now be provided.

### Rate Matching Operation

The BS may transmit the symbol sequence A by mapping channel A (or the symbol sequence A) to the whole resource A on which the symbol sequence A is intended to be transmitted to the UE, except for a region of the resource A which corresponds to the resource C overlapping the resource B. For example, when the symbol sequence A includes {symbol #1, symbol #2, symbol #3, and symbol #4}, the resource A includes {resource #1, resource #2, resource #3 and, resource #4} and the resource B includes {resource #3 and resource #5}, the BS may transmit the symbol sequence A by sequentially mapping the symbol sequence A to resources {resource #1, resource #2, and resource #4} of the resource A excluding {resource #3} that corresponds to the resource C. As a result, the BS may transmit the symbol sequence {symbol #1, symbol #2, and symbol #3} by respectively mapping them to {resource #1, resource #2, and resource #4}.

The UE may determine the resource A and the resource B from scheduling information for the symbol sequence A from the BS, and thus, may determine the resource C corresponding to the overlapping region between the resource A and the resource B. The UE may receive the symbol sequence A, assuming that the symbol sequence A is transmitted by being mapped to the whole resource A excluding the resource C. For example, when the symbol sequence A includes {symbol #1, symbol #2, symbol #3, and symbol #4}, the resource A includes {resource #1, resource #2, resource #3 and, resource #4} and the resource B includes {resource #3 and resource #5}, the UE may receive the symbol sequence A, assuming that the symbol sequence A is sequentially mapped to resources {resource #1, resource #2, and resource #4} of the resource A excluding {resource #3} corresponding to the resource C. As a result, the UE may assume that the symbol sequence {symbol #1, symbol #2, and symbol #3} is transmitted by being respectively mapped to {resource #1, resource #2, and resource #4}, and may perform a series of next operations.

### Puncturing Operation

When there is the resource C corresponding to an overlapping region between the whole resource A on which the symbol sequence A is intended to be transmitted to the UE and the resource B, the BS may map the symbol sequence A to the whole resource A but may perform transmission in the resource regions of the resource A excluding the resource C and may not perform transmission on the resource region corresponding to the resource C. For example, when the symbol sequence A includes {symbol #1, symbol #2, symbol #3, and symbol #4}, the resource A includes {resource #1, resource #2, resource #3 and, resource #4} and the resource B includes {resource #3 and resource #5}, the BS may map the symbol sequence A {symbol #1, symbol #2, symbol #3, and symbol #4} to the resource A {resource #1, resource #2, resource #3 and resource #4}, and may transmit a symbol sequence {symbol #1, symbol #2, and symbol #4} corresponding to resource regions {resource #1, resource #2, and resource #4} of the resource A excluding {resource #3} corresponding to the resource C without transmitting {symbol #3} mapped to {resource #3} corresponding to the resource C. As a result, the BS may transmit the symbol sequence {symbol #1, symbol #2, and symbol #4} by respectively mapping them to {resource #1, resource #2, and resource #4}.

The UE may determine the resource A and the resource B from scheduling information for the symbol sequence A from the BS, and thus, may determine the resource C corresponding to an overlapping region between the resource A and the resource B. The UE may receive the symbol sequence A assuming that the symbol sequence A is mapped to the whole resource A but transmitted only on the regions of the resource A excluding the resource C. For example, when the symbol sequence A includes {symbol #1, symbol #2, symbol #3, and symbol #4}, the resource A includes {resource #1, resource #2, resource #3 and, resource #4} and the resource B includes {resource #3 and resource #5}, the UE may perform reception, assuming that the symbol sequence A {symbol #1, symbol #2, symbol #3, and symbol #4} are mapped to the resource A {resource #1, resource #2, resource #3 and resource #4} but {symbol #3} mapped to {resource #3} corresponding to the resource C is not transmitted, and assuming that {symbol #1, symbol #2, and symbol #4} of the symbol sequence mapped to {resource #1, resource #2, and resource #4} of the resource A are transmitted without {resource #3} that corresponds to the resource C. As a result, the UE may assume that the symbol sequence {symbol #1, symbol #2, and symbol #4} are transmitted by being respectively mapped to {resource #1, resource #2, and resource #4}, and may perform a series of next operations.

Hereinafter, a rate matching resource configuring method for rate matching of the 5G communication system will now be described. Rate matching refers to adjustment of a size of a signal, in consideration of a resource amount for transmission of the signal. For example, rate matching of a data channel may refer that the data channel is mapped with respect to a specific time and frequency resource domain but is not transmitted, such that a size of data is adjusted.

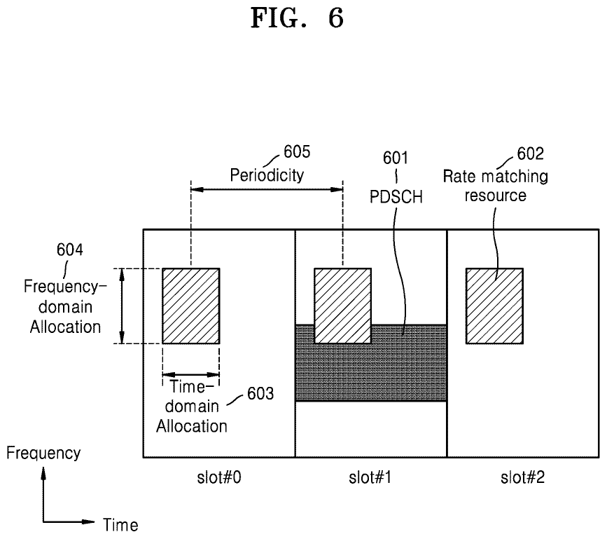

FIG. 6 illustrates a diagram for describing a method by which the BS and the UE transmit or receive data by considering a DL data channel 601 and a rate matching resource 602, according to an embodiment of the disclosure.

Referring to FIG. 6, a DL data channel (PDSCH) 601 and a rate matching resource 602 are illustrated. The BS may configure the UE with one or more rate matching resources 602 by higher layer signaling (e.g., RRC signaling). Configuration information for the rate matching resource 602 may include time-domain resource allocation information 603, frequency-domain resource allocation information 604, and periodicity information 605. Hereinafter, a bitmap corresponding to the frequency-domain resource allocation information 604 is referred to as a “first bitmap”, a bitmap corresponding to the time-domain resource allocation information 603 is referred to as a “second bitmap”, and a bitmap corresponding to the periodicity information 605 is referred to as a “third bitmap”. When all or some of time and frequency resources of the scheduled data channel 601 overlap the configured rate matching resource 602, the BS may transmit the data channel 601 by performing rate matching on the data channel 601 in a portion of the rate matching resource 602, and the UE may assume that the data channel 601 has been rate matched in the portion of the rate matching resource 602 and then may receive and decode the data channel 601.

Through additional configuration, the BS may dynamically notify whether to perform rate matching on the data channel in the portion of the configured rate matching resource to the UE via DCI (corresponding to the “rate matching indicator” in the DCI format described above). In more detail, the BS may select and group some of the configured rate matching resources into a rate matching resource group, and may indicate whether to perform rate matching on the data channel for each rate matching resource group to the UE via DCI by using a bitmap scheme. For example, when there are four rate matching resources configured, e.g., RMR #1, RMR #2, RMR #3, and RMR #4, the BS may configure rate matching groups RMG #1={RMR #1, RMR #2} and RMG #2={RMR #3, RMR #4}, and may indicate, by using 2 bits in a DCI field, whether to perform rate matching in each of RMG #1 and RMG #2 to the UE by a bitmap. For example, the BS may indicate “1” when the rate matching needs to be performed and may indicate “0” when the rate matching does not need to be performed.

The 5G supports “RB symbol level” and “RE level” granularities for a method of configuring the rate matching resource for the UE. In more detail, a configuration method below may be performed.

### RB Symbol Level

The UE may be configured with up to a maximum of four RateMatchPatterns for each BWP by higher layer signaling, and each RateMatchPattern may include information below.
For a reserved resource on a BWP, a resource configured with time and frequency resource region of the reserved resource in a combination of a symbol level bitmap and an RB level bitmap on the frequency axis may be included. The reserved resource may span one or two slots. A time domain pattern (periodicityAndPattern) in which a time and frequency region consisting of an RB-level and symbol-level bitmap pair is repeated may be additionally configured.
A time and frequency domain resource region configured with a CORESET on a BWP and a resource region corresponding to a time domain pattern configured with a search space configuration in which the time and frequency domain resource region is repeated may be included.

### RE Level

The UE may be configured with conditions below by higher layer signaling.
configuration information (lte-CRS-ToMatchAround) for an RE corresponding to an LTE cell-specific reference signal or common reference signal (CRS) pattern which may include the number of LTE CRS ports (nrofCRS-Ports), an LTE-CRS-vshift(s) value (v-shift), center subcarrier location information (carrierFreqDL) of an LTE carrier from a reference frequency point (e.g., reference point A), bandwidth size information of an LTE carrier (carrierBandwidthDL), subframe configuration information (mbsfn-SubframConfigList) corresponding to a multicast-broadcast single-frequency network (MBSFN). The UE may determine a location of a CRS in an NR slot corresponding to an LTE subframe based on a plurality of pieces of information described above.
Configuration information about a resource set corresponding to one or multiple zero power (ZP) CSI-RSs in a BWP.

### [PDSCH: Related to Frequency Resource Allocation]

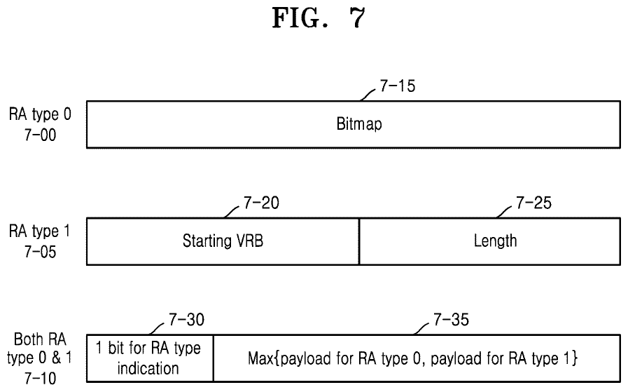

FIG. 7 illustrates an example of PDSCH frequency-axis resource allocation in a wireless communication system, according to an embodiment of the disclosure.

FIG. 7 illustrates three frequency-axis resource allocation methods, which are type 0 7-00, type 1 7-05, and dynamic switching 7-10, which are configurable by higher layer signaling in an NR wireless communication system.

Referring to FIG. 7, if the UE is configured, by higher layer signaling, to use only resource type 0 (7-00), some DCI to allocate a PDSCH to the UE has a bitmap consisting of NRBG bits. Conditions for the above will be described at a later time. Here, the NRGB refers to the number of resource block groups (RBGs) determined as in Table 11 below according to a size of a BWP allocated by the BWP indicator and a higher layer parameter rbg-Size, and data is transmitted on an RBG represented by 1 based in the bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured, by higher layer signaling, to use only resource type 1 (7-05), some DCI to allocate a PDSCH to the UE includes frequency-axis resource allocation information consisting of ┌log₂(N_{RB}^{DL,BWP}(N_{RB}^{DL,BWP}+1)/2)┐ bits. Conditions for the above will be described at a later time. Accordingly, the BS may configure a starting virtual resource block (VRB) 7-20 and length of frequency-axis resources 7-25 successively allocated therefrom.

If the UE is configured, by higher layer signaling, to use both the resource type 0 and the resource type 1 (7-10), some DCI to allocate a PDSCH to the UE includes frequency-axis resource allocation information consisting of bits 7-35 corresponding to a larger value among a payload 7-15 for configuring the resource type 0 and a payloads 7-20 and 7-25 for configuring the resource type 1. Conditions for the above will be described at a later time. In this case, 1 bit may be added to the front part (most significant bit, MSB) of the frequency-axis allocation information in the DCI, and when the bit has a value of ‘0’, it may indicate that the resource type 0 is to be used, and when the bit has a value of ‘1’, it may indicate that the resource type 1 is to be used.

### [PDSCH/PUSCH: Related to Time Resource Allocation]

Hereinafter, a time domain resource allocation method for a data channel in the next generation mobile communication system (5G or NR system) will now be described.

The BS may configure the UE with Table of time domain resource allocation information for a DL data channel (PDSCH) and a UL data channel (PUSCH) by higher layer signaling (e.g., RRC signaling). For the PDSCH, Table including up to a maximum of 16 (maxNrofDL−Allocations=16) entries may be configured, and for the PUSCH, Table including up to a maximum of 16 (maxNrofUL−Allocations=16) entries may be configured. In an embodiment of the disclosure, the time domain resource allocation information may include PDCCH-to-PDSCH slot timing (corresponding to a time interval in slots between a reception time of PDCCH and a transmission time of PDSCH scheduled by the received PDCCH, and indicated as K0), PDCCH-to-PUSCH slot timing (corresponding to a time interval in slots between a reception time of PDCCH and a transmission time of PUSCH scheduled by the received PDCCH, and indicated as K2), information about location and length of a start symbol scheduled on the PDSCH or the PUSCH in the slot, a mapping type of PDSCH or PUSCH, or the like. For example, information as in Table 12 or Table 13 below may be transmitted from the BS to the UE.

TABLE 12
PDSCH-TimeDomainResourceAllocationList information element

PDSCH-TimeDomainResourceAllocationList ::= SEQUENCE (SIZE(1..maxNrofDL-Allocations))
OF PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 13
PUSCH-TimeDomainResourceAllocation information element

PUSCH-TimeDomainResourceAllocationList ::= SEQUENCE (SIZE(1..maxNrofUL-Allocations))
OF PUSCH-TimeDomainResourceAllocation
PUSCH-TimeDomainResourceAllocation ::= SEQUENCE {

| | |
|---|---|
| k2 | INTEGER(0..32)OPTIONAL, -- Need S |

(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The BS may notify the UE of at least one of the entries in Table about the time domain resource allocation information by L1 signaling (e.g., the one entry may be indicated in a ‘time domain resource allocation’ field in the DCI). The UE may obtain the time domain resource allocation information for the PDSCH or the PUSCH, based on the DCI received from the BS.

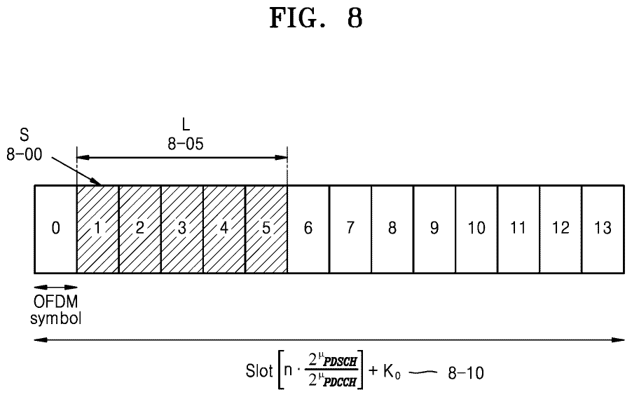

FIG. 8 illustrates an example of PDSCH time-axis resource allocation in a wireless communication system, according to an embodiment of the disclosure.

Referring to FIG. 8, the BS may indicate a location of a PDSCH resource in the time axis based on subcarrier spacing (SCS) (μ_{PDSCH}, μ_{PDCCH}) of a data channel and a control channel and a scheduling offset K0, which are configured by using higher layer signaling, and a start location 8-00 and length 8-05 of OFDM symbols in a slot dynamically indicated in DCI.

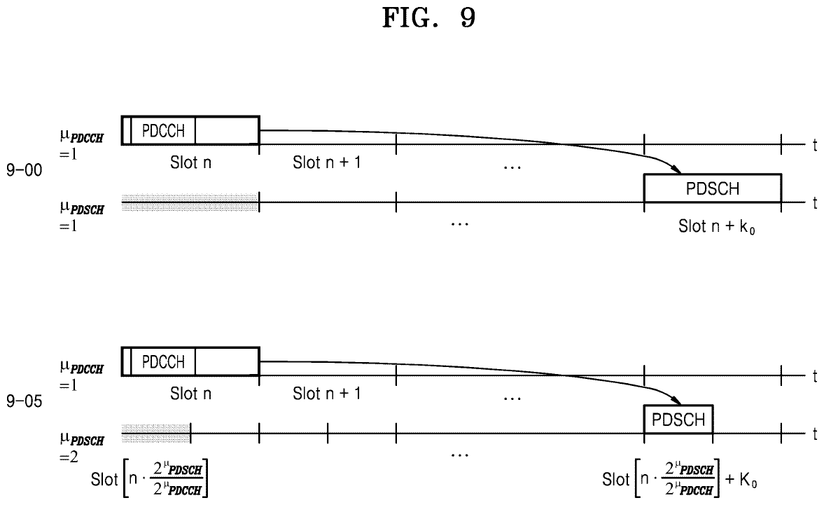

FIG. 9 illustrates an example of time-axis resource allocation based on SCS of a data channel and a control channel in a wireless communication system, according to an embodiment of the disclosure.

Referring to FIG. 9, when SCSs of the data channel and the control channel are equal, i.e., μ_{PDSCH}=μ_{PDCCH} (9-00), slot numbers for data and control are equal, such that the BS and the UE may generate a scheduling offset according to the preset slot offset K0. On the other hand, when SCSs of the data channel and the control channel are different, i.e., μ_{PDSCH}≠μ_{PDCCH} (9-05), slot numbers for data and control are different, such that the BS and the UE may generate a scheduling offset according to the preset slot offset K0 based on the SCS of the PDCCH.

### [PUSCH: Related to Transmission Scheme]

Hereinafter, a PUSCH transmission scheduling scheme will now be described. PUSCH transmission may be dynamically scheduled by UL grant in DCI or may be operated by configured grant Type 1 or Type 2. Dynamic scheduling indication for PUSCH transmission may be indicated by DCI format 0_0 or 0_1.

Configured grant Type 1 PUSCH transmission may be semi-statically configured not by receiving UL grant in DCI but by receiving configuredGrantConfig including rrc-ConfiguredUplinkGrant of [Table 14] below by higher layer signaling. Configured grant Type 2 PUSCH transmission may be semi-persistently scheduled by UL grant in DCI after receiving configuredGrantConfig that does not include rrc-ConfiguredUplinkGrant of Table 14 by higher layer signaling. When the PUSCH transmission is operated by configured grant, parameters to be applied to the PUSCH transmission are applied by higher layer signaling configuredGrantConfig of [Table 15] except for dataScramblingIdentityPUSCH, txConfig, codebookSubset, maxRank, scaling of UCI-OnPUSCH provided by higher layer signaling that is pusch-Config of [Table 14]. When the UE receives transformPrecoder in higher layer signaling that is configuredGrantConfig of [Table 14], the UE applies tp-pi2BPSK in pusch-Config of [Table 15] to the PUSCH transmission operated by the configured grant.

TABLE 14

| ConfiguredGrantConfig ::= | | SEQUENCE { |
|---|---|---|
| | frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resource Allocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED { enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, sym8x14, |

sym10x14, sym16x14, sym20x14,

sym32x14, sym40x14, sym64x14, sym80x14, sym128x14,

sym160x14, sym256x14, sym320x14, sym512x14,

```
  sym640x14, sym1024x14, sym1280x14, sym2560x14, sym5120x14,
  sym6, sym1x12, sym2x12, sym4x12, sym5x12, sym8x12, sym10x12,
```

sym16x12, sym20x12, sym32x12,

sym40x12, sym64x12, sym80x12, sym128x12, sym160x12,

sym256x12, sym320x12, sym512x12, sym640x12,

| | sym1280x12, sym2560x12 |
|---|---|
| }, | |
| configuredGrantTimer | INTEGER (1..64) |

OPTIONAL, -- Need R

| rrc-ConfiguredUplinkGrant | SEQUENCE { | |
|---|---|---|
| timeDomainOffset | INTEGER (0..5119), | |
| timeDomainAllocation | INTEGER (0..15), | |
| frequencyDomainAllocation | BIT STRING (SIZE(18)), | |
| antennaPort | INTEGER (0..31), | |
| dmrs-SeqInitialization | INTEGER (0..1) | OPTIONAL, |

-- Need R

| precodingAndNumberOfLayers | INTEGER (0..63), | |
|---|---|---|
| srs-ResourceIndicator | INTEGER (0..15) | OPTIONAL, |

-- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs-1), |

| ... | |
|---|---|
| } | OPTIONAL, -- Need R |

...

}

Hereinafter, a PUSCH transmission method will now be described. A DMRS antenna port for PUSCH transmission is equal to an antenna port for SRS transmission. PUSCH transmission may follow a codebook based transmission method or a non-codebook based transmission method depending on whether a value of txConfig in higher layer signaling that is pusch-Config of [Table 15] is ‘codebook’ or ‘nonCodebook’.

As described above, PUSCH transmission may be dynamically scheduled by DCI format 0_0 or 0_1, or may be semi-statically configured by the configured grant. If the UE receives an indication of scheduling of PUSCH transmission by DCI format 0_0, the UE performs beam configuration for PUSCH transmission by using pucch-spatialRelationInfoID corresponding to a UE-specific PUCCH resource corresponding to a smallest ID in an activated UL BWP in the serving cell, and in this regard, the PUSCH transmission is based on a single antenna port. The UE does not expect scheduling for the PUSCH transmission by DCI format 0_0 in a BWP on which a PUCCH resource including pucch-spatialRelationInfo is not configured. If the UE is not configured with txConfig in the pusch-Config of [Table 15], the UE does not expect to be scheduled by DCI format 0_1.

TABLE 15

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | |
|---|---|
| pusch-PowerControl | PUSCH-PowerControl |

OPTIONAL, -- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)

OPTIONAL, -- Need M

| | |
|---|---|
| resourceAllocation | ENUMERATED { resourceAllocationType0, |

resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent,nonCoherent}

OPTIONAL, -- Cond

codebookBased

| | | |
|---|---|---|
| maxRank | INTEGER (1..4) | OPTIONAL, -- Cond |

codebookBased

| | | |
|---|---|---|
| rbg-Size | ENUMERATED { config2} | OPTIONAL, -- |

Need S

| | |
|---|---|
| uci-OnPUSCH | SetupRelease { UCI-OnPUSCH} |

OPTIONAL, -- Need M

| | | |
|---|---|---|
| tp-pi2BPSK | ENUMERATED {enabled} | OPTIONAL, -- |

Need S
...
}

Hereinafter, codebook based PUSCH transmission will now be described. The codebook based PUSCH transmission may be dynamically scheduled by DCI format 00 or 0_1, or may be semi-statically operated by the configured grant. When the codebook based PUSCH transmission is dynamically scheduled by DCI format 0_1 or semi-statically configured by the configured grant, the UE determines a precoder for PUSCH transmission based on an SRS resource indicator (SRI), a transmission precoding matrix indicator (TPMI), and a transmission rank (the number of PUSCH transmission layers).

Here, the SRI may be given by an SRS resource indicator that is a field in DCI or may be configured by srs-ResourceIndicator that is higher layer signaling. The UE may be configured with at least one SRS resource for codebook based PUSCH transmission, and may be configured with up to two SRS resources. When the UE receives the SRI by DCI, an SRS resource indicated by the SRI refers to an SRS resource corresponding to the SRI among SRS resources transmitted before the PDCCH including the SRI. Also, the TPMI and the transmission rank may be given by precoding information and number of layers which is a field in the DCI or may be configured by precodingAndNumberOfLayers that is higher layer signaling. The TPMI is used to indicate a precoder to be applied to PUSCH transmission. If the UE is configured with one SRS resource, the TPMI is used to indicate a precoder to be applied in the configured one SRS resource. If the UE is configured with a plurality of SRS resources, the TPMI is used to indicate a precoder to be applied in the SRS resource indicated by the SRI.

The precoder to be used in PUSCH transmission is selected from a UL codebook having the same number of antenna ports as a value of nrofSRS-Ports in SRS-Config that is higher layer signaling. In the codebook based PUSCH transmission, the UE determines a codebook subset based on the TPMI and codebookSubset in pusch-Config that is higher layer signaling. The codebookSubset in the pusch-Config that is higher layer signaling may be configured as one of ‘fullyAndPartialAndNonCoherent’, ‘partialAndNonCoherent’, or ‘nonCoherent’, based on the UE capability reported by the UE to the BS. If the UE reports ‘partialAndNonCoherent’ in the UE capability, the UE does not expect that a value of codebookSubset that is higher layer signaling is configured to be ‘fullyAndPartialAndNonCoherent’. Also, if the UE reports ‘nonCoherent’ in the UE capability, the UE does not expect that a value of codebookSubset that is higher layer signaling is configured to be ‘fullyAndPartialAndNonCoherent’ or ‘partialAndNonCoherent’. When nrofSRS-Ports in SRS-ResourceSet that is higher layer signaling indicates two SRS antenna ports, the UE does not expect that a value of codebookSubset that is higher layer signaling is configured to be ‘partialAndNonCoherent’.

The UE may be configured with one SRS resource set with a value of the usage in SRS-ResourceSet that is higher layer signaling being configured to ‘codebook’, and one SRS resource in the SRS resource set may be indicated by the SRI. If several SRS resources are configured in the SRS resource set in which a value of the usage in SRS-ResourceSet that is higher layer signaling is configured to ‘codebook’, the UE expects that nrofSRS-Ports in SRS-Resource that is higher layer signaling is configured to have the same value for all SRS resources.

The UE transmits, to the BS, one or multiple SRS resources included in the SRS resource set with a value of the usage configured to ‘codebook’ by higher layer signaling, and the BS selects one of the SRS resources transmitted from the UE and indicates the UE to perform PUSCH transmission by using transmission beam information of the SRS resource. Here, for the codebook based PUSCH transmission, the SRI is used as information for selecting an index of the one SRS resource and is included in DCI. In addition, the BS may add, to the DCI, information indicating a TPMI and a rank to be used by the UE for PUSCH transmission. The UE performs, by using the SRS resource indicated by the SRI, PUSCH transmission by applying the precoder indicated by the rank and the TPMI indicated based on the transmission beam of the SRS resource.

Hereinafter, non-codebook based PUSCH transmission will now be described. The non-codebook based PUSCH transmission may be dynamically scheduled by DCI format 0_0 or 0_1, or semi-statically operated by the configured grant. When at least one SRS resource in an SRS resource set in which a value of the usage in SRS-ResourceSet that is higher layer signaling is configured to ‘nonCodebook’ is configured, the UE may be scheduled for non-codebook based PUSCH transmission by DCI format 0_1.

For the SRS resource set with a value of the usage in SRS-ResourceSet that is higher layer signaling being configured to ‘nonCodebook’, the UE may be configured with one associated non-zero power CSI-RS (NZP CSI-RS) resource. The UE may perform calculation on a precoder for SRS transmission by measuring the NZP CSI-RS resource associated with the SRS resource set. If a difference between a last reception symbol of an aperiodic NZP CSI-RS resource associated with the SRS resource set and a first symbol of aperiodic SRS transmission from the UE is less than 42 symbols, the UE does not expect that information about the precoder for SRS transmission is to be updated.

When a value of resourceType in SRS-ResourceSet that is higher layer signaling is configured to ‘aperiodic’, an associated NZP CSI-RS is indicated by the field SRS request in DCI format 0_1 or 1_1. Here, when the associated NZP CSI-RS resource is an aperiodic NZP CSI-RS resource, it indicates presence of an NZP CSI-RS associated for a case where the value of the field SRS request in DCI format 0_1 or 1_1 is not ‘00’. Here, the DCI shall not indicate cross carrier or cross BWP scheduling. Also, if the value of the SRS request indicates the presence of the NZP CSI-RS, the NZP CSI-RS is located in a slot in which a PDCCH including the SRS request field is transmitted. Here, TCI states configured for a scheduled subcarrier are not configured to QCL-TypeD.

If a periodic or semi-persistent SRS resource set is configured, an associated NZP CSI-RS may be indicated by associatedCSI-RS in SRS-ResourceSet that is higher layer signaling. For non-codebook based transmission, the UE does not expect both the spatialRelationInfo that is higher layer signaling for an SRS resource and associatedCSI-RS in the SRS-ResourceSet that is higher layer signaling to be configured.

When the UE is configured with a plurality of SRS resources, the UE may determine a precoder and a transmission rank to be applied to PUSCH transmission, based on the SRI indicated by the BS. Here, the SRI may be indicated by a SRS resource indicator that is a field in DCI or may be configured by srs-ResourceIndicator that is higher layer signaling. Likewise, in regard to the codebook based PUSCH transmission, when the UE is provided the SRI by DCI, an SRS resource indicated by the SRI refers to an SRS resource corresponding to the SRI among SRS resources transmitted before the PDCCH including the SRI. The UE may use one or more SRS resources in SRS transmission, and a maximum number of SRS resources available for simultaneous transmission on the same symbol in one SRS resource set and a maximum number of SRS resources are determined based on UE capability reported by the UE to the BS. In this case, the SRS resources simultaneously transmitted by the UE occupy a same RB. The UE configures one SRS port for each SRS resource. Only one SRS resource set with a value of the usage in SRS-ResourceSet that is higher layer signaling is configured to ‘nonCodebook’ may be configured, and up to a maximum of four SRS resources for non-codebook based PUSCH transmission may be configured.

The BS transmits one NZP-CSI-RS associated with the SRS resource set to the UE, and the UE calculates a precoder to be used in transmission of one or more SRS resources in the SRS resource set, based on a result of measurement performed in reception of the NZP_CSI-RS. The UE applies the calculated precoder to transmit, to the BS, one or more SRS resources in the SRS resource set with the usage configured to ‘nonCodebook’, and the BS selects one or more SRS resources from among the received one or more SRS resources. Here, for the non-codebook based PUSCH transmission, the SRI may indicate an index that can represent a combination of one or more SRS resources, and may be included in DCI. Here, the number of SRS resources indicated by the SRI transmitted from the BS may be the number of transmission layers of the PUSCH, and the UE transmits the PUSCH by applying, to each layer, the precoder applied to SRS resource transmission.

### [PUSCH: Preparation Procedure Time]

Hereinafter, a PUSCH preparation procedure time will now be described. When the BS schedules the UE to transmit a PUSCH by using DCI format 0_0, 01 or 0-2, the UE may need a PUSCH preparation procedure time to transmit the PUSCH by applying a transmission method (an SRS resource transmission precoding method, the number of transmission layers, or a spatial domain transmission filter) indicated by DCI. In consideration of information above, NR defines a PUSCH preparation procedure time. The PUSCH preparation procedure time of the UE may be calculated using [Equation 2] below.

$$[ Equation 2 ]$$

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} )$$

Variables in T_{proc,2} expressed in Equation 2 may have the following meanings.
N₂: the number of symbols determined according to UE processing capability 1 or 2 according to capability of the UE and numerology μ. When the UE capability 1 is reported in a UE capability report, it may have a value based on [Table 16], and when the UE capability 2 is reported in the UE capability report and when it is configured, by higher layer signaling, that the UE capability 2 is available, it may have a value based on [Table 17].

TABLE 16

| | PUSCH preparation time N₂ |
|---|---|
| μ | [symbols] |
| 0 | 10 |
| 1 | 12 |
| 2 | 23 |
| 3 | 36 |

TABLE 17

| | PUSCH preparation time N₂ |
|---|---|
| μ | [symbols] |
| 0 | 5 |
| 1 | 5.5 |
| 2 | 11 for frequency range 1 |

d_{2,1}: the number of symbols which is determined to be 0 when resource elements of the first OFDM symbol are all configured to consist of DMRSs, or 1 otherwise.
κ: 64
μ: This follows a value of μ_{DL} or μ_{UL} makes T_{proc,2} larger. μ_{DL} refers to numerology of a DL in which a PDCCH including DCI that schedules the PUSCH is transmitted, and μ_{UL} refers to numerology of a UL in which the PUSCH is transmitted.
T_{c} has a value of T_{c}: 1/(Δfₘₐₓ*N_{f}), Δfₘₐₓ=480*10³ Hz, N_{f}=4096.
d_{2,2}: This follows a BWP switching time when the DCI that schedules the PUSCH indicates BWP switching, or has 0 otherwise.
d₂: When OFDM symbols of a PUCCH, a PUSCH having a high priority index and a PUCCH having a low priority index overlap on the time domain, a d₂ value of the PUSCH having the high priority index is used. Otherwise, d₂ is 0.
Tₑₓₜ: When the UE uses a shared spectrum channel access scheme, the UE may calculate and apply Tₑₓₜ to the PUSCH preparation procedure time. Otherwise, Tₑₓₜ is assumed to be 0.
T_{switch}: When a UL switching interval is triggered, T_{switch} is assumed as a switching interval time. Otherwise, it is assumed to be 0.

In consideration of time-axis resource mapping information of the PUSCH scheduled by the DCI and an impact of timing advance between the UL and the DL, the BS and the UE determine that the PUSCH preparation procedure time is not sufficient when a first symbol of the PUSCH starts before a first UL symbol on which CP starts after T_{proc,2} from a last symbol of the PDCCH including the DCI that schedules the PUSCH. Otherwise, the BS and the UE determine that the PUSCH preparation procedure time is sufficient. Only when the PUSCH preparation procedure time is sufficient, the UE may transmit the PUSCH, and when the PUSCH preparation procedure time is not sufficient, the UE may ignore the DCI that schedules the PUSCH.

### [PUSCH: Related to Repetitive Transmission]

Hereinafter, UL data channel repetitive transmissions in the 5G system will now be described in detail. The 5G system may support two types of UL data channel repetitive transmission methods, i.e., PUSCH repetitive transmission type A and PUSCH repetitive transmission type B. The UE may be configured with one of the PUSCH repetitive transmission types A or B by higher layer signaling.

### 1. PUSCH Repetitive Transmission Type A

As described above, symbol length and a start symbol position of a UL data channel may be determined in a time domain resource allocation method in one slot, and the BS may notify the UE of the number of repetitive transmissions by higher layer signaling (e.g., RRC signaling) or L1 signaling (e.g., DCI).
The UE may repetitively transmit a UL data channel having a same length and start symbol as those of the UL data channel in consecutive slots, based on the number of repetitive transmissions received from the BS. In this case, when a slot configured by the BS for the UE in a DL or at least one of symbols of a UL data channel configured for the UE is configured for DL, the UE skips UL data channel transmission but counts the number of repetitive transmissions of the UL data channel. That is, a UL data channel may not be transmitted while the number of repetitive transmissions of the UL data channel is included. On the other hand, a UE configured to support Rel-17 UL data repetitive transmission may determine a slot as an available slot which is available for UL data repetitive transmission, and may count the number of transmissions when performing UL data channel repetitive transmission in the slot determined as the available slot. In a case where UL data channel repetitive transmission in the slot determined as the available slot is skipped, the UE may not count the skipped repetitive transmission, and may postpone and transmit the repetitive transmission in a next available slot.
In order to determine the available slot, if at least one symbol configured for time domain resource allocation (TDRA) for a PUSCH in a slot for PUSCH transmission overlaps a symbol for a different purpose (e.g., DL) other than UL transmission, the slot is determined as an unavailable slot (e.g., the slot that is not an available slot and is determined to be unavailable with respect to PUSCH transmission). Also, the available slot may be considered as a resource for PUSCH transmission and a UL resource for determining a transport block size (TBS) in a PDSCH repetitive transmission and in a multiple slots PUSCH transmission (transport block on multiple slots, TBoMS) consisting of one TB.

### 2. PUSCH Repetitive Transmission Type B

As described above, a start symbol and length of a UL data channel may be determined in a time domain resource allocation method in one slot, and the BS may notify the UE of numberofrepetitions that is the number of repetitive transmissions by higher layer signaling (e.g., RRC signaling) or L1 signaling (e.g., DCI).
Based on the start symbol and length of the UL data channel which are previously configured, nominal repetition of the UL data channel is determined as below. A slot in which n-th nominal repetition starts is given by

$${K}_{s} + ⌊ \frac{S + n \cdot L}{{N}_{symb}^{slot}} ⌋$$

and a symbol starting in the slot is given by mod(S+n·L, N_{symb}^{slot}). A slot in which the n-th nominal repetition ends is given by

$${K}_{s} + ⌊ \frac{s + ( n + 1 ) \cdot L - 1}{{N}_{symb}^{slot}} ⌋ ,$$

and a symbol that ends in the slot is given by mod(S+(n+1)·L−1, N_{symb}^{slot}). Here, n=0, . . . , numberofrepetitions−1, S indicates a start symbol of the configured UL data channel, and L indicates symbol length of the configured UL data channel. Kₛ indicates a slot in which the PUSCH transmission starts, and N_{symb}^{slot}, indicates the number of symbols per slot.
The UE may determine a specific OFDM symbol as an invalid symbol for the PUSCH repetitive transmission type B for a case below.

A symbol configured for DL by tdd-UL-DL-ConfigurationCommon or tdd-UL-DL-ConfigurationDedicated is determined as an invalid symbol for the PUSCH repetitive transmission type B.
Symbols indicated as ssb-PositionsInBurst in SIB1 for receiving SSB in an unpaired spectrum (TDD spectrum or as ssb-PositionsInBurst in ServingCellConfigCommon that is higher layer signaling may be determined as an invalid symbol for the PUSCH repetitive transmission type B.
Symbols indicated via pdcch-ConfigSIB1 in an MIB so as to transmit a control resource set connected to Type0-PDCCH CSS set in an unpaired spectrum (TDD spectrum) may be determined as an invalid symbol for the PUSCH repetitive transmission type B.
In an unpaired spectrum (TDD spectrum), if numberOfInvalidSymbolsForDL-UL-Switching that is higher layer signaling is configured, symbols configured for a DL by tdd-UL-DL-ConfigurationCommon or tdd-UL-DL-ConfigurationDedicated may be determined as invalid symbols for symbol duration of numberOfInvalidSymbolsForDL-UL-Switching.

In addition, the invalid symbol may be configured by a higher layer parameter (e.g., InvalidSymbolPattern). The higher layer parameter (e.g., InvalidSymbolPattern) may provide a symbol-level bitmap spanning one slot or two slots such that the invalid symbol may be configured. In addition, periodicity and a pattern of the bitmap may be configured by a higher layer parameter (e.g., periodicityAndPattern). If the higher layer parameter (e.g., InvalidSymbolPattern) is configured and parameter InvalidSymbolPatternIndicator-ForDCIFormat0_1 or InvalidSymbolPatternIndicator-ForDCIFormat0_2 indicates 1, the UE applies an invalid symbol pattern, and when the parameter indicates 0, the UE does not apply the invalid symbol pattern. If the higher layer parameter (e.g., InvalidSymbolPattern) is configured and the parameter InvalidSymbolPatternIndicator-ForDCIFormat0_1 or InvalidSymbolPatternIndicator-ForDCIFormat0_2 is not configured, the UE applies the invalid symbol pattern.

After the invalid symbol is determined, the UE may consider symbols other than the invalid symbol as valid symbols for each nominal repetition. When one or more valid symbols are included in each nominal repetition, the nominal repetition may include one or more actual repetitions. Here, each of the actual repetitions includes a set of consecutive valid symbols available for the PUSCH repetitive transmission type B in one slot. If a length of an OFDM symbol of nominal repetition is not 1, and a length of actual repetition is 1, the UE may ignore transmission of the actual repetition.

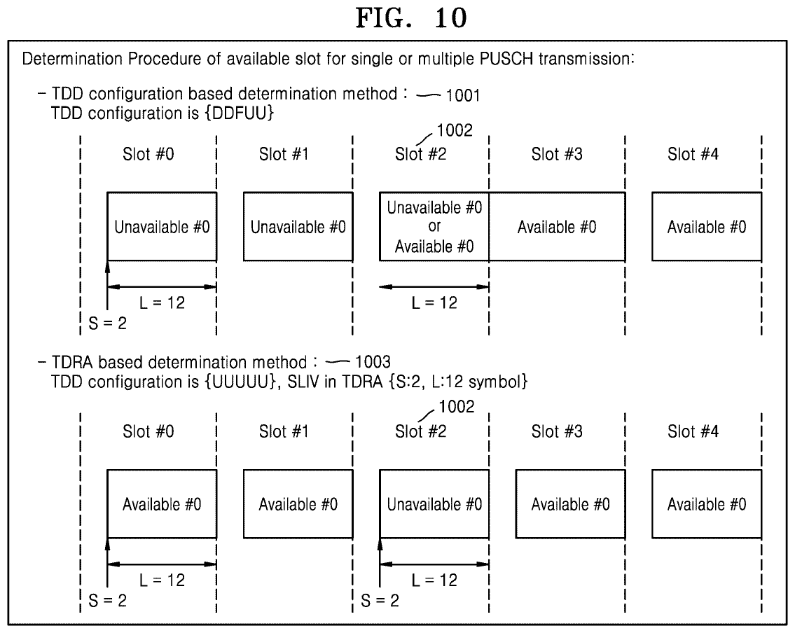

FIG. 10 illustrates an example of PUSCH repetitive transmission type A in a wireless communication system, according to an embodiment of the disclosure.

When a BS configures a UL resource by higher layer signaling (e.g.: tdd-UL-DL-ConfigurationCommon or tdd-UL-DL-ConfigurationDedicated) or L1 signaling (e.g.: dynamic slot format indicator), the BS and a UE may determine an available slot with respect to the configured UL resource, according to two methods below.
The method of determining an available slot, based on time division duplex (TDD) configuration
The method of determining an available slot, in consideration of TDD configuration and time domain resource allocation (TDRA), configured grant (CG) configuration or activation DCI

As an example of the method of determining an available slot, based on TDD configuration, when TDD configuration is configured as ‘DDFUU’ by higher layer signaling, the BS and the UE may determine, as available slots, slot #3 and slot #4 that are configured for UL ‘U’, based on TDD configuration (1001). Here, slot #2 (1002) that is configured as a flexible slot ‘F’, based on TDD configuration, may be determined as an unavailable slot or an available slot, and for example, may be predefined by BS configuration.

As an example of the method of determining an available slot, in consideration of TDD configuration and TDRA, CG configuration or activation DCI, in FIG. 10, when TDD configuration is configured as ‘UUUUU’ by higher layer signaling, and a start and length indicator value (SLIV) of PUSCH transmission is configured as {S: 2, L: 12 symbol} by L1 signaling, the BS and the UE may determine slot #0, slot #1, slot #3, slot #4 as available slots which satisfy the SLIV of a PUSCH with respect to the configured UL slot ‘U’. The BS and the UE may determine slot #2(‘L=9’ ≤SLIV ‘L=12’) as an unavailable slot which does not satisfy the SLIV that is a TDRA condition for the PUSCH transmission. However, this is merely an example and is not limited to the PUSCH transmission, and thus, is also applicable to PUCCH transmission, PUSCH/PUCCH repetitive transmission, nominal repetition of a PUSCH repetition type B, and TBoMS.

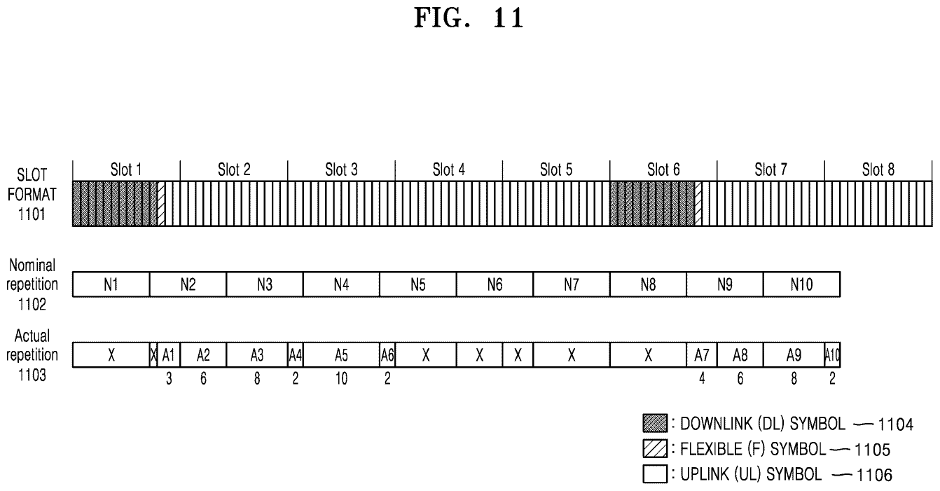

FIG. 11 illustrates an example of a PUSCH repetitive transmission type B in a wireless communication system, according to an embodiment of the disclosure.

FIG. 11 illustrates a case in which, with respect to nominal repetition, a UE is configured with 0 as a transmission start symbol S, 10 as a transmission symbol length L, and 10 as the number of nominal repetitions, and in FIG. 11, the nominal repetitions may be expressed as N1 to N10 (1102). Here, the UE may determine actual repetition by determining an invalid symbol, in consideration of a slot format 1101, and in FIG. 11, the actual repetition may be expressed as A1 to A10 (1103). Here, according to the method of determining an invalid symbol and actual repetition, a PUSCH repetition type B is not transmitted on a symbol for which a slot format is determined as a DL, and when there is a slot boundary within nominal repetition, actual repetition may be divided into two actual repetitions based on the slot boundary and may be transmitted. For example, A1 indicating first actual repetition may consist of three OFDM symbols, and A2 to be transmitted thereafter may consist of six OFDM symbols.

### [PUSCH: Related to UCI Transmission Scheme]

Next, an uplink control information (UCI) transmission scheme via a PUSCH will now be described.

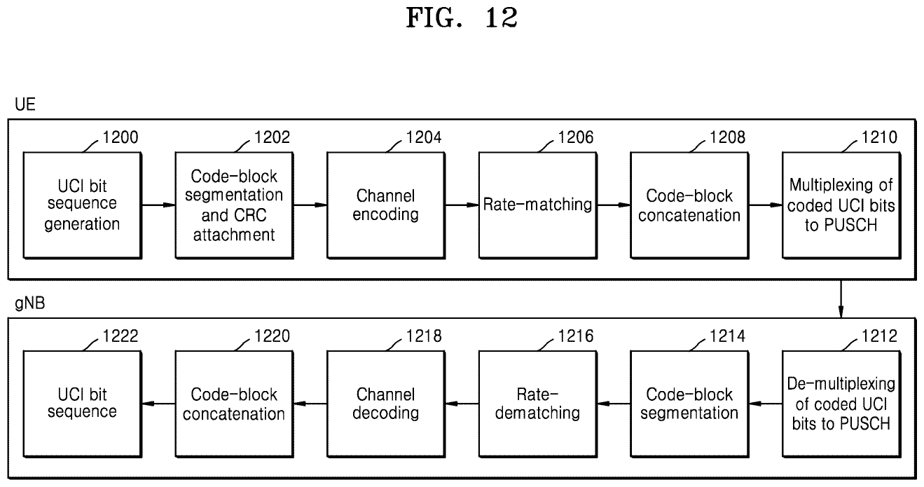

FIG. 12 illustrates a procedure for transmitting and receiving UCI information in a PUSCH between a UE and a BS, according to an embodiment of the disclosure.

Referring to FIG. 12, the UE generates UCI information (1200). In operation 1202, the UE determines a size of the UCI information, and when the size of the UCI information is equal to or less than 11 bits, the UE does not include CRC in the UCI information, and when the size is greater than 12 bits, the UE may additionally perform code block segmentation according to the size of the UCI information or may include CRC. In operation 1204, when the size of the UCI information is equal to or less than 11 bits, the UE may perform channel coding of small block lengths, and when the size is greater than 12 bits, the UE may perform polar coding. In operation 1206, the UE performs rate-matching according to a type of UCI information, and calculates the number of coded modulation symbols. The UE concatenates code-blocks in operation 1208, and multiplexes UCI bit information coded in a PUSCH in operation 1210.

After the UE transmits the modulated PUSCH to the gNB, in operation 1212, the gNB demodulates the PUSCH and demultiplexes the coded UCI bits in the PUSCH. The gNB segments the received information in units of code-blocks in operation 1214, and performs rate-dematching in operation 1216. In operation 1218, the gNB performs decoding by using a coded channel coding scheme according to the size of the UCI information. The gNB concatenates decoded code-blocks in operation 1220, and obtains the UCI information in operation 1222. The flowchart described with reference to FIG. 12 is merely an example, and at least one of operations 1200 to 1222 may be skipped, according to a specific condition. Also, an additional operation may be added to operations included in the flowchart described with reference to FIG. 12 and may be performed.

### [PUSCH: Related to UCI Rate Matching]

Next, rate-matching with respect to UCI in the UCI transmission scheme described above will now be described in detail. Before rate-matching with respect to UCI is described, a case in which UCI is multiplexed in a PUSCH will now be described. When a PUCCH and a PUSCH overlap, and a timeline condition for UCI multiplexing is satisfied, the UE may multiplex, in the PUSCH, hybrid automatic repeat request-acknowledgement (HARQ-ACK) and/or CSI information included in the PUCCH, according to UCI information included in the PUSCH, and may not transmit the PUCCH. Here, the timeline condition for UCI multiplexing may refer to TS 38.213 clause 9.2.5 of the 3GPP rules. As an example of the timeline condition for UCI multiplexing, if one of PUCCH transmission or PUSCH transmission is scheduled via DCI, the UE may perform UCI multiplexing only when a first symbol S₀ of an earliest PUCCH or PUSCH among PUCCHs and PUSCHs which overlap in a slot satisfies a condition below.
S₀ is not a symbol transmitted before a symbol including CP that starts after T_{proc,1}^{mux} after a last symbol of a corresponding PDSCH. Here, T_{proc,1}^{mux} is a maximum value among {T_{proc,1}^{mux,1}, . . . , T_{proc,1}^{mux,i}, . . . }) with respect to i^{th} PDSCH associated with HARQ-ACK transmitted in a PUCCH in the group of overlapping PUCCHs and PUSCHs. T_{proc,1}^{mux,i} is a processing procedure time with respect to i^{th} PDSCH and is defined as T_{proc,1}^{mux,i}=(N₁+d_{i,1})·(2048+144)·κ·2^{-μ}·T_{c}. Here, d_{1,i} is a value determined for I^{th} PDSCH by referring to TS 38.214 clause 5.3 of the 3GPP rules, and N₁ is a PDSCH processing time value according to PDSCH processing capability. μ is a smallest subcarrier configuration value among all PUSCHs of a PDCCH scheduling an i^{th} PDSCH, an i^{th} PDSCH, a PUCCH including HARQ-ACK for the i^{th} PDSCH, and the group of overlapping PUCCHs and PUSCHs. T_{C} is

$$\frac{1}{Δ {f}_{max} \cdot {N}_{f}} ,$$

Δfₘₐₓ=480·10³ Hz, N_{f}=4096, κ is 64.

This is a part of the timeline condition for UCI multiplexing, and additionally, when all conditions are satisfied, in consideration of TS 38.213 clause 9.2.5 of the 3GPP rules, the UE may perform UCI multiplexing on a PUSCH.

When a PUCCH and a PUSCH overlap, the timeline condition for UCI multiplexing is satisfied, and the UE determines to multiplex, in the PUSCH, UCI included in the PUCCH, the UE performs UCI rate-matching for multiplexing UCI. UCI multiplexing is performed in order of HARQ-ACK and configured grant-UCI (CG-UC), CSI part 1, CSI part 2. The UE performs rate-matching, in consideration of UCI multiplexing order. Therefore, the UE calculates a coded modulation symbol for each layer with respect to HARQ-ACK and CG-UCI, and, based on the calculation, calculates a coded modulation symbol for each layer of CSI part 1. Afterward, based on the coded modulation symbol for each layer with respect to HARQ-ACK, CG-UCI, and CSI part 1, the UE calculates a coded modulation symbol for each layer of CSI part 2.

When performing rate-matching according to each UCI type, a method of calculating the number of coded modulation symbols for each layer varies according to a repetitive transmission type of a PUSCH in which UCI is to be multiplexed, and whether UL data (uplink shared channel (UL-SCH)) is included. For example, when performing layer-matching with respect to HARQ-ACK, calculation of a coded modulation symbol for each layer according to the PUSCH in which UCI is to be multiplexed is as shown in Equation below.

$$[ Equation 3 ]$$

$${Q}_{ACK}^{′} = min \text{} \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{PUSCH} - 1} {M}_{sc}^{UCI} ( l ) ⌉ \}$$

$$[ Equation 4 ]$$

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \}$$

$$[ Equation 5 ]$$

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \}$$

[Equation 3] is calculation of a coded modulation symbol for each layer with respect to HARQ-ACK to be multiplexed in a PUSCH that includes UL-SCH and is not a PUSCH repetitive transmission type B, and [Equation 4] is calculation of a coded modulation symbol for each layer with respect to HARQ-ACK to be multiplexed in a PUSCH that includes UL-SCH and is a PUSCH repetitive transmission type B. [Equation 5] is calculation of a coded modulation symbol for each layer with respect to HARQ-ACK to be multiplexed in a PUSCH not including UL-SCH. In [Equation 3], O_{ACK} indicates the number of HARQ-ACK bits. L_{ACK} indicates the number of CRC bits with respect to HARQ-ACK. β_{offest}^{PUSCH} is beta offset with respect to HARQ-ACK and is equal to β_{offest}^{HARQ-ACK}. C_{UL-SCH} indicates the number of code-blocks of UL-SCH for PUSCH transmission, and Kᵣ indicates a code-block size of an r^{th} code-block. M_{SC}^{UCI}(l) indicates the number of resource elements of l symbol available for UCI transmission, and the number is determined according to presence or non-presence of a DMRS and a phase tracking reference signal (PTRS) of the l symbol. If the l symbol includes the DMRS, M_{SC}^{UCI}(l)=0. For l symbol not including a DMRS, M_{SC}^{UCI}(l)=M_{SC}^{PUSCH}−M_{SC}^{PT-RS}(l). M_{SC}^{PUSCH} indicates the number of subcarriers for a bandwidth in which PUSCH transmission is scheduled, and M_{SC}^{PT-RS}(l) indicates the number of subcarriers including a PTRS in an l symbol. N_{symb,all}^{PUSCH} indicates the number of all symbols of a PUSCH. α indicates higher layer parameter scaling, and means a ratio of resources in which UCI can be multiplexed to all resources for PUSCH transmission. l₀ indicates an index of a first symbol not including a DMRS after a first DMRS. In [Equation 4], M_{sc,nominal}^{UCI}(l) indicates the number of resource elements available for UCI transmission with respect to nominal repetition, is 0 for a symbol including a DMRS, and is the same as M_{sc,nominal}^{UCI}(l)=M_{SC}^{PUSCH}−M_{sc,nominal}^{PT-RS}(l) for a symbol not including a DMRS, and M_{sc,nominal}^{PT-RS}(l) indicates the number of subcarriers including a PTRS in a l symbol with respect to a PUSCH for which nominal repetition is assumed. N_{symb,nominal}^{PUSCH} indicates the number of all symbols with respect to nominal repetition of the PUSCH. M_{sc,actual}^{UCI}(l) indicates the number of resource elements available for UCI transmission with respect to actual repetition, is 0 for a symbol including a DMRS, and is the same as M_{sc,actual}^{UCI}(l)=M_{sc}^{PUSCH}−M_{sc,actual}^{PT-RS}(l) for a symbol not including a DMRS, and M_{sc,actual}^{PT-RS}(l) indicates the number of subcarriers including a PTRS in an l symbol with respect to actual repetition of a PUSCH. N_{sc,actual}^{PUSCH} indicates the number of all symbols with respect to actual repetition of the PUSCH. In [Equation 5], R is a code-rate of a PUSCH, and Qₘ is a modulation order of the PUSCH.

While the number of coded modulation symbols for each layer of CSI part 1 for which rate-matching has been performed may be calculated in a similar manner to HARQ-ACK, the number of maximally applicable resources from among all resources may be decreased to a value excluding the number of coded modulation symbols with respect to HARQ-ACK/CG-UCI. Calculation of a coded modulation symbol for each layer of CSI part 1 is as shown in [Equation 6], [Equation 7], [Equation 8], and [Equation 9], according to a repetitive transmission type of a PUSCH and whether or not the UL-SCH is included.

$$[ Equation 6 ]$$

$${Q}_{CSI - 1}^{′} = min \text{} \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$$

$$[ Equation 7 ]$$

$${Q}_{CSI - 1}^{′} = min \text{} \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , {\sum }_{l = 0}^{{N}_{symb , actual}^{PUSCH} - 1} {M}_{sc , actual}^{UCI} ( l ) - {Q}_{ACK / CG - UCI}^{′} \}$$

$$[ Equation 8 ]$$

$${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′} \qquad [ Equation 9 ]$$

[Equation 6] is calculation of a coded modulation symbol for each layer of CSI part 1 to be multiplexed in a PUSCH including UL-SCH and not being a PUSCH repetitive transmission type B, and [Equation 7] is calculation of a coded modulation symbol for each layer of CSI part 1 to be multiplexed in a PUSCH including UL-SCH and being a PUSCH repetitive transmission type B. [Equation 8] is calculation of a coded modulation symbol for each layer of CSI part 1 to be multiplexed, when CSI part 1 and CSI part 2 are multiplexed in a PUSCH not including UL-SCH. [Equation 9] is calculation of a coded modulation symbol for each layer of CSI part 1 to be multiplexed, when CSI part 2 is not multiplexed in a PUSCH not including UL-SCH. In [Equation 6], O_{CSI-1} and L_{CSI-1} respectively indicate the number of bits for CSI part 1 and the number of CRC bits for CSI part 1. β_{offset}^{PUSCH} is beta offset with respect to CSI part 1 and is equal to β_{offset}^{CSI-part1}. Q′_{ACK/(CG-UCI)} indicates the number of coded modulation symbols for each layer, which is calculated with respect to HARQ-ACK and/or CG-UCI. Parameters other than those described above are equal to parameters required in calculating the number of coded modulation symbols for each layer with respect to HARQ-ACK.

While the number of coded modulation symbols for each layer of CSI part 2 for which rate-matching has been performed may be calculated in a similar manner to CSI part 1, the number of maximally applicable resources from among all resources may be decreased to a value excluding the number of coded modulation symbols with respect to HARQ-ACK/CG-UCI and the number of coded modulation symbols for CSI part 2. Calculation of a coded modulation symbol for each layer of CSI part 1 is as shown in [Equation 10], [Equation 11], and [Equation 12], according to a repetitive transmission type of a PUSCH and whether or not the UL-SCH is included.

$$[ Equation 10 ]$$

$${Q}_{CSI - 2}^{′} = min \text{} \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$$

$$[ Equation 11 ]$$

$${Q}_{CSI - 2}^{′} = min \text{} \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{\frac{ACK}{CG} - UCI}^{′} - {Q}_{CSI - 1}^{′} , {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$$

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} \qquad [ Equation 12 ]$$

[Equation 10] is calculation of a coded modulation symbol for each layer with respect to CSI part 2 to be multiplexed in a PUSCH that includes UL-SCH and is not a PUSCH repetitive transmission type B, and [Equation 11] is calculation of a coded modulation symbol for each layer with respect to CSI part 2 to be multiplexed in a PUSCH that includes UL-SCH and is a PUSCH repetitive transmission type B. In [Equation 10], O_{CSI-2} and L_{CSI-2} respectively indicate the number of bits for CSI part 2 and the number of CRC bits for CSI part 2. β_{offset}^{PUSCH} is beta offset with respect to CSI part 2 and is equal to β_{offset}^{CSI-part2}. Parameters other than those described above are equal to parameters required in calculating the number of coded modulation symbols for each layer with respect to HARQ-ACK and CSI part 1.

The number of coded modulation symbols for each layer of CG-UCI for which rate-matching has been performed may be calculated in a similar manner to HARQ-ACK. Calculation of a coded modulation symbol for each layer of CG-UCI to be multiplexed in a PUSCH including UL-SCH is as shown in [Equation 13].

$$[ Equation 13 ]$$

$${Q}_{CG - UCI}^{′} = min \text{} \{ ⌈ \frac{( {O}_{CG - UCI} + {L}_{CG - UCI} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ \}$$

In [Equation 13], O_{CG-UCI} and L_{CG-UCI} respectively indicate the number of bits of CG-UCI and the number of CRC bits for CG-UCI. β_{offset}^{PUSCH} is beta offset with respect to CG-UCI and is equal to β_{offset}^{CG-UCI}. Parameters other than those described above are equal to parameters required in calculating the number of coded modulation symbols for each layer with respect to HARQ-ACK.

When HARQ-ACK and CG-UCI are multiplexed in a PUSCH including UL-SCH, the number of coded modulation symbols for each layer of HARQ-ACK and CG-UCI for which rate-Matching has been performed may be calculated as shown in [Equation 14].

$$[ Equation 14 ]$$

$${Q}_{CG - UCI}^{′} = min \text{} \{ ⌈ \frac{( {O}_{ACK} + {O}_{CG - UCI} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , all}^{PUSCH} - 1} {M}_{sc}^{UCI} ( l ) ⌉ \}$$

In [Equation 14], β_{offset}^{PUSCH} is beta offset with respect to HARQ-ACK and is equal to β_{offset}^{HAR-ACK}, and parameters other than those described above are equal to parameters required in calculating the number of coded modulation symbols for each layer with respect to HARQ-ACK.

### [PUSCH: Related to UCI Multiplexing]

Next, a method of multiplexing UCI in a PUSCH will now be described in detail. Multiplexing may be performed in a procedure below.

### Step 1:

When HARQ-ACK information to be transmitted in a PUSCH is 0 or 1 or 2 bits, reserved resources for potential HARQ-ACK transmission are determined. According to a frequency priority rule, the reserved resources are determined starting from a first symbol immediately after a symbol including a first DMRS among resources on which a PUSCH is allocated. The frequency priority rule collectively refers to schemes of sequentially mapping symbols to frequency resources, and moving to a next symbol and performing mapping. Here, the amount of reserved resources may be calculated, assuming that HARQ-ACK information is 2 bits.
According to whether or not to perform frequency hopping for PUSCH, whether to identify coded bits for potential HARQ-ACK transmission for each hop may be determined.

### Step 2:

When HARQ-ACK information to be transmitted in a PUSCH is greater than 2 bits, rate-matching is performed. That is, mapping is performed on coded bits of HARQ-ACK information in a frequency priority rule starting from a first symbol immediately after a symbol including a first DMRS among resources on which a PUSCH is allocated.

### Step 2-A:

When there is CG-UCI information to be transmitted in a PUSCH, rate-matching is performed. That is, mapping is performed on coded bits of CG-UCI information in a frequency priority rule starting from a first symbol immediately after a symbol including a first DMRS among resources on which a PUSCH is allocated.

### Step 3:

When there is CSI part 1 information to be transmitted in a PUSCH, rate-matching is performed. Frequency priority mapping is performed on CSI part 1 starting from a first symbol of resources to which a PUSCH is allocated, excluding a resource to which a DMRS and HARQ-ACK reserved or HARQ-ACK or CG-UCI which is allocated in Step1 or Step 2 or Step 2-A. Afterward, frequency priority mapping is performed on CSI part 2 starting from a first symbol of a resource to which a PUSCH is allocated, excluding resources to which a DMRS and HARQ-ACK or CG-UCI or CSI part 1 which is allocated in Step 2 or Step 2-A. CSI part2 may be allocated to reserved RE allocated in Step1 above.

### Step 4:

UL-SCH information rate-matching is performed. Frequency priority mapping is performed on UL-SCH in a resource in which a PUSCH is allocated, except for resources in which a plurality of pieces of UCI information mapped in Step 2 to Step 3 above are mapped. UL-SCH may be allocated to reserved RE allocated in Step1 above.

### Step 5:

When HARQ-ACK information to be transmitted in a PUSCH is not greater than 2 bits, mapping is performed on reserved resources as in Step 1. As the amount of reserved resources is calculated, assuming that a size of the HARQ-ACK information is 2 bits, resources to be actually mapped may be less than the reserved resources. When there is UCI resource or UL-SCH pre-mapped to the resource in Step 2 to Step 4, corresponding information is punctured, and the HARQ-ACK information is mapped.

In Steps above, when the number of bits (or the number of modulated symbols) of UCI information to be mapped to a PUSCH on an OFDM symbol is greater than the number of bits available for UCI information mapping on the OFDM symbol, frequency-axis RE distance d between modulated symbols of the UCI information to be mapped may be configured as d=1. If the number of bits of the UCI information to be mapped to the PUSCH by the UE on the OFDM symbol is less than the number of bits available for UCI information mapping on the OFDM symbol, frequency-axis RE distance d between modulated symbols of the UCI information to be mapped may be configured as d=floor (# of available bits on 1 OFDM symbol/# of unmapped UCI bits at the beginning of 1 OFDM symbol).

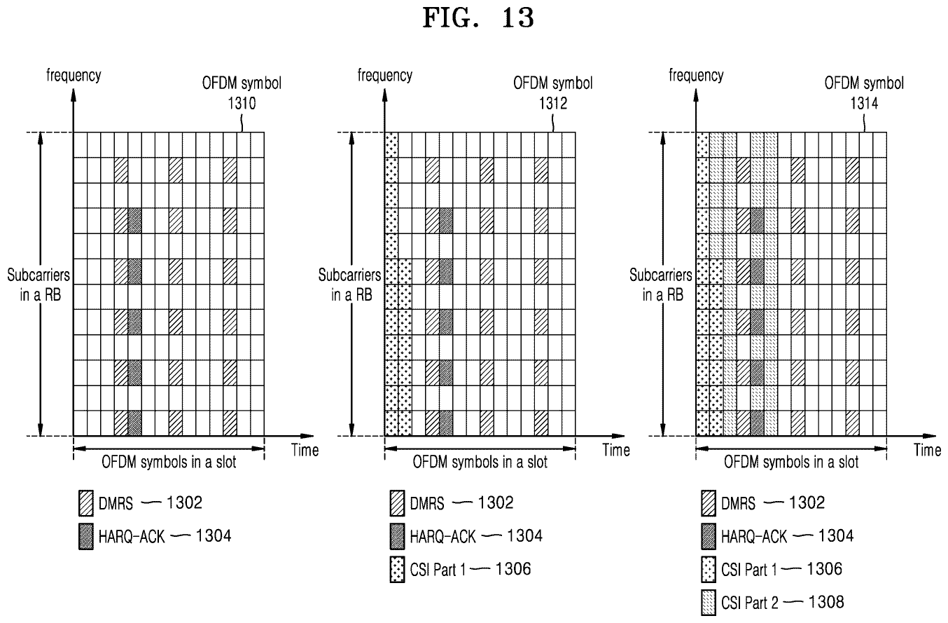

FIG. 13 illustrates an example in which UCI is mapped to a PUSCH, according to an embodiment of the disclosure.

In FIG. 13, it is assumed that the number of HARQ-ACK symbols to be mapped to the PUSCH is 5, and one RB is configured or scheduled for the PUSCH. First, as shown in (a) of FIG. 13, a UE may map HARQ-ACK 1304 of 5 symbols, starting from a lowest RE index (or highest RE index) of a first OFDM symbol 1310 not including a DMRS after a first DMRS 1302, in an RE distance of d=floor(12/5)=2 on a frequency axis. Next, as shown in (b) of FIG. 13, the UE may map CSI part 1 1306, starting from a first OFDM symbol 1312, not the DMRS 1302. Lastly, as shown in (c) of FIG. 13, the UE may map CSI part 2 1308 to RE to which CSI part 1 1306 and HARQ-ACK 1304 are not mapped, starting from a first OFDM symbol 1314 not including the DMRS 1302.

### [Related to CA/DC]

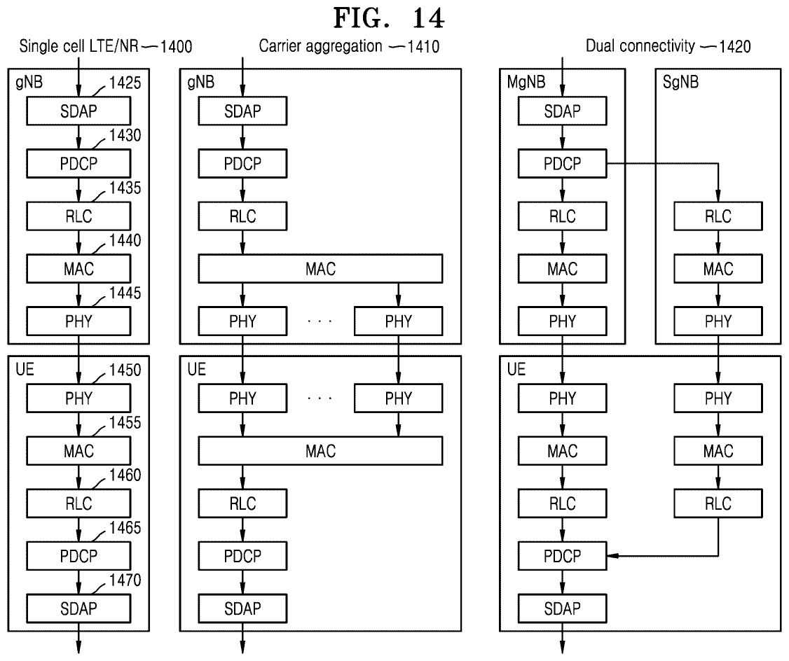

FIG. 14 illustrates radio protocol architecture of a BS and a UE in a situation of a single cell 1400, carrier aggregation 1410 and dual connectivity 1420, according to an embodiment of the present disclosure.

Referring to FIG. 14, a radio protocol of a next generation mobile communication system may include, in each of the UE and the NR BS, an NR service data adaptation protocol (NR SDAP) 1425 or 1470, an NR packet data convergence protocol (NR PDCP) 1430 or 1465, an NR radio link control (NR RLC) 1435 or 1460, an NR medium access control (NR MAC) 1440 or 1455, and a NR PHY 1445 or 1450.

Main functions of the NR SDAP 1425 or 1470 may include some of the following functions.
Transfer of user plane data
Mapping between a quality of service (QoS) flow and a data radio bearer (DRB) for both DL and UL
Marking QoS flow ID in both DL and UL packets
Reflective QoS flow to DRB mapping for the UL SDAP packet data units (PDUs).

With respect to the NR SDAP layer device, information about whether to use a header of the NR SDAP layer device or to use functions of the NR SDAP layer device may be configured for the UE by using a RRC message per NR PDCP layer device, per bearer, or per logical channel, and when the SDAP header is configured, the UE may direct to update or reconfigure UL and DL QoS flow and data bearer mapping information by using a 1-bit non access stratum (NAS) reflective QoS indicator and a 1-bit access stratum (AS) reflective QoS indicator of the SDAP header. The SDAP header may include QoS flow ID information indicating QoS. The QoS information may be used as data processing priority information or scheduling information for seamlessly supporting a service.

Main functions of the NR PDCP 1430 or 1465 may include some of the following functions.
Header compression and decompression: robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink.

The reordering function of the NR PDCP device may indicate a function of reordering PDCP PDUs received from a lower layer, on a PDCP sequence number (SN) basis, may include a function of delivering the reordered data to an upper layer in order. Alternatively, the reordering function of the NR PDCP device may include a function of delivering the reordered data to an upper layer out of order, a function of recording missing PDCP PDUs by reordering the received PDCP PDUs, a function of reporting status information of the missing PDCP PDUs to a transmitter, and a function of requesting to retransmit the missing PDCP PDUs.

Main functions of the NR RLC 1435 or 1460 may include some of the following functions.
Transfer of upper layer PDUs
In-sequence delivery of upper layer PDUs
Out-of-sequence delivery of upper layer PDUs
Error Correction through automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery function of the NR RLC device may indicate a function of delivering RLC SDUs received from a lower layer to an upper layer in order. The in-sequence delivery function of the NR RLC device may include a function of reassembling the RLC SDUs and delivering the reassembled RLC SDU when a plurality of RLC SDUs segmented from one RLC SDU are received, a function of reordering received RLC PDUs on a RLC SN or PDCP SN basis, a function of recording missing RLC PDUs by reordering the received RLC PDUs, a function of reporting status information of the missing RLC PDUs to a transmitter, and a function of requesting to retransmit the missing RLC PDUs, The in-sequence delivery function of the NR RLC device may include a function of delivering only RLC SDUs prior to a missing RLC SDU, to an upper layer in order when the missing RLC SDU exists, or a function of delivering all RLC SDUs received before a timer starts, to an upper layer in order although a missing RLC SDU exists when a certain timer expires. Alternatively, the in-sequence delivery function of the NR RLC device may include a function of delivering all RLC SDUs received so far, to an upper layer in order although a missing RLC SDU exists when a certain timer expires. Also, the NR RLC device may process the RLC PDUs in order of reception and deliver the RLC PDUs to the PDCP device (regardless of SNs (out-of-sequence delivery)), and when a segment is received, the NR RLC layer 1435 or 1460 may reassemble the segment with other segments stored in a buffer or to be subsequently received, into a whole RLC PDU and may process and deliver the RLC PDU to the PDCP device. The NR RLC layer may not have a concatenation function, and the concatenation function may be performed by the NR MAC layer or be substituted with a multiplexing function of the NR MAC layer.

The out-of-sequence delivery function of the NR RLC device may include a function of directly delivering RLC SDUs received from a lower layer to an upper layer out of order, a function of reassembling a plurality of RLC SDUs segmented from one RLC SDU and delivering the reassembled RLC SDU when the segmented RLC SDUs are received, and a function of recording missing RLC PDUs by storing RLC SNs or PDCP SNs of received RLC PDUs and reordering the received RLC PDUs.

The NR MAC may be connected to a plurality of NR RLC layer devices configured for one UE, and main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
Multimedia broadcast multicast service (MBMS) service identification
Transport format selection
Padding

The NR PHY layer 1445 or 1450 may channel-code and modulate upper layer data into OFDM symbols and may transmit the OFDM symbols through a wireless channel, or may demodulate OFDM symbols received through a wireless channel and channel-decode and may deliver the OFDM symbols to an upper layer.

The radio protocol architecture may be variously changed according to carrier (or cell) operation schemes. For example, when the BS transmits data to the UE on a single carrier (or cell) 1400, the BS and the UE use protocol architecture having a single structure for each layer, as shown in 1400. On the other hand, when the BS transmits data to the UE based on a CA 1410 in which multiple carriers are used at a single transmission and reception point (TRP), the BS and the UE use protocol architecture having a single structure up to the RLC, in which the PHY layer is multiplexed via the MAC layer, as shown in 1410. In another example, when the BS transmits data to the UE based on a dual connectivity (DC) 1420 in which multiple carriers are used at multiple TRPs, the BS and the UE use protocol architecture having a single structure up to the RLC, in which the PHY layer is multiplexed via the MAC layer, as shown in 1420.

Referring to descriptions related to PDCCH and beam configuration, as current Rel-15 and Rel-16 NR do not support PDCCH repetitive transmission, it is difficult to achieve required reliability for a scenario such as URLLC which requires high reliability. The disclosure provides a PDCCH repetitive transmission method via multiple TRPs, thereby improving PDCCH reception reliability of the UE. Detailed methods will now be described in embodiments below.

Hereinafter, an embodiment of the disclosure will now be described with reference to accompanying drawings. Contents of the disclosure are applicable to frequency division duplex (FDD) and TDD systems. In the following descriptions, high signaling (or higher layer signaling) may indicate a method by which the BS transmits a signal to the UE by using a DL data channel of the physical layer or by which the UE transmits a signal to the BS by using a UL data channel of the physical layer, and may be referred to as RRC signaling, PDCP signaling, or an MAC control element (CE).

Hereinafter, in the disclosure, when the UE determines whether to apply the cooperative communication, the UE may use various methods in which PDCCH(s) that allocates a PDSCH, to which the cooperative communication is applied, has a particular format, PDCCH(s) that allocates a PDSCH, to which the cooperative communication is applied, includes a particular indicator to indicate whether the cooperative communication is applied, PDCCH(s) that allocates a PDSCH, to which the cooperative communication is applied, is scrambled by a particular RNTI, or application of the cooperative communication is assumed in a particular section indicated by an upper layer. For convenience of descriptions, a case in which the UE receives the PDSCH to which the cooperative communication is applied based on conditions similar to those as described above will now be referred to as a non-coherent joint transmission (NC-JT) case.

Hereinafter, in the disclosure, determining priorities between A and B may refer to selecting one of A and B which has a higher priority according to a preset priority rule and performing an operation corresponding thereto or omitting or dropping an operation for the other one having a lower priority.

Hereinafter, in the disclosure, the above examples will now be described in several embodiments, but the examples are not independent and one or more embodiments may be applied simultaneously or in combination.

### [Related to SBFD]

The 3GPP discusses subband non-overlapping full duplex (SBFD) as an NR-based new duplex scheme. The SBFD refers to a technology by which a portion of a DL resource is used as a UL resource in a TDD spectrum of a frequency equal to or less than 6 GHz or a frequency equal to or greater than 6 GHz, and then UL transmission on an increased UL resource is received from a UE, so that UL coverage of the UE may be increased, a feedback with respect to DL transmission on the increased UL resource is received from the UE, and thus, a feedback delay may be decreased. In the disclosure, for convenience of descriptions, a UE capable of receiving information about whether SBFD is supported from a BS, and performing UL transmission on a portion of a DL resource may be referred to as the SBFD-capable UE. In order to define the SBFD scheme in the rule and determine that the SBFD-capable UE is supported in a specific cell (or frequency, frequency band), schemes below may be considered.

First scheme. Another frame structure type (e.g., frame structure type 2) may be introduced to define the SBFD, in addition to a frame structure type of a legacy unpaired spectrum (or TDD) or paired spectrum (or FDD). The frame structure type 2 may define that it is supported in the specific frequency or frequency band, or a BS may indicate via system information for a UE whether the SBFD is supported. The SBFD-capable UE may receive the system information including information indicating whether the SBFD is supported, and thus, may determine whether the SBFD is supported in the specific cell (or frequency or frequency band).

Second scheme. Without definition with respect to a new frame structure type, whether the SBFD is additionally supported in a specific frequency or frequency band of a legacy unpaired spectrum (or TDD) may be indicated. In the second scheme, whether the SBFD is additionally supported in the specific frequency or frequency band of the legacy unpaired spectrum (or TDD) may be defined, or the BS may indicate via system information for the UE whether the SBFD is supported. The SBFD-capable UE may receive the system information including information indicating whether the SBFD is supported, and thus, may determine whether the SBFD is supported in the specific cell (or frequency or frequency band).

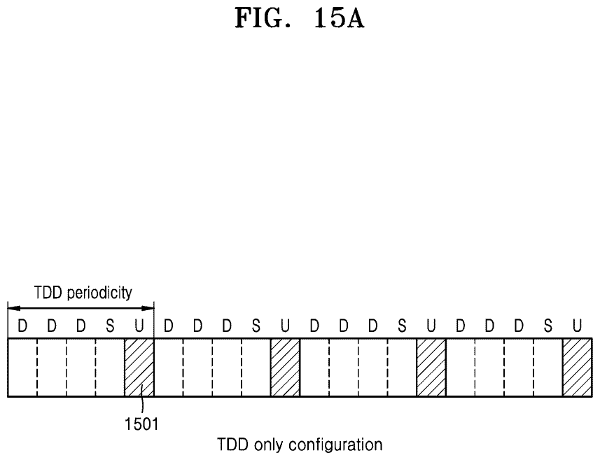

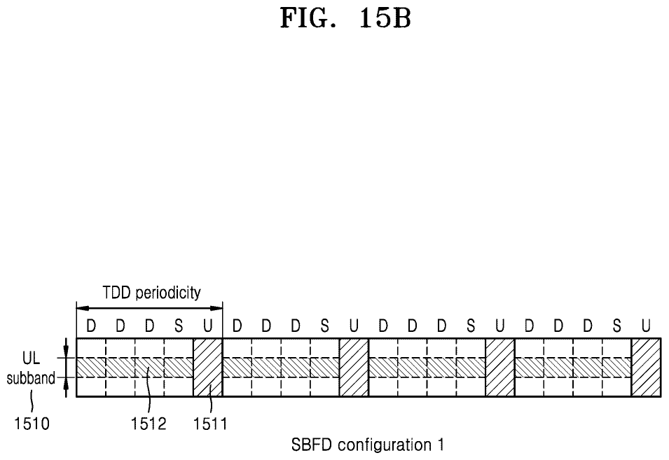

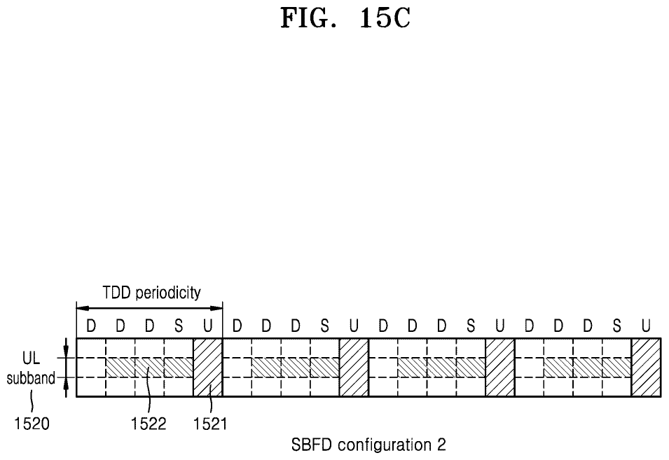

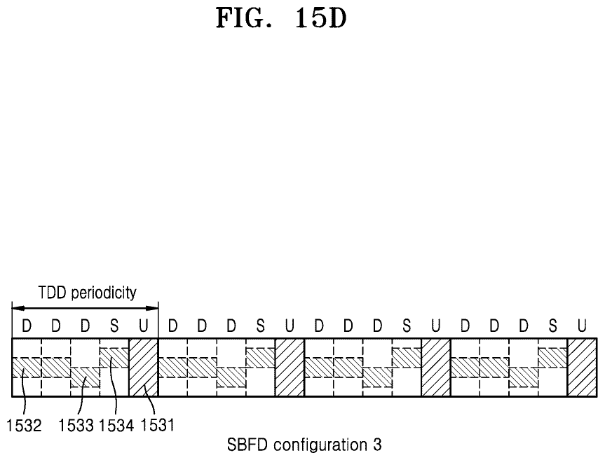

The information indicating whether the SBFD is supported in the first and second schemes may be information (e.g., SBFD resource configuration information to be described below in FIGS. 15A-15D) that indirectly indicates whether the SBFD is supported, by additionally configuring a portion of a DL resource as a UL resource, in addition to configuration about TDD UL-DL resource configuration information indicating a DL slot (or symbol) and a UL slot (or symbol) of TDD, or may be information that directly indicates whether the SBFD is supported.

In the disclosure, the SBFD-capable UE may obtain cell synchronization by receiving a synchronization signal block in an initial cell access for accessing a cell (or a BS). A procedure for obtaining the cell synchronization may be equal for the SBFD-capable UE and a normal TDD UE. Afterward, the SBFD-capable UE may determine whether the cell supports the SBFD, via an MIB obtainment or SIB obtainment or random access procedure.

The system information for transmission of information indicating whether the SBFD is supported may be system information that is transmitted separately from system information for a UE (e.g., an existing TDD UE) for supporting rules of a different version within a cell, and the SBFD-capable UE may determine whether the SBFD is supported, by obtaining all or a portion of the system information that is transmitted separately from the system information for the existing TDD UE. When the SBFD-capable UE obtains only the system information for the existing TDD UE or obtains system information indicating that the SBFD is not supported, the SBFD-capable UE may determine that the cell (or BS) supports only TDD.

When information about whether the SBFD is supported is included in the system information for a UE (e.g., the existing TDD UE) that supports rules of a different version, the information about whether the SBFD is supported may be inserted into the end so as to avoid any effect on obtainment of the system information for the existing TDD UE. When the SBFD-capable cannot obtain the information about whether the SBFD is supported inserted into the end, or obtains information indicating that the SBFD is not supported, the SBFD-capable UE may determine that the cell (or BS) supports only TDD.

When information about whether the SBFD is supported is included in the system information for a UE (e.g., the existing TDD UE) that supports rules of a different version, the information about whether the SBFD is supported may be transmitted as a separate PDSCH so as to avoid any effect on obtainment of the system information for the existing TDD UE. That is, the SBFD-incapable UE may receive a first SIB (or SIB1) including system information related to existing TDD, via a first PDSCH. The SBFD-capable UE may receive a first SIB (or SIB1) including system information related to existing TDD, via a first PDSCH, and may receive a second SIB including system information related to SBFD via a second PDSCH. Here, the first PDSCH and the second PDSCH may be scheduled on a first PDCCH and a second PDCCH, and a CRC of the first PDCCH and the second PDCCH may be scrambled by the same RNTI (e.g., SI-RNTI). A search space for monitoring the second PDCCH may be obtained from system information of the first PDSCH, and if not obtained (i.e., if the system information of the first PDSCH does not include information about the search space), the second PDCCH may be received in the same search space as the first PDCCH.

As described above, when the SBFD-capable UE determines that the cell (or BS) supports only TDD, the SBFD-capable UE may perform a random access procedure and transmission and reception of data/control signals in an equal manner to the existing TDD UE.

The BS may configure a separate random access resource for each of the existing TDD UE and the SBFD-capable UE (e.g., the SBFD-capable UE supporting duplex communication) and the SBFD-capable UE supporting half-duplex communication), and may transmit, to the SBFD-capable UE, system information including configuration information about the random access resource (control information or configuration information which indicates time-frequency resources available for a PRACH). The system information for transmission of the random access resource may be system information that is transmitted separately from system information for a UE (e.g., the existing TDD UE) that supports rules of a different version within a cell.

The BS may configure a random access resource separately for the TDD UE supporting rules of a different version and the SBFD-capable UE, thereby identifying whether the TDD UE supporting rules of a different version performs a random access or the SBFD-capable UE performs a random access. For example, a random access resource separately configured for the SBFD-capable UE may be a resource that the existing TDD UE determines as a DL time resource, and the SBFD-capable UE performs an random access on a UL resource (or the separate random access resource) configured in a portion of a frequency of the DL time resource, such that the BS may determine that a UE that performed the random access on the UL resource is the SBFD-capable UE.

Alternatively, the BS may not configure a separate random access resource for the SBFD-capable UE, and may configure a common random access resource for all UEs within a cell. In this case, configuration information about the random access resource may be transmitted to all UEs in the cell via system information, and when receiving the system information, the SBFD-capable UE may perform a random access on the random access resource. Afterward, the SBFD-capable UE may complete a random access procedure, and then may proceed to an RRC_connected mode for transmitting and receiving data to and from the cell. After the RRC_connected mode, the SBFD-capable UE may receive, from the BS, a higher layer signal or physical signal for the SBFD-capable UE to determine that a partial frequency resource of the DL time resource is configured as a UL resource, and may perform an SBFD operation, e.g., transmission of a UL signal on the UL resource.

When the SBFD-capable UE determines that the cell supports SBFD, the SBFD-capable UE may inform the BS that an accessing UE is the SBFD-capable UE, by transmitting, to the BS, capability information including at least one of whether the UE supports SBFD, whether full-duplex communication or half-duplex communication is supported, or the number of included transmitting or receiving antennas. Alternatively, when the support of half-duplex communication is essentially implemented in the SBFD-capable UE, whether half-duplex communication is supported may be omitted from the capability information. The report on the capability information by the SBFD-capable UE may be reported to the BS via a random access procedure, may be reported to the BS after a random access procedure is completed, or may be reported to the BS after processing to an RRC_connected mode for transmitting and receiving data to and from the cell.

The SBFD-capable UE may support half-duplex communication for performing only UL transmission or DL reception at one time as the existing TDD UE, or may support full-duplex communication for performing both UL transmission and DL reception at one time. Therefore, whether the half-duplex communication or the full-duplex communication is supported may be reported from the SBFD-capable UE to the BS, and after the report, the BS may configure the SBFD-capable UE as to whether transmission and reception are performed by using the half-duplex communication or the full-duplex communication. In a case where the SBFD-capable UE reports a capability of the half-duplex communication to the BS, as a duplexer generally does not exist, a switching gap for changing an radio frequency (RF) between transmission and reception may be required when operating in FDD or TDD.

FIGS. 15A-15D illustrate an example in which SBFD is operated in a TDD spectrum of a wireless communication system, according to an embodiment of the disclosure.

FIG. 15A illustrates a case in which TDD is operated in a specific frequency spectrum. In a cell operating the TDD, a BS may transmit and receive signals including data/control information to and from the existing TDD UE or the SBFD-capable UE in a DL slot (or symbol), a UL slot (or symbol) 1501, or a flexible slot (or symbol), based on configuration of TDD UL-DL resource configuration information indicating a DL slot (or symbol) resource and a UL slot (or symbol) resource of TDD.

In FIGS. 15A-15D, it may be assumed that a DDDSU slot format is configured according to the TDD UL-DL resource configuration information. Here, “D” is a slot consisting of all DL symbols, “U” is a slot consisting of all UL symbols, and “S” is a slot that is not “D” nor “U”, i.e., a slot including a DL symbol or a UL symbol, or a slot including a flexible symbol. For convenience of descriptions, it may be assumed that “S” consists of 12 DL symbols and 2 flexible symbols. According to the TDD UL-DL resource configuration information, the DDDSU slot format may be repeated. That is, repetition periodicity of TDD configuration may be 5 slots (5 ms for 15 kHz SCS, 2.5 ms for 30 kHz SCS, etc.).

Next, a case in which TDD and SBFD are co-operated in a specific frequency spectrum is shown in FIGS. 15B-15D.

Referring to FIG. 15B, the UE may be configured with a portion of a frequency spectrum of the cell, as a frequency spectrum 1510 available for UL transmission. This spectrum may be referred to as the UL subband 1510. The UL subband 1510 may be applied to all symbols of all slots. The UE may transmit a UL channel or signal scheduled on all symbols 1512 within the UL subband 1510. However, the UE cannot transmit a UL channel or signal scheduled in a band other than the UL subband 1510.

Referring to FIG. 15C, the UE may be configured with a portion of a frequency spectrum of the cell, as a frequency spectrum 1520 available for UL transmission, and may be configured with a time domain in which the UL subband 1520 is activated. Here, the frequency spectrum 1520 may be referred to as the UL subband 1520. In FIG. 15C, the UL subband 1520 is inactivated in a first slot, and may be activated in other slots. Therefore, the UE may transmit a UL channel or signal in the UL subband 1520 of the other slots. Therefore, while the UL subband 1520 is activated in a slot unit herein, activation of the UL subband 1520 may be determined in a symbol unit.

Referring to FIG. 15D, the UE may be configured with a time-frequency resource available for UL transmission. The UE may be configured with one or more time-frequency resources as the time-frequency resource available for UL transmission. For example, some frequency bands 1532 of a first slot and a second slot may be configured as time-frequency resources available for UL transmission. Also, some frequency band 1533 of a third slot and some frequency band 1534 of a fourth slot may be configured as time-frequency resources available for UL transmission.

In descriptions below, a time-frequency resource available for UL transmission in a DL symbol or a DL slot may be referred to as an SBFD resource. A symbol in a DL symbol on which a UL subband is configured may be referred to as an SBFD symbol. Also, a time-frequency resource available for DL reception in a UL symbol or a UL slot may be referred to as an SBFD resource. A symbol in a UL symbol on which a DL subband is configured may be referred to as an SBFD symbol.

For convenience, in the disclosure, a band excluding a UL subband, in which reception of a DL channel or a DL signal is available is referred to as a DL subband. The UE may be configured with up to one UL subband and up to two DL subbands, on one symbol. For example, the UE may be configured with one of {UL subband, DL subband}, {DL subband, UL subband}, and {first DL subband, UL subband, second DL subband} in a frequency domain.

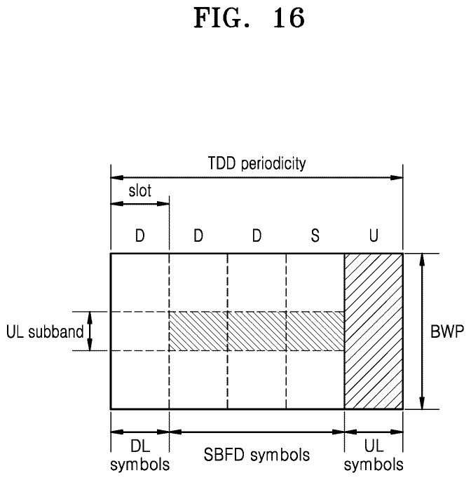

FIG. 16 illustrates an example in which an SBFD resource is configured in a wireless communication system, according to an embodiment of the disclosure.

For descriptions of the present embodiment of the disclosure, FIG. 16 is provided. FIG. 16 is merely an example, and the present embodiment of the disclosure may be equally applicable to another embodiment of the disclosure. Referring to FIG. 16, a UE may be configured with a UL symbol, a DL symbol, and a flexible symbol, according to TDD configuration. Here, a ‘D’ slot indicates a slot of which symbols are all DL symbols. A ‘U’ slot indicates a slot of which symbols are all UL symbols. A ‘S’ slot indicates a slot that is not the ‘D’ slot nor the ‘U’ slot. The UE may be configured with UL BWP. Also, the UE may be configured with a UL subband within a DL symbol. In the present embodiment of the disclosure, it is assumed that the UL BWP includes 275 RBs, and the UL subband includes 50 RBs. It is assumed that the UL subband is not configured in a first slot. Therefore, the first slot is referred to as a DL slot, and a symbol included in the first slot is referred to as a DL symbol. It is assumed that the UL subband is configured in second, third, and fourth slots. Therefore, the second, third, and fourth slots are each referred to as an SBFD slot, and symbols included in the second, third, and fourth slots are each referred to as an SBFD symbol. A fifth slot is a UL slot, and a symbol included in the fifth slot is referred to as a UL symbol.

Hereinafter, embodiments of the disclosure will be described in detail with reference to accompanying drawings. Hereinafter, a base station is an entity that allocates resources to a terminal, and may be at least one of gNode B, gNB, eNode B, Node B, BS, a radio access unit, a BS controller, or a node on a network. A terminal may include a UE, an MS, a cellular phone, a smartphone, a computer, or a multimedia system capable of performing a communication function. Although 5G system is described as an example for embodiments of the disclosure, the embodiments of the disclosure may also be applied to other communication systems having similar technical backgrounds or channel types. For example, mobile communication technologies developed after LTE or LTE-A mobile communication and 5G may be included therein. Therefore, the embodiments of the disclosure may also be applied to other communication systems through partial modification without greatly departing from the scope of the disclosure based on determination by one of ordinary skill in the art. The embodiments of the disclosure may be applied to FDD and TDD systems.

In the descriptions of the disclosure, detailed explanations of the related art are omitted when it is deemed that they may unnecessarily obscure the essence of the disclosure. The terms used in the specification are defined in consideration of functions used in the disclosure, and can be changed according to the intent or commonly used methods of users or operators. Accordingly, definitions of the terms are understood based on the entire descriptions of the present specification.

Hereinafter, in the following description of the disclosure, higher layer signaling may include at least one of signaling below or may refer to signaling including a combination of signaling below.
MIB (Master Information Block)
SIB (System Information Block) or SIB X (X=1, 2, . . . )
RRC (Radio Resource Control)
MAC (Medium Access Control) CE (Control Element)

Also, L1 signaling may refer to signaling corresponding to at least one or a combination of signaling methods using a physical layer channel or signaling below.
PDCCH (Physical Downlink Control Channel)
DCI (Downlink Control Information)
UE-specific DCI
Group common DCI
Common DCI
scheduling DCI (e.g., DCI used for scheduling DL or UL data)
non-scheduling DCI (e.g., DCI not used for scheduling DL or UL data)
PUCCH (Physical Uplink Control Channel)
UCI (Uplink Control Information)

Hereinafter, in the disclosure, determining priorities between A and B may refer to selecting one of A and B which has a higher priority according to a preset priority rule and performing an operation corresponding thereto or omitting or dropping an operation for the other one having a lower priority.

Hereinafter, in the disclosure, the above examples will now be described in several embodiments, but the examples are not independent and one or more embodiments may be applied simultaneously or in combination.

### Introduction of Embodiment

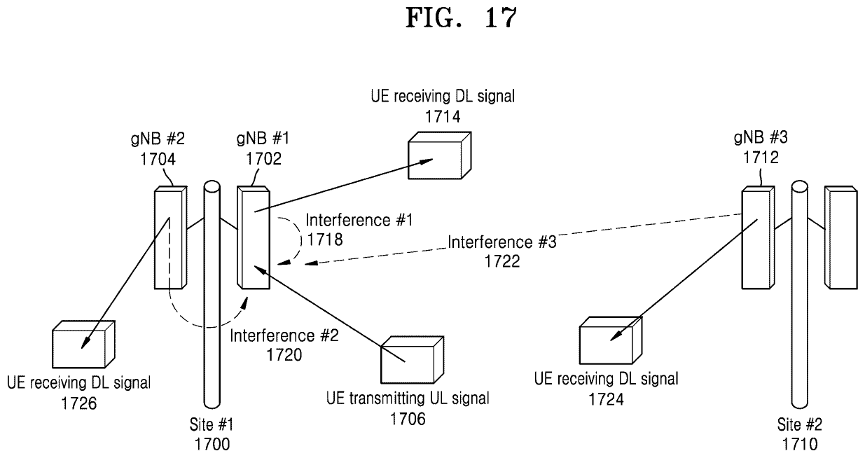

FIG. 17 illustrates a scenario in which gNB-gNB cross-link interference (CLI) occurs, according to an embodiment of the disclosure.

gNBs #1, #2, and #3 1702, 1704, and 1712 supporting SBFD may use some frequency bands of a same time resource for DL transmission, and other frequency bands for UL reception. Some UEs among UEs within a cell may receive scheduling of UL transmission on a same time resource (symbol), and other UEs may receive scheduling of DL reception on the same time resource (symbol). For example, a UE 1714 having received scheduling of DL reception on the same time resource (symbol) may receive DL information from the gNB #1 1702. A UE 1706 having received scheduling of UL transmission on the same time resource may transmit UL information to the gNB #1 1702. Here, the gNB #1 1702 may experience CLI in receiving a signal transmitted from the UL transmit UE 1706 from various paths. For example, as the gNB #1 1702 simultaneously performs DL transmission and UL reception on the same time resource, when receiving a UL, the gNB #1 1702 may experience self-interference that is interference #1 1718 from a DL transmitted from the gNB #1 1702 itself. The gNB #1 1702 may experience neighboring-gNB interference that is interference #2 1720 from a DL transmitted the SBFD support gNB #2 1704 located in the same site #1 1700 and covering another region. Also, the gNB #1 1702 may experience inter-gNB interference that is interference #3 1722 from a DL transmitted from the gNB #3 1712 located in a different site #2 1710 and supporting SBFD.

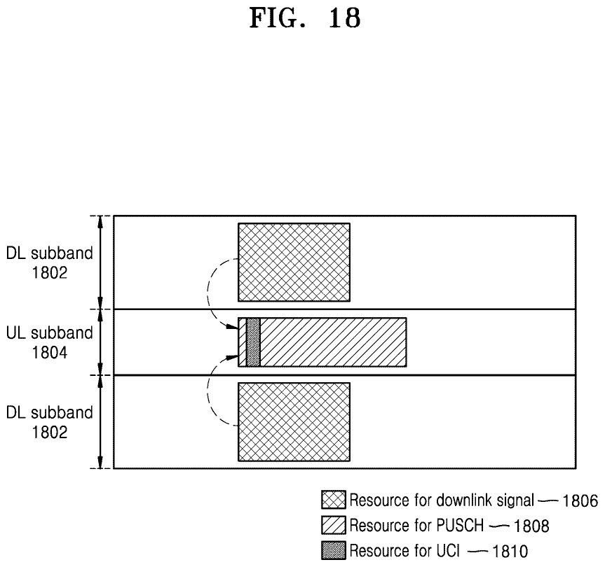

FIG. 18 illustrates an example of gNB-gNB CLI effect in an SBFD system, according to an embodiment of the disclosure.

A gNB may schedule DL transmission 1806 on a frequency resource of DL subband 1802 and may schedule UL data transmission 1808 on a frequency resource of UL subband 1804, on the same time resource. As described above, the DL signal 1806 scheduled on the same time resource may act as interference in receiving, by the gNB, UL data 1808. Here, a DL signal may indicate a signal including at least one of PDSCH, PDCCH, or a DL reference signal. If it is a situation in which a UE transmits the UL data channel 1808 in which UCI 1810 is multiplexed, an interference effect due to gNB-gNB CLI may occur in UCI receiving performance of the gNB.

In order to ensure the UCI receiving performance, the gNB may perform scheduling, in consideration of the gNB-gNB CLI. For example, in consideration of gNB-gNB CLI of a DL signal transmitted on the same time resource, the gNB may schedule UCI transmission of a UL UE on a different time resource (symbol). Also, in consideration of interference due to a DL signal, the gNB may transmit the DL signal with decreased DL transmission power, or may schedule a portion of DL in a corresponding time resource or an entire frequency resource as a muting resource, in consideration of a UL resource on which UCI is transmitted.

### First Embodiment: Method of Determining UCI Multiplexing Resource on PUSCH, in SBFD System

When the UE performs UCI multiplexing on a PUSCH, the UE may perform the UCI multiplexing by considering configuration from the gNB and an indicated time resource. The gNB that supports an SBFD system may simultaneously perform DL reception and UL transmission on the same time resource. Here, in order to improve reception quality of UCI to be transmitted after being multiplexed in a UL data channel (hereinafter, the PUSCH), the gNB may configure the UE to multiplex the UCI in the PUSCH on a time resource on which DL transmission does not exist.

In descriptions below, UCI multiplexing methods according to various PUSCH transmission types will now be described.

### Method 1: Method 1 of Determining UCI Multiplexing Resource in Single PUSCH Transmission

When the UE performs UCI multiplexing on a PUSCH, the UE may perform UCI multiplexing, starting from a time resource configured and indicated by the gNB. The configured and indicated time resource for UCI multiplexing may be limited only for HARQ-ACK information among information configuring UCI. That is, a start point of a PUSCH resource in which HARQ-ACK information bit of UCI configuration information may be multiplexed may be the time resource configured and indicated by the gNB. Here, the configured and indicated time resource for UCI multiplexing may be applied by being counted from a start point of a scheduled PUSCH time resource, and may be a symbol unit. The configured and indicated time resource may be allowed for a resource moving from the start point of the scheduled PUSCH time resource up to a maximum of N resources (symbols).

In UCI multiplexing, when HARQ-ACK information to be transmitted in a PUSCH is 0 or 1 or 2 bits, reserved resources for potential HARQ-ACK transmission are determined. The reserved resources may be determined as a time resource (symbol) configured by higher layer or indicated by DCI from the gNB, not a first symbol not including a DMRS after a first DMRS from among time resources on which the PUSCH is allocated. If the HARQ-ACK information to be transmitted in the PUSCH is greater than 2 bits, rate-matching is performed. When performing rate-matching, a start point of a time resource allocable to HARQ-ACK may be configured by higher layer signaling or determined as a time resource (symbol) indicated by DCI from the gNB. For example, in [Equation 3] that is calculation of a coded modulation symbol for each layer with respect to HARQ-ACK to be multiplexed in a PUSCH that includes UL-SCH and is not a PUSCH repetitive transmission type B, l₀ refers to a first time resource in which HARQ-ACK may be multiplexed. Here, l₀ does not indicate an index of a first symbol not including a DMRS after a first DMRS but indicates a time resource (symbol) configured by higher layer signaling or indicated by DCI from the gNB. Afterward, a pre-defined rate-matching operation may be performed on CSI part 1 and CSI part 2 of UCI configuration information excluding HARQ-ACK, according to whether UL-SCH exists and a PUSCH is repetitively transmitted.

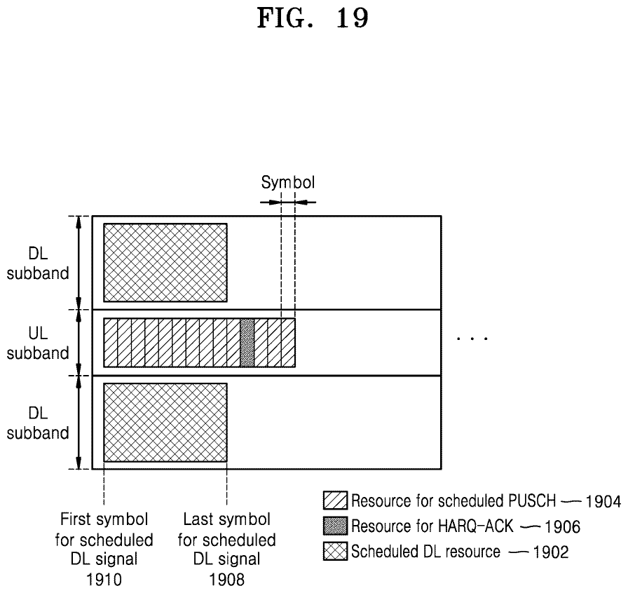

FIG. 19 illustrates an example of a UCI multiplexing method in single PUSCH transmission, according to an embodiment of the disclosure.

A gNB that supports an SBFD system may perform transmission of DL 1902 and reception of UL 1904 in a same time resource. The gNB may identify a time and frequency resource used in the transmission of DL 1902, and may use the time and frequency resource in resource configuration for transmission of UL 1904 by a UE. As described above, in order to improve reception quality of UCI information transmitted by the UE, the gNB may configure and indicate the UE with a start point for UCI multiplexing on a PUSCH. As illustrated in FIG. 19, the gNB may configure and indicate the UE with a start point for UCI multiplexing, in consideration of time after a last symbol 1908 of the same time resource on which DL and UL co-exist. Accordingly, the UE may calculate the number of HARQ-ACK coded modulation symbols and perform multiplexing, based on a resource 1906 configured and indicated by the gNB.

### Method 2: Method 2 of Determining UCI Multiplexing Resource in Single PUSCH Transmission

When the UE performs UCI multiplexing on a PUSCH, the UE may perform UCI multiplexing, starting from a time resource moved by a value configured and indicated by the gNB. The configured and indicated time resource for UCI multiplexing may be limited only for HARQ-ACK information among information configuring UCI. The configured and indicated value may be a symbol unit. The configured and indicated time resource may be applied by being counted from a start point as a first symbol not including a DMRS after a first DMRS, and may be information indicating movement by up to a maximum of N resources (symbols).

For example, in UCI multiplexing, when HARQ-ACK information to be transmitted in a PUSCH is 0 or 1 or 2 bits, reserved resources for potential HARQ-ACK transmission are determined. The reserved resources may be determined as a time resource (symbol) moved from a first symbol by up to a time resource configured and indicated by the gNB, the first symbol not including a DMRS after a first DMRS from among time resources on which the PUSCH is allocated. If the HARQ-ACK information to be transmitted in the PUSCH is greater than 2 bits, rate-matching is performed. When performing rate-matching, a start point of a time resource allocable to HARQ-ACK may be determined as the time resource moved from the first symbol by up to the time resource configured and indicated by the gNB, the first symbol not including a DMRS after a first DMRS. For example, in [Equation 3] that is calculation of a coded modulation symbol for each layer with respect to HARQ-ACK to be multiplexed in a PUSCH that includes UL-SCH and is not a PUSCH repetitive transmission type B, l₀ refers to a first time resource in which HARQ-ACK may be multiplexed. Here, l₀ indicates a symbol moved from an index of the first symbol by offset for UCI multiplexing configured and indicated by the gNB, the first symbol not including a DMRS after a first DMRS. Afterward, a pre-defined rate-matching operation may be performed on CSI part 1 and CSI part 2 of UCI configuration information excluding HARQ-ACK, according to whether UL-SCH exists and a PUSCH is repetitively transmitted.

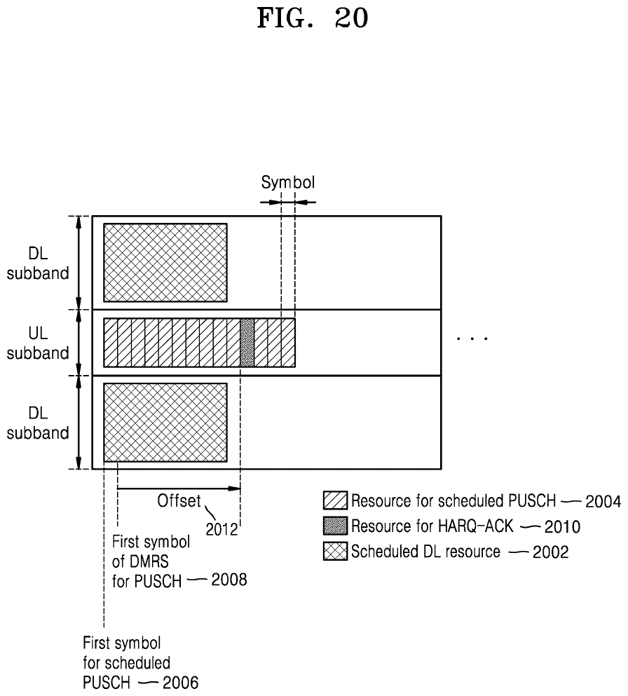

FIG. 20 illustrates an example of a UCI multiplexing method in single PUSCH transmission, according to an embodiment of the disclosure.

A gNB that supports an SBFD system may perform transmission of DL 2002 and reception of UL 2004 in a same time resource. The gNB may identify a time and frequency resource used in the transmission of DL 2002, and may use the time and frequency resource in resource configuration for transmission of UL 2004 by a UE. As described above, in order to improve reception quality of UCI information transmitted by the UE, the gNB may configure and indicate the UE with an offset value 2012 as a start point for UCI multiplexing on a PUSCH. As illustrated in FIG. 20, the gNB may configure and indicate the UE with the offset value 2012 as the start point for UCI multiplexing, in consideration of time after a last symbol of the same time resource on which DL and UL co-exist. Accordingly, the UE may determine a start point of a time resource allocable to HARQ-ACK as a time resource moved from a first symbol 2008 by the configured and indicated offset value 2012, the first symbol 2008 not including a DMRS after a first DMRS.

### Method 3: Method 3 of Determining UCI Multiplexing Resource in Single PUSCH Transmission

When the UE performs UCI multiplexing on a PUSCH, the UE may perform UCI multiplexing, starting from a time resource moved by a value configured and indicated by the gNB. The configured and indicated time resource for UCI multiplexing may be limited only for HARQ-ACK information among information configuring UCI. The configured and indicated value may be a symbol unit. Unlike the method 2, the configured and indicated time resource may be applied by being counted from a start point 2006 of a scheduled PUSCH time resource, and may be information indicating movement by up to a maximum of N resources (symbols).

### Method 4: Method 4 of Determining UCI Multiplexing Resource in Single PUSCH Transmission

When the UE performs UCI multiplexing on a PUSCH, the UE may perform UCI multiplexing, starting from a time resource configured and indicated by the gNB. The configured and indicated time resource for UCI multiplexing may be limited only for HARQ-ACK information among information configuring UCI. That is, a start point of a PUSCH resource in which HARQ-ACK information bit of UCI configuration information may be multiplexed may be the time resource configured and indicated by the gNB. Here, the configured and indicated time resource for UCI multiplexing may be applied by being counted from a last resource (symbol) of a scheduled PUSCH time resource, and may be a symbol unit. The configured and indicated time resource may be allowed for movement from a start point 2006 of the scheduled PUSCH time resource up to a maximum of N resources (symbols).

### Method 5: Method 5 of Determining UCI Multiplexing Resource in Multi-PUSCH Transmission

When the UE multiplexes UCI information in multi-PUSCH transmission, the UE may perform UCI multiplexing on a PUSCH resource configured and indicated by the gNB. Here, the multi-PUSCH transmission indicates at least one of PUSCH repetitive transmission, multi-PUSCH transmission, or TBoMS. That is, a PUSCH resource on which multiplexing of UCI information is available may be one PUSCH time resource from among multiple PUSCH transmission time resources configured and indicated by the gNB.

It may be assumed that the gNB has configured the UE with one PUSCH transmission or one or more PUSCH transmissions, according to one or more slots. When the gNB schedules one PUSCH transmission or multi-PUSCH transmission in one or more slots to the UE, the gNB may configure and indicate a PUSCH time resource in which UCI multiplexing is available, by considering DL resource configuration. The UE may perform UCI multiplexing on a PUSCH according to information configured and indicated by the gNB, and may determine a time resource of the PUSCH for performing UCI multiplexing, based on the information configured and indicated by the gNB.

Another example may be provided as a case in which the gNB configures the UE with a PUSCH repetitive transmission type B. When the gNB schedules PUSCH transmission with PUSCH repetitive transmission configuration to the UE, the gNB may configure and indicate a PUSCH time resource in which UCI multiplexing is available, by considering DL resource configuration. In more detail, when the gNB configures and indicates the UE with the PUSCH time resource in which UCI multiplexing is available, the gNB may consider transmission on a time resource that does not overlap with a DL time resource in actual PUSCH transmission of PUSCH repetitive transmission. When the UE performs PUSCH repetitive transmission, based on the information configured and indicated by the gNB, the UE may perform UCI multiplexing, and a PUSCH resource in which UCI is multiplexed may be determined based on the information configured and indicated by the gNB.

The configured and indicated PUSCH time resource may be allowed up to a maximum of N from among scheduled multiple PUSCHs.

The PUSCH time resource information for UCI multiplexing by the UE may be configured according to methods below.
Method 5-1: One PUSCH index from among N PUSCH transmission slots or N PUSCH actual transmission resources
Method 5-2: One slot index from among N PUSCH transmission slots or N PUSCH actual transmission resources
Method 5-3: A time resource moved from a first slot or an actual transmission resource by K slots and/or symbols, from among N PUSCH transmission slots or N PUSCH actual transmission resources

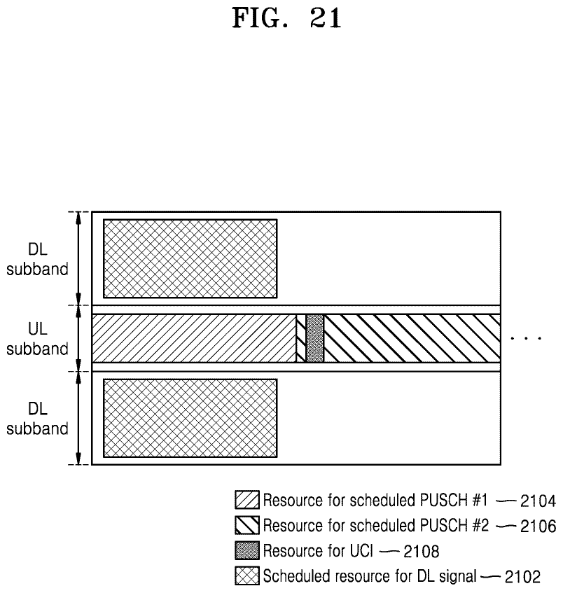

FIG. 21 illustrates an example of a method of determining a UCI multiplexing resource in multi-PUSCH transmission, according to an embodiment of the disclosure.

The gNB may schedule multi-PUSCH transmission in one or more slots to the UE. The gNB may schedule, to the UE, PUSCH transmission by considering that there is a PUSCH 2104 that overlaps a DL signal 2102 on the same time resource, from among time resources 2104 and 2106 on which a PUSCH is to be scheduled. When the gNB schedules, to the UE, PUSCH transmission, the gNB may configure and indicate the UE to perform UCI multiplexing on the PUSCH resource 2106 that does not overlap a DL resource. The UE may multiplex UCI in the PUSCH 2106 and transmit the PUSCH 2106, according to information configured and indicated by the gNB.

### Method 6: Method 1 of Determining UCI Multiplexing Resource, in Consideration of UL Resource Type

The UE may perform UCI multiplexing on a multiplexing-available time resource. Here, the multiplexing-available time resource indicates a time resource that is configured and scheduled by the gNB and is a UL-dedicated slot and/or symbol that is not a DL slot and/or symbol, an SBFD slot and/or symbol, nor a flexible slot and/or symbol. Even when a PUSCH transmission-available UL resource exists on the SBFD slot and/or symbol, the UE may defer UCI multiplexing until the UL-dedicated slot and/or symbol. The UE may perform UCI multiplexing, based on a first symbol of the UL-dedicated slot and/or symbol. That is, the UE does not multiplex UCI in a PUSCH and transmit the PUSCH in all time resources other than a UL-dedicated resource.

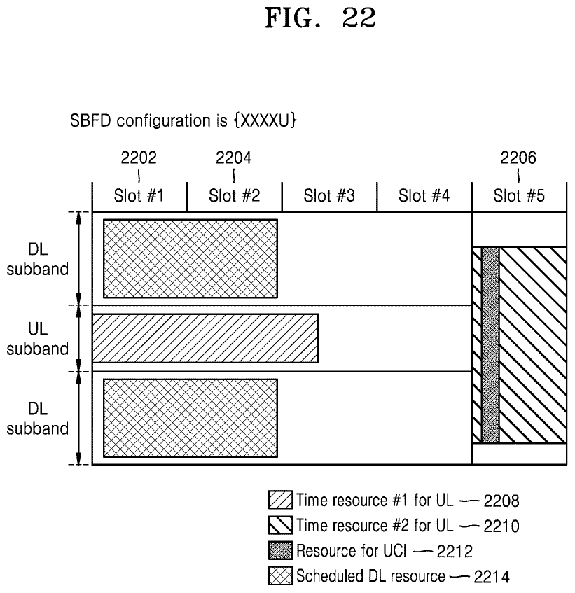

FIG. 22 illustrates a method of determining a UCI multiplexing resource, in consideration of a UL resource type, according to an embodiment of the disclosure.

The gNB may schedule, to the UE, UL PUSCH transmission. The gNB may schedule, to the UE, PUSCH transmission so as to allow the UE to transmit a PUSCH in Slot #1 2202 to Slot #5 2206. Even when there is UCI to be transmitted and a condition of multiplexing in a PUSCH to be transmitted is satisfied, the UE does not perform UCI multiplexing in a time resource (e.g., Slot #1 2202 and Slot #2 2204) that is not a UL-dedicated slot and/or symbol. The UE may perform UCI multiplexing on the UL-dedicated slot and/or symbol 2206. For example, the UE may calculate a coded modulation symbol for each layer with respect to HARQ-ACK to be multiplexed in a PUSCH that includes UL-SCH, by using [Equation 3], and parameters of [Equation 3] are calculated based on scheduling information about a UL-dedicated slot and/or symbol. Here, l₀ in [Equation 3] indicates an index of a first symbol not including a DMRS after a first DMRS, from among PUSCH resources scheduled on a UL-dedicated slot and/or symbol.

### Method 7: Method 2 of Determining UCI Multiplexing Resource, in Consideration of UL Resource Type

The UE may perform UCI multiplexing on a multiplexing-available time resource. Here, the multiplexing-available time resource may be a time resource that is configured and scheduled by the gNB and is a resource scheduled for a UL from among flexible slot and/or symbols that are scheduled by the gNB and are not a DL slot and/or symbol nor an SBFD slot and/or symbol. Even when a PUSCH transmission-available UL resource exists on the SBFD slot and/or symbol, the UE may defer UCI multiplexing. For example, the UE may calculate a coded modulation symbol for each layer with respect to HARQ-ACK to be multiplexed in a PUSCH that includes UL-SCH, by using [Equation 3], and parameters of [Equation 3] are calculated based on scheduling information about a corresponding UL symbol. Here, l₀ in [Equation 3] indicates an index of a first symbol not including a DMRS after a first DMRS, from among PUSCH resources on symbols scheduled for a UL from among flexible slots.

### Second Embodiment: Signaling Method for UCI Multiplexing on PUSCH, in SBFD System

The gNB may configure activation as to whether move a multiplexing resource, in UCI multiplexing resource scheduling for the UE. That is, the gNB does not always configure UCI multiplexing on a UL resource with a small DL interference, and may activate and deactivate a UCI multiplexing resource change operation. When the gNB schedules, to the UE, PUSCH transmission, the gNB may configure and indicate activation of the UCI multiplexing resource change operation, and the UE may multiplex UCI in a PUSCH, in a resource configured and indicated by the gNB, based on scheduling information. Also, the gNB may configure and indicate the UE with deactivation of the UCI multiplexing resource change operation. If the UE receives configuration and indication with respect to the deactivation from the gNB, the UE may perform a legacy operation without UCI multiplexing resource change.

The activation and deactivation may be performed via higher layer signaling or MAC-CE signaling or L1 signaling as below.

Method 1: The gNB may indicate activation/deactivation of the UCI multiplexing resource change operation for the UE, via separate configuration information in higher layer signaling. That is, new configuration information may be defined for activation/deactivation of UCI multiplexing resource change. If the gNB configures the UE with activation of UCI multiplexing resource change, when the gNB schedules a PUSCH, the gNB may also transmit UCI multiplexing resource change configuration information.

Method 2: The gNB may implicitly configure and indicate the UE with activation/deactivation of the UCI multiplexing resource change operation, via configuration information in higher layer signaling. That is, new configuration information for activation/deactivation of UCI multiplexing resource change is not defined, and when the gNB schedules a PUSCH, the gNB may configure configuration information for UCI multiplexing resource change. By doing so, the UE may implicitly activate UCI multiplexing resource change.

Method 3: The gNB may indicate the UE with activation/deactivation of the UCI multiplexing resource change operation, via MAC-CE signaling. For example, when the gNB schedules, to the UE, PUSCH transmission, the gNB may configure deactivation as an activation/deactivation state with respect to UCI multiplexing resource change, and may configure configuration information for UCI multiplexing resource change. Here, the UE may perform a PUSCH transmission operation without consideration of UCI multiplexing resource change. If the gNB indicates activation of UCI multiplexing resource change, via MAC-CE signaling, the UE perform UCI multiplexing on a PUSCH and transmit the PUSCH, based on configuration of the UCI multiplexing resource change, until the UE receives deactivation indication with respect to the UCI multiplexing resource change from the gNB.

Method 4: The gNB may indicate the UE with activation/deactivation of the UCI multiplexing resource change operation, via L1 signaling (DCI format). For example, when the gNB schedules, to the UE, PUSCH transmission, the gNB may configure deactivation as an activation/deactivation state with respect to UCI multiplexing resource change, and may configure configuration information for UCI multiplexing resource change. Here, the UE may perform a PUSCH transmission operation without consideration of UCI multiplexing resource change. If the gNB indicates the UE with activation of UCI multiplexing resource change, via L1 signaling (DCI format), the UE may perform UCI multiplexing on a PUSCH, based on configuration of UCI multiplexing resource change, and may transmit the PUSCH.

### Third Embodiment: Method of Configuring DCI Format for UCI Multiplexing on PUSCH, in SBFD System

The gNB may indicate the UE with a UCI multiplexing resource change value, via DCI for scheduling a PUSCH. For example, the gNB may schedule, to the UE, single PUSCH transmission, and may indicate a start symbol for UCI multiplexing resource change, via an information field in a DCI format. As another example, the gNB may schedule multi-PUSCH transmission on one or more slots to the UE, and may indicate a PUSCH index for UCI multiplexing resource change, via an information field in a DCI format. However, the example above is only for descriptions, and various methods may be applied to the first embodiment of the disclosure.

Configuration of the information in the DCI format will now be described in methods below.

### Method 1: Indication Method Using Downlink Assignment Index (UL DAI) Field

A bit field of a UL DAI in a DCI field may be extended, and may be used in indication of information for UCI multiplexing resource change. That is, a UL DAI field having N bit size may be used not only to indicate presence of UCI multiplexing and but also to indicate information for UCI multiplexing resource change. If N=2 UL DAI bit field is assumed, it may be assumed that ‘00’ may indicate presence of UCI multiplexing, and other bit combination indicates information for UCI multiplexing resource change. For example, it is assumed that the gNB has scheduled, to the UE, single PUSCH transmission. The gNB may indicate the UE with activation of UCI multiplexing resource change, via DCI, and on which resource (symbol) from among scheduled PUSCH resources UCI multiplexing is to be performed. The UE may interpret a UL DAI in transmitted DCI field information, and when a bit field is indicated with a bit combination other than ‘00’, the UE may move to an indicated resource (symbol) and may multiplex UCI in a PUSCH. Here, it may be applied only to HARQ-ACK in UCI information.

### Method 2: Indication Method Using New Field Application

A new bit field may be defined to indicate information for UCI multiplexing resource change. Here, the bit field may be defined up to a maximum of N bits. For example, when a bit field for N=2 information for UCI multiplexing resource change is assumed, each bit combination may be assumed to indicate information for UCI multiplexing resource change. For example, it is assumed that the gNB has scheduled, to the UE, single PUSCH transmission. The gNB may indicate the UE with activation of UCI multiplexing resource change, via DCI, and on which resource (symbol) from among scheduled PUSCH resources UCI multiplexing is to be performed. The UE may interpret a UCI multiplexing resource change information field in transmitted DCI field information, and may move to an indicated resource (symbol), according to an indicated bit combination and may multiplex UCI in a PUSCH. Here, it may be applied only to HARQ-ACK in UCI information.

### Fourth Embodiment: Method of Relaxing PUSCH Transmission Time Line, in SBFD System

As an example of a timeline condition for UCI multiplexing, if one PUCCH transmission or PUSCH transmission is scheduled via DCI, the UE may perform UCI multiplexing only when a first symbol S₀ of a PUSCH from among a PUCCH and the PUSCH which overlap a slot, and a start point S₀′ of UCI (HARQ-ACK) multiplexing configured or indicated by the gNB satisfy the conditions below. S₀′ is not a symbol transmitted before a symbol including CP which starts after T_{proc,1}^{mux} from a last symbol of a corresponding DL signal. Also, S₀ may be a symbol transmitted before a symbol including CP which starts after T_{proc,1}^{mux} from a last symbol of a corresponding DL signal. Here, T_{proc,1}^{mux} may be a maximum value of {T_{proc,1}^{mux,1}, . . . , T_{proc,1}^{mux,i}, . . . } with respect to an i^{th} DL signal associated with HARQ-ACK transmitted in a PUCCH in the group of overlapping PUCCHs and PUSCHs. By doing so, a latency improvement effect according to fast PUSCH transmission may be expected, compared to an operation of performing UCI multiplexing starting from a first symbol of a scheduled PUSCH.

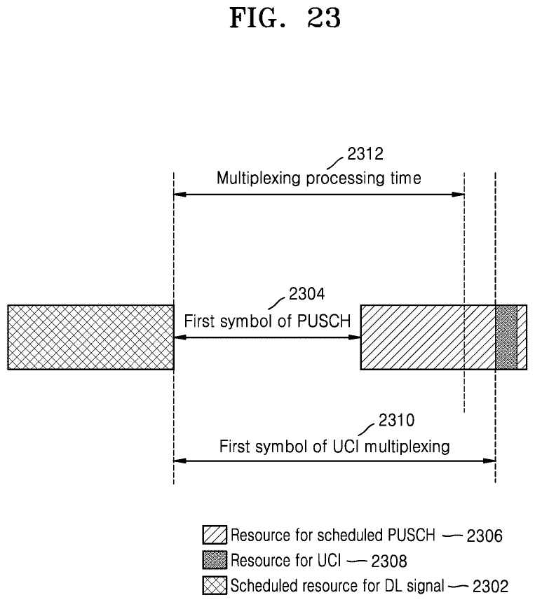

FIG. 23 illustrates a method of relaxing a PUSCH transmission timeline according to UCI multiplexing resource change, according to an embodiment of the disclosure.

Referring to FIG. 23, the UE may determine a UCI multiplexing start point 2308 in a PUSCH 2306, via UCI multiplexing resource change configured or indicated by the gNB. It may be identified that S₀′ 2310 (UCI multiplexing start point) is a symbol transmitted after a symbol that includes CP and starts after a processing time 2312 from a last symbol of a DL signal, and S₀ 2304 (PUSCH transmission start point) may be a symbol before the symbol that includes CP and starts after the processing time 2312 from the last symbol of the DL signal. In this regard, as a UCI multiplexing start point 2310 satisfies a condition of the processing time 2312, the UE may multiplex UCI in a PUSCH and transmit the PUSCH.

### Fifth Embodiment: Method of Transmitting Semi-Persistent Scheduling (SPS) HARQ-ACK, in SBFD System

The UE may transmit SPS HARQ-ACK, according to a symbol type. The gNB may configure the UE with semi-persistent DL transmission, and thus, HARQ-ACK may also be transmitted semi-persistently. The UE may transmit a UL in which HARQ-ACK is multiplexed, on both an SBFD symbol and a non-SBFD symbol, or may transmit a UL in which HARQ-ACK is multiplexed, on only an SBFD symbol, or may transmit a UL in which HARQ-ACK is multiplexed, on only a non-SBFD symbol. As described in the embodiments of the disclosure, UL reception on an SBFD symbol by the gNB may deteriorate in a reception quality due to DL interference (gNB-gNB CLI). Therefore, the gNB may configure the UE to multiplex and transmit HARQ-ACK in a UL channel only on a non-SBFD symbol that is not an SBFD and is a UL-dedicated symbol, in a semi-persistent operation, in particular, an SPS HARQ-ACK operation. For example, it is assumed that a resource configuration of an SBFD system is {XXXXU}. The UE having received a DL signal in first and second X slots may not multiplex and transmit HARQ-ACK in a UL on third and fourth X slots with respect to the DL signal, and may multiplex and transmit, in a UL channel in a fifth U slot, HARQ-ACK with respect to the DL signal in the first and second X slots. Such operation may be applied via methods below.

Method 1: The gNB may configure, via higher layer signaling, the UE to transmit SPS HARQ-ACK only on a non-SBFD symbol.

Method 2: The gNB may configure, via DCI indication, the UE to transmit SPS HARQ-ACK only on a non-SBFD symbol. For example, the gNB may configure the UE with semi-persistent DL reception, and when there is no other indication from the gNB, the UE may transmit SPS HARQ-ACK, regardless a symbol type. If the gNB configures, via DCI, the UE with activation of an SPS HARQ-ACK transmission operation only on a non-SBFD symbol, the UE may multiplex and transmit SPS HARQ-ACK in a UL channel only on the non-SBFD symbol.

Method 3: When UL transmission on an SBFD symbol is not available, the UE may defer SPS HARQ-ACK, and then may multiplex and transmit SPS HARQ-ACK in a UL channel on a non-SBFD symbol. Here, that UL transmission on an SBFD symbol is not available may correspond to cases below.
Another DL signal reception is scheduled on an SBFD symbol on which SPS HARQ-ACK is to be transmitted.
DL reference signal reception is scheduled on an SBFD symbol on which SPS HARQ-ACK is to be transmitted.
DL reception with high priority is scheduled on an SBFD symbol on which SPS HARQ-ACK is to be transmitted.

When the above scheduling situation occurs, the UE may defer SPS HARQ-ACK and then may multiplex and transmit SPS HARQ-ACK in a UL channel on a non-SBFD symbol.

### Sixth Embodiment: Method of Configuring Resource for DL Power Control, in SBFD System

The methods described in the above embodiments of the disclosure are methods in view of a UL of moving a UCI multiplexing resource, whereas the present embodiment of the disclosure provides a method of configuring a resource and controlling power, in DL view for assurance of UCI reception performance. The gNB that supports an SBFD system may schedule DL transmission and UL reception on the same time resource. In this regard, in order to ensure UCI reception performance, in consideration of interference due to a DL signal, the gNB may transmit the signal with reduced DL transmission power, or may schedule a portion of or an entire resource of a scheduled DL frequency resource as a muting resource. By doing so, an effect of decreasing interference due to a DL (gNB-gNB CLI) may be expected. However, when operations in the DL view are applied to all scheduled DL resources, DL system performance may deteriorate. Therefore, the operations may be performed in a specific resource configured by the gNB.

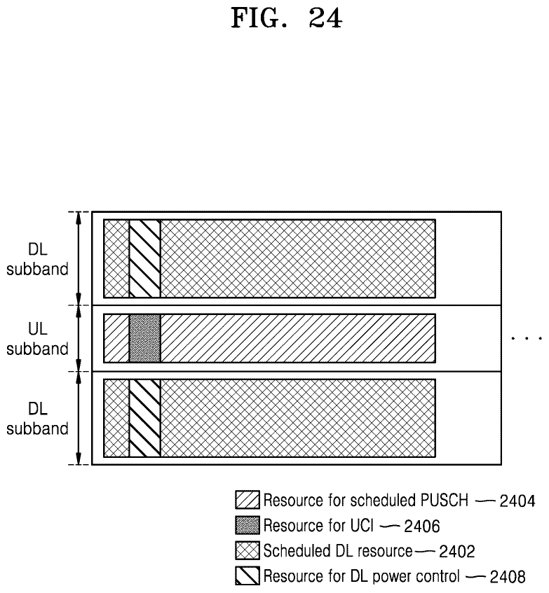

FIG. 24 illustrates a method of configuring a DL power control resource, according to an embodiment of the disclosure.

When the gNB schedules DL transmission 2402 and UL reception 2404 on the same time resource, the gNB may configure a DL power control resource 2408 by considering a UCI multiplexing resource 2406 of a UL. That is, when the gNB schedules a DL resource to the UE, the gNB may configure the area 2408 in which DL power control is available. In this regard, the DL power control area may be implemented via at least one operation among methods below.

Method 1: The gNB may configure the UE with DL power control area configuration via higher layer signaling and L1 signaling, and may indicate the UE as to whether it is available to use a DL power control area, via DCI. That is, although the UE has been configured with the DL power control area by the gNB, if there is no separate indication from the gNB, the UE may use the area without applying a DL power control operation thereto. If the gNB indicates, via a DCI format, that it is available to use the configured DL power control area, the UE may perform the DL power control operation in the area.

Method 2: The gNB may configure the UE with DL power control area configuration via higher layer signaling and L1 signaling, and the UE may always use a corresponding area as a DL power control area. That is, when the UE is configured with the DL power control area by the gNB, only a DL power control operation is assumed in the area.

Method 3: The gNB may configure the UE with DL power control area configuration via higher layer signaling and L1 signaling, and the UE may autonomously determine whether it is available to use a DL power control area. Here, the UE may be a UE capable of performing DL reception in a portion of a frequency resource and performing UL transmission in a portion of a frequency resource, in the same time resource. For example, the UE may receive, from the gNB, scheduling of DL reception and UL transmission in the same time resource. If the UE has determined to multiplex UCI information in a PUSCH and transmit the PUSCH on the corresponding time resource, the UE may use a DL power control area and perform a power control operation. In this regard, the gNB may also transmit a DL signal by applying a DL power control operation on the time resource.

Method 4: The gNB may configure the UE with DL power control area configuration via higher layer signaling and L1 signaling, and DL power control may be activated according to an amount of beam pair interference between a DL and a UL. The gNB may configure, as a pair, beam information of a DL channel and beam information of a UL channel in the same cell or beam information of a UL channel in a different cell. The gNB may identify an amount of mutual interference with respect to each of DL-UL beam pairs, and may activate DL power control only for a beam pair having high interference.

### Seventh Embodiment: Method of Applying DL Power Control, in SBFD System

The gNB may apply a DL power control area configured for the UE, according to a slot type. A resource required for DL power control in the gNB that supports the SBFD system is an SBFD resource on which a DL and a UL coexist on the same time resource, and a non-SBFD resource may not require the DL power control. Accordingly, the gNB may operate DL power control by using at least one of methods below.

Method 1: The gNB may configure the UE with a DL power control area, and may apply the DL power control area to all slot types. If, when the gNB schedules a DL, the gNB configures a DL power control resource, the gNB may apply DL power control on an SBFD resource and a non-SBFD resource, on which the DL is scheduled.

Method 2: The gNB may configure the UE with a DL power control area, and may apply the DL power control area only to an SBFD resource.

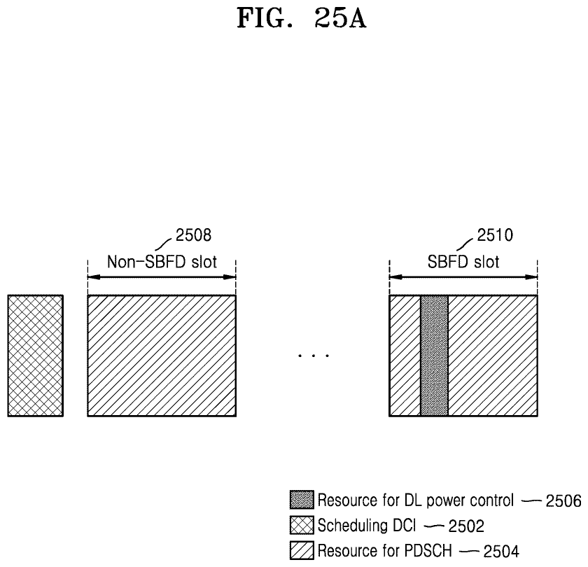

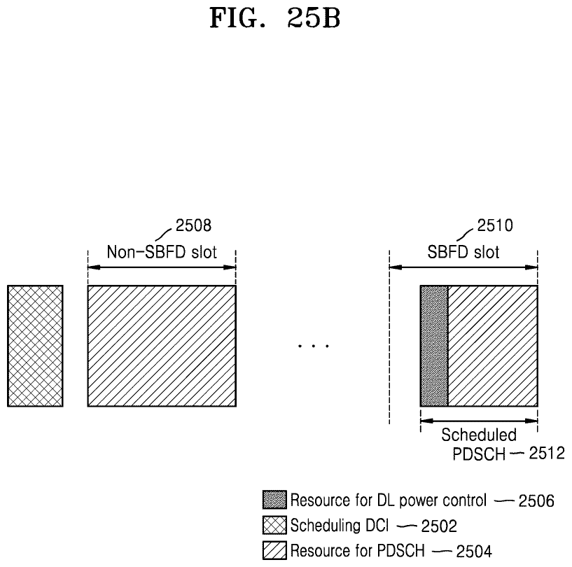

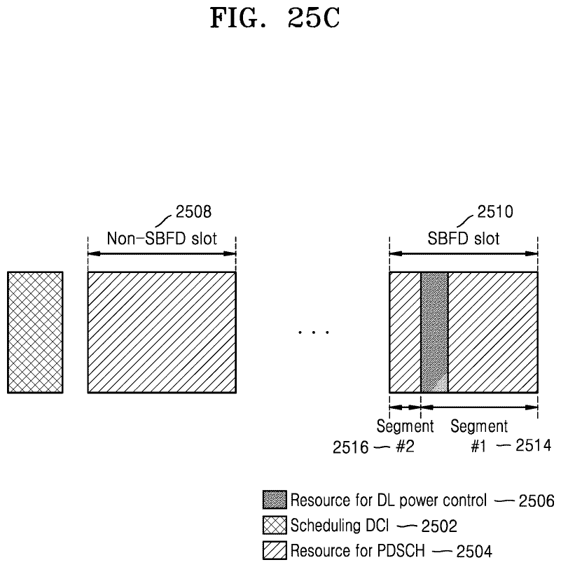

FIGS. 25A-25C illustrate a method of applying DL power control, according to an embodiment of the disclosure.

FIG. 25A illustrates an example of a method of applying DL power control, according to an embodiment of the disclosure.

When scheduling a DL 2504, if the gNB configures a DL power control resource 2506, the gNB may use the DL power control resource 2506 only on an SBFD 2510 from among the SBFD 2510 and a non-SBFD resource 2508, on which a DL is scheduled. In addition, the DL power control resource 2506 may not be applied on the non-SBFD resource 2508.

Method 3: The gNB may configure the UE with a DL power control area, and may perform DL transmission only on a DL resource after a DL power control resource from among SBFD resources.

FIG. 25B illustrates an example of a method of applying DL power control, according to an embodiment of the disclosure.

When scheduling a PDSCH 2504 on an SBFD resource 2510, the gNB may allocate one slot consisting of 14 symbols, and may configure a second symbol thereof as a DL power control area 2506. When the gNB applies DL power control on the SBFD resource, the gNB may perform PDSCH transmission (2512) by applying the DL power control to the second symbol to the fourteen symbol from among the scheduled PDSCH resources, and may not use a first symbol.

Accordingly, a scheduling scheme of the gNB may be selected according to one of methods below.

Method 3-1: The gNB may schedule a PDSCH on an SBFD resource, and may perform puncturing or rate-matching on a resource before a DL power control area.

Method 3-2: The gNB may schedule a PDSCH on an SBFD resource, but may perform scheduling only on a resource after a DL power control area.

Method 4: The gNB may configure the UE with a DL power control area, and may perform DL transmission with different power levels on a DL resource divided into a resource before a DL power control resource and a resource after the DL power control resource of an SBFD resource.

FIG. 25C illustrates an example of a method of applying DL power control, according to an embodiment of the disclosure.

When scheduling the PDSCH 2504 on the SBFD resource 2510, the gNB may allocate one slot consisting of 14 symbols, and may configure a second symbol thereof as the DL power control area 2506. When the gNB applies DL power control on the SBFD resource 2510, the gNB may perform PDSCH transmission (2514) by applying the DL power control to the second symbol to the fourteen symbol from among the scheduled PDSCH resources, and with respect to the first symbol, the gNB may not apply the DL power control but may perform PDSCH transmission (2516).

### Eight Embodiment: Control Method Via DL Power Reduction, in SBFD System

The gNB may configure and indicate the UE with power offset for power reduction, in the configured DL power control resource. In this regard, the power offset may be in a list form of a dB unit, and offset with a dB unit may have an index. When the gNB uses DL power control, the gNB may transmit, to the UE, a DL signal with power changed by applying the power offset, compared to a slot and/or a symbol on which DL power control is not used. Equally, it may be assumed that, when the UE is configured and indicated, by the gNB, with the use of DL power control and a power offset value for DL power control, a DL signal may be transmitted with power changed by applying power offset, compared to a resource on which DL power control is not used. Accordingly, the gNB requires a DCI format for a DL power control scheme and power control indication, and this will be described in detail in methods below.

### Method 1: DL Power Control Mode

The gNB may configure, via higher layer signaling, the UE as to which power control mode is to be used. The power control mode may be configured as at least one of a method of applying accumulated sum offset of power control offset indicated by the gNB or an absolute value applying method applying only indicated power control offset.

### Method 1-1: Power Control Method Via Accumulation of Offset Values

The gNB may configure via higher layer signaling that the UE is enabled for an accumulation operation with respect to power control offset. According to the configuration, the UE may store, as one set, power control offset indicated for DL scheduling. When the UE applies the stored power control offset to DL power control, it may be assumed that an accumulated sum value of offset in the stored set is applicable to DL channel power control.

### Method 1-2: Power Control Method Via Offset Absolute Value

The gNB may configure via higher layer signaling that the UE is disabled for an accumulation operation with respect to power control offset. According to the configuration, the UE may assume that a power control offset value indicated for DL channel scheduling is applied to DL channel power control.

### Method 2: DL Power Control Applying Scheme

The UE may receive a DL channel, assuming that DL power control offset configured and indicated by the gNB is applied to the DL channel transmitted in a configured DL power control resource area. In this regard, the UE may require rules as to which DL channel is referenced, in application of DL power control offset, and as to which DL channel offset is to be applied. Hereinafter, methods therefor will now be described in detail.

Method 2-1: The UE may assume that DL control power offset provided from the gNB via higher layer signaling has been applied to power of a DL channel transmitted in a DL power control resource. Here, the DL channel that is a reference in application of power control offset indicates a channel before a DL power control resource. The DL channel may be at least one of all DL reference signals including a PDSCH, a PDCCH, an SSB, a DMRS, and a CSI-RS transmitted from the gNB. For example, it is assumed that the gNB schedules, to the UE, a PDSCH in three consecutive slots and simultaneously configures two slots thereof as a DL power control resource. According to scheduling information, the UE may receive the PDSCH with assumed power of X dB in a first slot. Also, the UE may receive the PDSCH with assumed power of X−offset dB in a second slot.

Method 2-2: The UE may assume that DL power control offset provided from the gNB via higher layer signaling has been applied to power of a DL channel that does not include a DMRS and is transmitted in a DL power control resource. Here, the DL channel that is a reference in application of power control offset indicates a DL channel including a DMRS in a resource, not the DL power control resource. That is, the DL channel may be at least one of all DL reference signals including a PDSCH, a PDCCH, an SSB, a DMRS, and a CSI-RS. If a DMRS is included in a scheduled DL channel in a DL power control resource configured for the UE, the UE may assume that DL power control offset is not applied to the DL channel. If a DMRS is not included in a scheduled DL channel in a DL power control resource configured for the UE, the UE may assume that DL power control offset is applied to the DL channel.

### Method 3: Signaling Method for DL Power Control

The gNB needs signaling information about which power control information and how to transmit it to the UE in performing the DL control power operation. In this regard, DL power control signaling configuration information may include at least one of DL power control enabling information, a closed loop indicator, or a DL power control offset index. The DL power control information may be transmitted to the UE via at least one of signaling schemes below.
Method 3-1: DL power control field in DCI format for scheduling DL
Method 3-2: DL power control field in DCI format for scheduling UL (PUSCH)
Method 3-3: DL power control field in new group common DCI format for DL power control
Method 3-4: DL power control field in new UE-specific DCI format for DL power control
Method 3-5: DL power control field in DCI format indicating power control of UL (PUSCH)
Method 3-6: DL power control field in new MAC-CE for DL power control

### Ninth Embodiment: Control Method Via DL Resource Muting, in SBFD System

The gNB may configure muting of some or all resources of the configured DL power control resources. The gNB may assume that defined power is allocated to a DL bandwidth and a symbol on which transmission power of the gNB is configured. Accordingly, if the gNB mutes some or all resources of the configured DL power control resources, this may mean that transmission power of the gNB is decreased. Accordingly, methods of muting a resource in a DL power control resource will now be described in detail.

Method 1: The gNB may configure an entire DL power control resource as a muting resource. That is, the gNB may configure a DL power control resource, and may not transmit a DL channel in the corresponding resource.

Method 2: The gNB may configure a portion of the DL power control resource as a muting resource, and the muting resource may be configured based on a comb pattern. When configuring a DL power control resource, the gNB may also configure the comb pattern, and may not transmit a DL channel in a resource of the configured comb pattern. Accordingly, the UE may assume that the resource of the comb pattern configured by the gNB is muted. Here, the comb pattern may be an RB unit, and may have a comb value of a maximum of N. Also, for muting resource mapping by the UE, the gNB may inform the UE whether a corresponding comb is an even comb or an odd comb. For example, the UE may assume that the UE is configured by the gNB with an odd comb and configuration of a DL power control resource. According to the configuration, the gNB may assume a muting resource on odd index RBs, and may assume that a DL channel is not transmitted on the corresponding resource. Here, the RB unit is merely an example, and a unit of the comb pattern may be not only the RB unit but also be an RE unit.

Method 3: The gNB may configure a portion of a DL power control resource as a muting resource, and the muting resource may be configured based on a comb pattern. When the gNB configures the DL power control resource, the gNB may also configure the comb pattern, and may transmit a DL channel on a resource of the configured comb pattern. Accordingly, the UE may assume that resources other than the resource of the comb pattern configured by the gNB are muted. Here, the comb pattern may be an RB unit, and may have a comb value of a maximum of N. Also, for muting resource mapping by the UE, the gNB may inform the UE whether a corresponding comb is an even comb or an odd comb. For example, the UE may assume that the UE is configured by the gNB with an odd comb and configuration of a DL power control resource. According to the configuration, the UE may assume that a DL channel is transmitted on odd index RBs, and may assume other resources as a muting resource. Here, the RB unit is merely an example, and a unit of the comb pattern may be not only the RB unit but also be an RE unit.

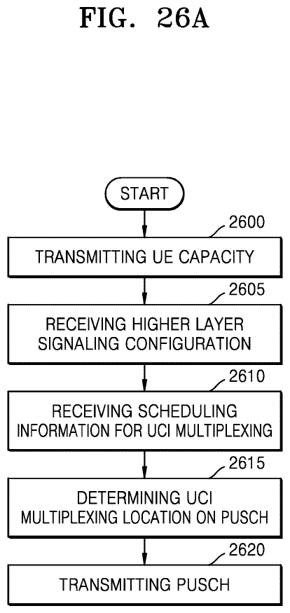

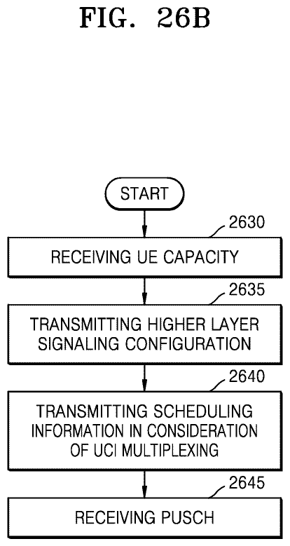

FIGS. 26A-26B illustrate flowcharts of operations of a UE and a BS, respectively, according to an embodiment of the disclosure.

Referring to FIG. 26A, the UE may transmit (2600) UE capacity to a serving BS. The UE may identify configuration information about a DL channel by receiving (2605) higher layer signaling transmitted from the BS. Afterward, the UE may receive (2610) scheduling information transmitted from the BS, and thus, may determine (2615) a resource for multiplexing of UCI in a PUSCH as described in the above embodiment of the disclosure or may apply a DL power control area. The UE may transmit (2620) the PUSCH to the BS, according to the scheduling information configured and indicated by the BS.

Referring to FIG. 26B, the BS may receive (2630) the UE capacity from the UE. When the BS transmits (2635) higher layer signaling to the UE, the BS may include and transmit UL channel scheduling information and UCI multiplexing-associated information. Afterward, the BS may indicate (2640) scheduling information to the UE. Afterward, the BS may receive (2645) the PUSCH transmitted from the UE.

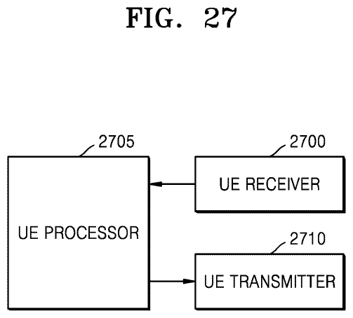

FIG. 27 illustrates a structure of a UE in a wireless communication system, according to an embodiment of the disclosure.

Referring to FIG. 27, the UE may include a transceiver collectively referring to a UE receiver 2700 and a UE transmitter 2710, a memory (not shown), and a UE processor (or a UE controller or a processor) 2705. According to the communication method of the UE described above, the transceiver 2700 or 2710, the memory, and the UE processor 2705 of the UE may operate. However, elements of the UE are not limited to the example above. For example, the UE may include more elements than those described above or may include fewer elements than those described above. In addition, the transceiver 2700 or 2710, the memory, and the processor 2705 may be implemented as one chip.

The transceiver 2700 or 2710 may transmit or receive a signal to or from a BS. Here, the signal may include control information and data. To this end, the transceiver 2700 or 2710 may include an RF transmitter for up-converting and amplifying a frequency of signals to be transmitted, and an RF receiver for low-noise-amplifying and down-converting a frequency of received signals. However, this is merely an example of the transceiver 2700 or 2710, and elements of the transceiver 2700 or 2710 are not limited to the RF transmitter and the RF receiver.

Also, the transceiver 2700 or 2710 may receive signals via wireless channels and output the signals to the processor 2705, and may transmit signals output from the processor 2705, via wireless channels.

The memory may store programs and data required for the UE to operate. Also, the memory may store control information or data included in a signal transmitted or received by the UE. The memory may include any or a combination of storage media such as read-only memory (ROM), random access memory (RAM), a hard disk, a compact disc (CD)-ROM, a digital versatile disc (DVD), or the like. Also, the memory may include a plurality of memories.

Also, the processor 2705 may control a series of processes to allow the UE to operate according to the embodiments of the disclosure. For example, the processor 2705 may control elements of the UE to receive DCI consisting of two layers so as to simultaneously receive a plurality of PDSCHs. The processor 2705 may be provided in a multiple number, and may perform an element control operation of the UE by executing a program stored in the memory.

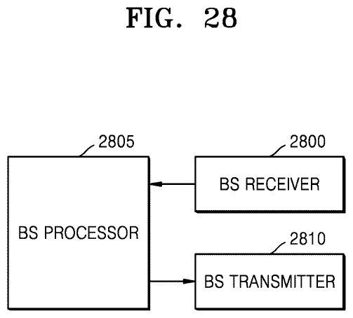

FIG. 28 illustrates a structure of a BS in a wireless communication system, according to an embodiment of the disclosure.

Referring to FIG. 28, the BS may include a transceiver collectively referring to a BS receiver 2800 and a BS transmitter 2810, a memory (not shown), and a BS processor (or a BS controller or a processor) 2805. According to the communication method of the BS described above, the transceiver 2800 or 2810, the memory, and the BS processor 2805 of the BS may operate. However, elements of the BS are not limited to the example above. For example, the BS may include more elements than those described above or may include fewer elements than those described above. In addition, the transceiver 2800 or 2810, the memory, and the processor 2805 may be implemented as one chip.

The transceiver 2800 or 2810 may transmit or receive a signal to or from a UE. Here, the signal may include control information and data. To this end, the transceiver 2800 or 2810 may include a RF transmitter for up-converting and amplifying a frequency of signals to be transmitted, and an RF receiver for low-noise-amplifying and down-converting a frequency of received signals. However, this is merely an example of the transceiver 2800 or 2810, and elements of the transceiver 2800 or 2810 are not limited to the RF transmitter and the RF receiver.

Also, the transceiver 2800 or 2810 may receive signals via wireless channels and output the signals to the processor 2805, and may transmit signals output from the processor 2805, via wireless channels.

The memory may store programs and data required for the BS to operate. Also, the memory may store control information or data included in a signal transmitted or received by the BS. The memory may include any or a combination of storage media such as ROM, RAM, a hard disk, a CD-ROM, a DVD, or the like. Also, the memory may include a plurality of memories.

Also, the processor 2805 may control a series of processes to allow the BS to operate according to the embodiments of the disclosure. For example, the processor 2805 may configure DCI consisting of two layers and including allocation information associated with a plurality of PDSCHs, and may control each element to transmit the DCI. The processor 2805 may be provided in a multiple number, and may perform an element control operation of the BS by executing a program stored in the memory.

The methods according to the embodiments of the disclosure as described in claims or specification may be implemented as hardware, software, or a combination of hardware and software.

When implemented as software, a computer-readable storage medium which stores one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described in the claims or the specification.

The programs (e.g., software modules or software) may be stored in non-volatile memory including random access memory (RAM) or flash memory, read only memory (ROM), electrically erasable programmable read only memory (EEPROM), a magnetic disc storage device, a compact disc (CD)-ROM, a digital versatile disc (DVD), another optical storage device, or a magnetic cassette. Alternatively, the programs may be stored in a memory including a combination of some or all of the above-mentioned memory devices. Also, a plurality of such memories may be included.

In addition, the programs may be stored in an attachable storage device accessible through any or a combination of communication networks such as Internet, an intranet, a local area network (LAN), a wide LAN (WLAN), a storage area network (SAN), or the like. Such a storage device may access, via an external port, a device performing the embodiments of the disclosure. Furthermore, a separate storage device on the communication network may access the electronic device performing the embodiments of the disclosure.

In the afore-described embodiments of the disclosure, elements included in the disclosure are expressed in a singular or plural form according to the embodiments of the disclosure. However, the singular or plural form is appropriately selected for convenience of descriptions and the disclosure is not limited thereto. As such, an element expressed in a plural form may also be configured as a single element, and an element expressed in a singular form may also be configured as plural elements.

The embodiments of the disclosure described with reference to the present specification and the drawings are merely illustrative of specific examples to easily facilitate description and understanding of the disclosure, and are not intended to limit the scope of the disclosure. That is, it will be apparent to one of ordinary skill in the art that other modifications based on the technical ideas of the disclosure are feasible. Also, the embodiments may be combined to be implemented, when required. For example, the BS and the UE may be operated in a manner that portions of an embodiment of the disclosure are combined with portions of another embodiment of the disclosure. For example, the BS and the UE may be operated in a manner that portions of first to fifth embodiments of the disclosure are combined with each other. Also, although the embodiments are described based on a FDD LTE system, modifications based on the technical scope of the embodiments may be applied to other communication systems such as a TDD LTE system, a 5G or NR system, or the like.

The description order of the method of the disclosure as in the drawings may not exactly correspond to actual execution order, but may be performed reversely or in parallel.

In the drawings for describing the methods of the disclosure, some elements may be omitted and only some elements may be shown within a range that does not deviate the scope of the disclosure.

In the disclosure, the methods may be performed by combining some or all of the contents included in each of the embodiments within the scope of the disclosure.

Various embodiments of the disclosure are described above. The aforementioned embodiments of the disclosure are merely for illustration, and are not limited thereto. It is obvious to one of ordinary skill in the art that the disclosure may be easily embodied in many different forms without changing the technical concept or essential features of the disclosure. The scope of the disclosure is defined by the appended claims, rather than defined by the aforementioned detailed descriptions, and all differences and modifications that can be derived from the meanings and scope of the claims and other equivalent embodiments therefrom will be construed as being included in the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving, from a base station (BS), information associated with a downlink (DL) resource on a DL subband and information associated with an uplink (UL) resource on a UL subband, wherein the DL resource and the UL resource are on a same time resource;
receiving, from the BS, time resource information for multiplexing uplink control information (UCI) on the UL resource;
performing multiplexing of the UCI on the UL resource based on the time resource information; and
transmitting, to the BS, an UL signal based on the UL resource multiplexed with the UCI.

2. The method of claim 1, further comprising:
transmitting, to the BS, capability information indicating that the UE supports subband full duplex (SBFD).

3. The method of claim 1, wherein the time resource information comprises a start point of the UL resource to be multiplexed with the UCI.

4. The method of claim 3, wherein the start point is based on a resource that does not overlap with the DL resource and the UL resource.

5. The method of claim 1, further comprising:
receiving, from the BS, first configuration information indicating activation of a UCI multiplexing resource change.

6. The method of claim 1, further comprising:
receiving, from the BS, second configuration information indicating a transmission of a semi-persistent scheduling (SPS) Hybrid Automatic Repeat Request-Acknowledgement (HARQ-ACK), wherein the transmission is only on a non-SBFD resource; and
transmitting, to the BS, the SPS HARQ-ACK on the non-SBFD resource, wherein the SPS HARQ-ACK is multiplexed on the non-SBFD resource.

7. The method of claim 1, further comprising:
receiving, from the BS, third configuration information comprising information on a DL power control resource, or information on whether the DL power control resource is available.

8. The method of claim 7, wherein the information on the DL power control resource comprises information that the DL power control resource is applied only on a SBFD resource.

9. The method of claim 8, wherein the third configuration information comprises information for configuring the DL power control resource as a muting resource, and
wherein the muting resource is configured based on a comb pattern.

10. A method performed by a base station (BS) in a wireless communication system, the method comprising:
transmitting, to a user equipment (UE), information associated with a downlink (DL) resource on a DL subband and information associated with an uplink (UL) resource on a UL subband, wherein the DL resource and the UL resource are on a same time resource;
transmitting, to the UE, time resource information for multiplexing uplink control information (UCI) on the UL resource, wherein the UCI is multiplexed on the UL resource based on the time resource information; and
receiving, from the UE, an UL signal based on the UL resource multiplexed with the UCI.

11. A user equipment (UE) comprising:
a transceiver; and
at least one processor coupled to the transceiver, and configured to:
receive, from a base station (BS), information associated with a downlink (DL) resource on a DL subband and information associated with an uplink (UL) resource on a UL subband, wherein the DL resource and the UL resource are on a same time resource,
receive, from the BS, time resource information for multiplexing uplink control information (UCI) on the UL resource,
perform multiplexing of the UCI on the UL resource based on the time resource information, and
transmit, to the BS, an UL signal based on the UL resource multiplexed with the UCI.

12. The UE of claim 11, wherein the at least one processor is further configured to:
transmit, to the BS, capability information indicating that the UE supports subband full duplex (SBFD).

13. The UE of claim 11, wherein the time resource information comprises a start point of the UL resource to be multiplexed with the UCI.

14. The UE of claim 13, wherein the start point is based on a resource that does not overlap with the DL resource and the UL resource.

15. The UE of claim 11, wherein the at least one processor is further configured to:
receive, from the BS, first configuration information indicating activation of a UCI multiplexing resource change.

16. The UE of claim 11, wherein the at least one processor is further configured to:
receive, from the BS, second configuration information indicating a transmission of a semi-persistent scheduling (SPS) Hybrid Automatic Repeat Request-Acknowledgement (HARQ-ACK), wherein the transmission is only on a non-SBFD resource, and
transmit, to the BS, the SPS HARQ-ACK on the non-SBFD resource, wherein the SPS HARQ-ACK is multiplexed on the non-SBFD resource.

17. The UE of claim 11, wherein the at least one processor is further configured to:
receive, from the BS, third configuration information comprising information on a DL power control resource, or information on whether the DL power control resource is available.

18. The UE of claim 17, wherein the information on the DL power control resource comprises information that the DL power control resource is applied only on a SBFD resource.

19. The UE of claim 18, wherein the third configuration information comprises information for configuring the DL power control resource as a muting resource, and
wherein the muting resource is configured based on a comb pattern.

20. A base station (BS) comprising:
a transceiver; and
at least one processor coupled to the transceiver, and configured to:
transmit, to a user equipment (UE), information associated with a downlink (DL) resource on a DL subband and information associated with an uplink (UL) resource on a UL subband, wherein the DL resource and the UL resource are on a same time resource;
transmit, to the UE, time resource information for multiplexing uplink control information (UCI) on the UL resource, wherein the UCI is multiplexed on the UL resource based on the time resource information; and
receive, from the UE, an UL signal based on the UL resource multiplexed with the UCI.
